(19) United States
(12) Patent Application Publication
(10) Pub. No.: US 2025/0151750 A1
(43) Pub. Date: May 15, 2025

(54) COLLOIDAL FOOD PRODUCTS COMPRISING FILAMENTOUS FUNGAL PARTICLES

(71) Applicant: THE FYNDER GROUP, INC., Chicago, IL (US)

(72) Inventors: Jessica Okane KAWABATA, Chicago, IL (US); Eleanore Brophy ECKSTROM, Chicago, IL (US); Baljit Singh GHOTRA, Chicago, IL (US); Yuval Charles AVNIEL, Chicago, IL (US); Sébastien Raymond CANONNE, Chicago, IL (US); Nahla KREIDLY, Chicago, IL (US); Shantanu AGARWAL, Chicago, IL (US); Brian KLOPF, Chicago, IL (US)

(21) Appl. No.: 18/263,599

(22) PCT Filed: Jan. 31, 2022
(86) PCT No.: PCT/US22/14502

§ 371 Date: Jul. 31, 2023

Related U.S. Application Data
(60) Provisional application No. 63/143,908, filed on Jan. 31, 2021.

(51) Int. Cl. A23G 9/38; A23G 9/08; A23G 9/32; A23G 9/34; A23G 9/42

(52) U.S. Cl. CPC A23G 9/38; A23G 9/086; A23G 9/327; A23G 9/34; A23G 9/42

(57) ABSTRACT

Colloidal food products comprising filamentous fungal particles are disclosed, as are methods of making such colloidal food products. The filamentous fungal particles may stabilize the colloid and/or act as a supplemental or replacement source of protein in analogs of conventional non-fungal colloidal food products, such as ice cream and mayonnaise.

### CROSS-REFERENCE TO RELATED APPLICATION

This application claims the benefit of priority of U.S. Provisional Patent Application 63/143,908, filed 31 Jan. 2021, the entirety of which is incorporated herein by reference.

### FIELD OF THE INVENTION

This application relates to edible filamentous fungi and provides methods of preparing colloidal suspensions of edible filamentous fungi, particularly colloidal food products containing edible filamentous fungi and colloidal food products comprising particles of edible filamentous fungi, as well as uses and methods associated therewith.

### BACKGROUND OF THE INVENTION

Many popular food ingredients and products are mixtures in which particles of one substance (a “dispersed phase”) are dispersed throughout a volume of a different substance (a “dispersion medium” or “dispersion phase”); mixtures of this type are referred to herein as “colloidal” or “colloids.” Examples of colloidal foods include blancmange, bread, butter, cake, custard, egg white foam, ice cream, jam, jelly, margarine, mayonnaise, meringue, milk, and whipped cream. As the preceding list of examples illustrates, however, many colloidal foods are “indulgence” items-foods that may be particularly rich or decadent, and that can therefore be expensive or unhealthy if consumed regularly or in large quantities. Moreover, many such colloids include as at least one phase an allergenic substance and/or a substance that is derived or obtained from animals and may therefore be unsuitable for consumption by vegans or other persons with dietary restrictions or allergic sensitivities; existing hypoallergenic or vegan alternatives to conventional colloidal food products often suffer from poor stability and rapid separation of the colloidal phases.

There is thus a need in the art for colloidal food products that are analogous in taste, texture, and other aesthetic and sensory characteristics to conventional colloidal food products, but that can be provided at low cost and/or with an improved nutritional profile. It is further advantageous for such colloidal food products to be free of allergenic or animal-derived products to allow these products to appeal to a wider range of potential consumers, and to remain stable and/or homogeneous over extended periods to provide for a longer usable shelf life.

### SUMMARY OF THE INVENTION

In an aspect of the present disclosure, a colloidal composition comprises a first phase, comprising at least one gas; a second phase, comprising at least one monosaccharide, disaccharide, or polysaccharide; filamentous fungal particles; and water, wherein the first phase is dispersed in the second phase, and wherein at least about 65 wt % of protein in the colloidal composition is provided by the filamentous fungal particles.

In embodiments, the filamentous fungal particles may be in a form selected from the group consisting of a flour, a dispersion of particles, wet biomat-derived particles, a paste, and combinations thereof.

In embodiments, the colloidal composition may comprise the at least one monosaccharide, disaccharide, or polysaccharide in an amount of at least about 10 wt %. The colloidal composition may, but need, comprise the at least one monosaccharide, disaccharide, or polysaccharide in an amount of between about 10 wt % and about 35 wt %. The colloidal composition may, but need not, comprise the at least one monosaccharide, disaccharide, or polysaccharide in an amount of between about 17 wt % and about 25 wt %. The at least one monosaccharide, disaccharide, or polysaccharide may, but need not, comprise at least one of sucrose, dextrose, and glucose.

In embodiments, the colloidal composition may comprise at least one monosaccharide or disaccharide and at least one polysaccharide, wherein the polysaccharide is provided in an amount of between about 5 wt % and about 10 wt %. The colloidal composition may, but need not, comprise the at least one polysaccharide in an amount of between about 7.2 wt % and about 8.2 wt %. The at least one polysaccharide may, but need not, comprise at least one of an inulin, psyllium, and a fructooligosaccharide.

In embodiments, the colloidal composition may comprise the filamentous fungal particles in an amount of between about 6 wt % and about 17.0 wt %. The filamentous fungal particles may, but need not, be provided as part of a homogenate or dispersion, a weight ratio of a liquid to filamentous fungal particles in the aqueous homogenate or dispersion may, but need not, be between about 0.1 and about 10, and the liquid may, but need not, be selected from the group consisting of water, coconut water, soy milk, almond milk, oat milk, and a fruit juice. The weight ratio of the liquid to filamentous fungal particles in the aqueous homogenate or dispersion may, but need not, be between about 2.5 and about 3.5.

In embodiments, the colloidal composition may further comprise at least one fatty substance. The colloidal composition may, but need not, comprise the at least one fatty substance in an amount of between about 4.5 wt % and about 60.0 wt %. The fatty substance may, but need not, comprise at least one of canola oil, palm oil, palm kernel oil, sunflower oil, vegetable oil, refined coconut oil, almond oil, peanut oil, and palm olein.

In embodiments, the colloidal composition may further comprise a foam stabilizer in an amount of between about 0.05 wt % and about 0.5 wt %. The foam stabilizer may, but need not, comprise at least one of a monoglyceride, a diglyceride, locust bean gum, guar gum, carob bean gum, cellulose gum, and a fatty oil.

In embodiments, the colloidal composition may be substantially free of non-fungal-derived emulsifiers, stabilizers, and surfactants.

In embodiments, the first phase and the second phase may remain substantially homogenously mixed, and/or may not visibly separate, for at least about one day, at least about two days, at least about three days, at least about four days, at least about five days, at least about six days, at least about one week, at least about two weeks, at least about three weeks, at least about one month, at least about two months, at least about three months, at least about four months, at least about five months, at least about six months, at least about seven months, at least about eight months, at least about nine months, at least about ten months, at least about eleven months, at least about twelve months, at least about thirteen months, at least about fourteen months, at least about fifteen months, at least about sixteen months, at least about seventeen months, or at least about eighteen months after formation of the colloidal composition.

In embodiments, a volume ratio of the at least one gas to the remainder of the colloidal composition may be at least about 0.1, at least about 0.2, at least about 0.3, at least about 0.4, at least about 0.5, at least about 0.75, at least about 1, at least about 2, at least about 3, at least about 4, or at least about 5. The gas may, but need not, be selected from the group consisting of argon, nitrogen, air, helium, and carbon dioxide.

In embodiments, the colloidal composition may have a foam stability of at least about 50%, at least about 60%, at least about 70%, at least about 80%, at least about 90%, or at least about 95% over a period of at least about one day, at least about two days, at least about three days, at least about four days, at least about five days, at least about six days, at least about one week, at least about two weeks, at least about three weeks, at least about one month, at least about two months, at least about three months, at least about four months, at least about five months, at least about six months, at least about seven months, at least about eight months, at least about nine months, at least about ten months, at least about eleven months, at least about twelve months, at least about thirteen months, at least about fourteen months, at least about fifteen months, at least about sixteen months, at least about seventeen months, or at least about eighteen months.

In embodiments, the colloidal composition may comprise at least one monosaccharide or disaccharide in an amount of between about 17 wt % and about 25 wt %, at least one polysaccharide in an amount of between about 7.2 wt % and about 8.2 wt %, and the filamentous fungal particles in an amount of between about 12.8 wt % and about 17.0 wt %, and may further comprise at least one fatty substance in an amount of between about 4.5 wt % and about 10.0 wt % and a foam stabilizer in an amount of between about 0.05 wt % and about 0.50 wt %, and the at least one monosaccharide or disaccharide may comprise at least one of sucrose, dextrose, and glucose, the at least one polysaccharide may comprise an inulin, the fatty substance may comprise refined coconut oil, and the foam stabilizer may comprise locust bean gum, and may further comprise between about 0.01 wt % and about 40 wt % of at least one flavoring ingredient.

In embodiments, the colloidal composition may be a dairy analog food product. The dairy analog food product may, but need not, be a cream analog food product having a fat content of at least about 10.5 wt %.

In embodiments, the colloidal composition may be a frozen food product. The frozen food product may, but need not, have a melting point of no more than about 15° C.

In embodiments, the colloidal composition may be an ice cream analog food product. The colloidal composition may, but need not, be a vanilla ice cream analog food product and the at least one flavoring ingredient may, but need not, comprise vanilla beans or vanilla paste. The colloidal composition may, but need not, be a strawberry ice cream analog food product and the at least one flavoring ingredient may, but need not, comprise strawberry puree and lemon juice. The colloidal composition may, but need not, be a chocolate ice cream analog food product and the at least one flavoring ingredient may, but need not, comprise cacao powder.

In embodiments, at least about 10% (by number, volume, or weight), at least about 20% (by number, volume, or weight), at least about 30% (by number, volume, or weight), at least about 40% (by number, volume, or weight), at least about 50% (by number, volume, or weight), at least about 60% (by number, volume, or weight), at least about 70% (by number, volume, or weight), at least about 80% (by number, volume, or weight), at least about 90% (by number, volume, or weight), at least about 91% (by number, volume, or weight), at least about 92% (by number, volume, or weight), at least about 93% (by number, volume, or weight), at least about 94% (by number, volume, or weight), at least about 95% (by number, volume, or weight), at least about 96% (by number, volume, or weight), at least about 97% (by number, volume, or weight), at least about 98% (by number, volume, or weight), or at least about 99% (by number, volume, or weight) of ice crystals in the colloidal composition may have particle sizes of less than about 25 μm, less than about 24 μm, less than about 23 μm, less than about 22 μm, less than about 21 μm, less than about 20 μm, less than about 19 μm, less than about 18 μm, less than about 17 μm, less than about 16 μm, less than about 15 μm, less than about 14 μm, less than about 13 μm, less than about 12 μm, less than about 11 μm, less than about 10 μm, less than about 9 μm, less than about 8 μm, less than about 7 μm, less than about 6 μm, or less than about 5 μm.

In embodiments, the colloidal composition may be characterized by a subjective iciness score of no more than about 5, no more than about 4, no more than about 3, or no more than about 2 on a scale of 0 to 10.

In embodiments, the colloidal composition may be characterized by a subjective firmness score in the mouth of between about 3 and about 7 on a scale of 0 to 10, or equivalents of these values on another numerical scale.

In embodiments, the colloidal composition may be characterized by a subjective creamy mouthfeel score of between about 3 and about 6 on a scale of 0 to 10, or equivalents of these values on another numerical scale.

In embodiments, the colloidal composition may be characterized by a subjective creamy mouthcoating score of between about 3 and about 5 on a scale of 0 to 10, or equivalents of these values on another numerical scale.

In embodiments, the at least one gas may comprise at least one of air, nitrogen, oxygen, argon, carbon dioxide, and helium.

In embodiments, the colloidal composition may have a total fat content of less than about 10 wt %, less than about 9 wt %, less than about 8 wt %, less than about 7 wt %, less than about 6 wt %, or less than about 5 wt %.

In embodiments, the colloidal composition may have a total fat content of at least about 10 wt %, at least about 15 wt %, at least about 20 wt %, at least about 25 wt %, at least about 30 wt %, at least about 35 wt %, at least about 40 wt %, or at least about 45 wt %.

In embodiments, the colloidal composition may have a saturated fat content of less than about 55 wt % of the total fat content, less than about 50 wt % of the total fat content, less than about 45 wt % of the total fat content, or less than about 40 wt % of the total fat content.

In embodiments, the colloidal composition may have a saturated fat content of less than about 5.5 wt % of the composition, less than about 5 wt % of the composition, less than about 4.5 wt % of the composition, less than about 4 wt % of the composition, less than about 3.5 wt % of the composition, less than about 3 wt % of the composition, less than about 2.5 wt % of the composition, or less than about 2 wt % of the composition.

In embodiments, the colloidal composition may further comprise at least one hydrophobin. The at least one hydrophobin may, but need not, make up at least about 1 wt % of a total protein content of the colloidal composition.

In embodiments, the colloidal composition or a mix or precursor thereof may have a dynamic viscosity, at 20° C. and 1 atm, of greater than about 400 cP.

In another aspect of the present disclosure, a colloidal composition comprises an oil phase; an aqueous phase; and filamentous fungal particles, wherein the filamentous fungal particles stabilize the colloidal composition, and wherein the colloidal composition is an oil-in-water emulsion.

In embodiments, the colloidal composition may be stabilized by a combination of the oil phase and mycelial proteins in the filamentous fungal particles.

In embodiments, at least about 50 wt % of protein in the colloidal composition may be provided by the filamentous fungal particles. At least about 65 wt % of protein in the colloidal composition may, but need not, be provided by the filamentous fungal particles.

In embodiments, the filamentous fungal particles may be dispersed in the aqueous phase.

In embodiments, the oil phase and the aqueous phase may remain substantially homogenously mixed, and/or may not visibly separate, for at least about one day, at least about two days, at least about three days, at least about four days, at least about five days, at least about six days, at least about one week, at least about two weeks, at least about three weeks, at least about one month, at least about two months, at least about three months, at least about four months, at least about five months, at least about six months, at least about seven months, at least about eight months, at least about nine months, at least about ten months, at least about eleven months, at least about twelve months, at least about thirteen months, at least about fourteen months, at least about fifteen months, at least about sixteen months, at least about seventeen months, or at least about eighteen months after formation of the colloidal composition.

In embodiments, the colloidal composition may be a mayonnaise analog food product.

In embodiments, the colloidal composition may be an analog of a sauce or spread other than mayonnaise.

In embodiments, the colloidal composition may be a foie gras analog food product.

In another aspect of the present disclosure, a colloidal composition comprises a first phase; a continuous second phase; and filamentous fungal particles, wherein the filamentous fungal particles comprise elongated particles having a length of between about 1 micron and about 50 microns, and wherein the filamentous fungal particles are substantially uniformly dispersed throughout the continuous second phase.

In embodiments, the first phase may comprise a gas. The gas may, but need not, comprise at least one species selected from the group consisting of nitrogen, oxygen, argon, carbon dioxide, and helium.

In embodiments, the continuous second phase may comprise at least one of a fatty substance, a monosaccharide, a disaccharide, a polysaccharide, and ice crystals.

In embodiments, the filamentous fungal particles may comprise elongated particles having a length of between about 5 microns and about 20 microns.

In embodiments, the filamentous fungal particles may comprise elongated particles having a width of between about 0.01 microns and about 4 microns.

In embodiments, the colloidal composition may be a dairy analog food product. The dairy analog food product may, but need not, be a cream analog food product having a fat content of at least about 10.5 wt %.

In embodiments, the colloidal composition may be a frozen food product.

In embodiments, the colloidal composition may be an ice cream analog food product comprising at least one flavoring ingredient. The colloidal composition may, but need not, be a vanilla ice cream analog food product and the at least one flavoring ingredient may, but need not, comprise vanilla beans or vanilla paste. The colloidal composition may, but need not, be a strawberry ice cream analog food product and the at least one flavoring ingredient may, but need not, comprise strawberry puree and lemon juice. The colloidal composition may, but need not, be a chocolate ice cream analog food product and the at least one flavoring ingredient comprises cacao powder.

In embodiments, at least about 10% (by number, volume, or weight), at least about 20% (by number, volume, or weight), at least about 30% (by number, volume, or weight), at least about 40% (by number, volume, or weight), at least about 50% (by number, volume, or weight), at least about 60% (by number, volume, or weight), at least about 70% (by number, volume, or weight), at least about 80% (by number, volume, or weight), at least about 90% (by number, volume, or weight), at least about 91% (by number, volume, or weight), at least about 92% (by number, volume, or weight), at least about 93% (by number, volume, or weight), at least about 94% (by number, volume, or weight), at least about 95% (by number, volume, or weight), at least about 96% (by number, volume, or weight), at least about 97% (by number, volume, or weight), at least about 98% (by number, volume, or weight), or at least about 99% (by number, volume, or weight) of ice crystals in the colloidal composition may have particle sizes of less than about 25 μm, less than about 24 μm, less than about 23 μm, less than about 22 μm, less than about 21 μm, less than about 20 μm, less than about 19 μm, less than about 18 μm, less than about 17 μm, less than about 16 μm, less than about 15 μm, less than about 14 μm, less than about 13 μm, less than about 12 μm, less than about 11 μm, less than about 10 μm, less than about 9 μm, less than about 8 μm, less than about 7 μm, less than about 6 μm, or less than about 5 μm.

In embodiments, the colloidal composition may be characterized by a subjective iciness score of no more than about 5, no more than about 4, no more than about 3, or no more than about 2 on a scale of 0 to 10.

In embodiments, the colloidal composition may be characterized by a subjective firmness score in the mouth of between about 3 and about 7 on a scale of 0 to 10, or equivalents of these values on another numerical scale.

In embodiments, the colloidal composition may be characterized by a subjective creamy mouthfeel score of between about 3 and about 6 on a scale of 0 to 10, or equivalents of these values on another numerical scale.

In embodiments, the colloidal composition may be characterized by a subjective creamy mouthcoating score of between about 3 and about 5 on a scale of 0 to 10, or equivalents of these values on another numerical scale.

In embodiments of any colloidal composition as disclosed herein, the filamentous fungal particles may have an average particle size of between about 2 microns and about 10 microns, between about 10 microns and about 20 microns, between about 20 microns and about 50 microns, between about 50 microns and about 75 microns, or between about 75 microns and about 120 microns. The filamentous fungal particles may, but need not, comprise particles having a particle size of less than about 1 μm or less than about 500 nm.

In embodiments of any of the colloidal compositions disclosed herein, the filamentous fungal particles may comprise at least about 46 wt % protein.

In embodiments of any of the colloidal compositions disclosed herein, the filamentous fungal particles may comprise particles of at least one filamentous fungus belonging to an order selected from the group consisting of Mucorales, Ustilaginales, Russulales, Polyporales, Agaricales, Pezizales, and Hypocreales.

In embodiments of any of the colloidal compositions disclosed herein, the filamentous fungal particles may comprise particles of at least one filamentous fungus belonging to a family selected from the group consisting of Mucoraceae, Ustilaginaceae, Hericiaceae, Polyporaceae, Grifolaceae, Lyophyllaceae, Strophariaceae, Lycoperdaceae, Agaricaceae, Pleurotaceae, Physalacriaceae, Omphalotaceae, Tuberaceae, Morchellaceae, Sparassidaceae, Nectriaceae, Bionectriaceae, and Cordycipitaceae.

In embodiments of any of the colloidal compositions disclosed herein, the filamentous fungal particles may comprise particles of at least one filamentous fungus belonging to a family selected from the group consisting of Rhizopus oligosporus, Ustilago esculenta, Hericululm erinaceus, Polyporous squamosus, Grifola fondrosa, Hypsizygus marmoreus, Hypsizygus ulmarius (elm oyster), Calocybe gambosa, Pholiota nameko, Calvatia gigantea, Agaricus bisporus, Stropharia rugosoannulata, Hypholoma lateritium, Pleurotus eryngii, Pleurotus ostreatus (pearl), Pleurotus ostreatus var. columbinus (Blue oyster), Tuber borchii, Morchella esculenta, Morchella conica, Morchella importuna, Sparassis crispa (cauliflower), Fusarium venenatum, Fusarium strain flavolapis, Disciotis venosa, Clonostachys rosea, Cordyceps militaris, Trametes versicolor, Ganoderma lucidum, Flammulina velutipes, Lentinula edodes, Pleurotus djamor, Pleurotus ostreatus, and Leucoagaricus spp.

In embodiments of any of the colloidal compositions disclosed herein, the filamentous fungal particles may comprise particles of at least one filamentous fungus belonging to the genus Fusarium.

In embodiments of any of the colloidal compositions disclosed herein, the filamentous fungal particles may comprise particles of Fusarium venenatum.

In embodiments of any of the colloidal compositions disclosed herein, the filamentous fungal particles may comprise particles of the Fusarium strain flavolapis identified by ATCC Accession Deposit No. PTA-10698.

In embodiments of any of the colloidal compositions disclosed herein, the filamentous fungal particles may be derived from a fungal biomass comprising at least one of mycelia, conidia, and a fruiting body. The filamentous fungal particles may, but need not, be derived from a fruiting body and the colloidal composition may, but need not, be an ice cream analog food product.

In embodiments of any of the colloidal compositions disclosed herein, the filamentous fungal particles may, but need not, be derived from a filamentous fungal biomat. The filamentous fungal biomat may, but need not, be produced by a fermentation method selected from the group consisting of surface fermentation, submerged fermentation, and solid substrate fermentation.

In embodiments of any of the colloidal compositions disclosed herein, the filamentous fungal particles may be provided as part of a homogenate, and the homogenate may further comprise a liquid.

In embodiments of any of the colloidal compositions disclosed herein, at least one of the following may be true: (i) no more than about 36.2% of the filamentous fungal particles have a particle size of less than about 53 microns; (ii) between about 10.7% and about 67.1% of the filamentous fungal particles have a particle size of less than about 105 microns; (iii) no more than about 69.8% of the filamentous fungal particles have a particle size of between about 53 microns and about 105 microns; (iv) between about 2.7% and about 59.6% of the filamentous fungal particles have a particle size of between about 105 microns and about 177 microns; (v) no more than about 28.6% of the filamentous fungal particles have a particle size of between about 177 microns and about 250 microns; (vi) no more than about 42.6% of the filamentous fungal particles have a particle size of between about 250 microns and about 350 microns; (vii) no more than about 41.8% of the filamentous fungal particles have a particle size of between about 350 microns and about 590 microns; and (viii) no more than about 4.8% of the filamentous fungal particles have a particle size of between about 590 microns and about 1190 microns.

In embodiments of any of the colloidal compositions disclosed herein, a circular equivalent number-average particle size of the filamentous fungal particles may be between about 1.46 microns and about 6.42 microns. The circular equivalent number-average particle size of the filamentous fungal particles may, but need not, be between about 3.64 microns and about 4.64 microns.

In embodiments of any of the colloidal compositions disclosed herein, the filamentous fungal particles may comprise at least about 27 wt % dietary fiber. The filamentous fungal particles may, but need not, comprise no more than about 37 wt % dietary fiber.

In embodiments of any of the colloidal compositions disclosed herein, the filamentous fungal particles may comprise at least about 30 wt % protein. The filamentous fungal particles may, but need not, comprise no more than about 80 wt % protein.

In embodiments of any of the colloidal compositions disclosed herein, the colloidal composition may comprise at least about 4.0 wt %, at least about 4.5 wt %, at least about 5.0 wt %, at least about 5.5 wt %, at least about 6.0 wt %, at least about 6.5 wt %, at least about 7.0 wt %, at least about 7.5 wt %, at least about 8.0 wt %, at least about 8.5 wt %, at least about 9.0 wt %, at least about 9.5 wt %, at least about 10.0 wt %, at least about 10.5 wt %, at least about 11.0 wt %, at least about 11.5 wt %, at least about 12.0 wt %, or at least about 12.5 wt % protein.

In embodiments of any of the colloidal compositions disclosed herein, the filamentous fungal particles may comprise no more than about 14% moisture. The filamentous fungal particles may, but need not, comprise at least about 4% moisture.

In embodiments of any of the colloidal compositions disclosed herein, protein, fat, and air may be substantially uniformly distributed throughout the colloidal composition.

In embodiments of any of the colloidal compositions disclosed herein, the filamentous fungal particles may comprise at least about 11.0 μmol/g, at least about 11.5 μmol/g, at least about 12.0 μmol/g, at least about 12.5 μmol/g, at least about 13.0 μmol/g, at least about 13.5 μmol/g, at least about 14.0 μmol/g, or at least about 14.5 μmol/g phospholipids.

In embodiments of any of the colloidal compositions disclosed herein, the colloidal composition may comprise no more than about 18.5 μmol/g, no more than about 18.0 μmol/g, no more than about 17.5 μmol/g, no more than about 17.0 μmol/g, no more than about 16.5 μmol/g, no more than about 16.0 μmol/g, no more than about 15.5 μmol/g, or no more than about 15.0 μmol/g phospholipids.

In embodiments of any of the colloidal compositions disclosed herein, the colloidal composition may comprise at least about 0.01 wt %, at least about 0.02 wt %, at least about 0.03 wt %, at least about 0.04 wt %, at least about 0.05 wt %, at least about 0.1 wt %, at least about 0.15 wt %, at least about 0.2 wt %, at least about 0.25 wt %, at least about 0.3 wt %, at least about 0.35 wt %, at least about 0.4 wt %, at least about 0.45 wt %, or at least about 0.5 wt % phospholipids.

In embodiments of any of the colloidal compositions disclosed herein, the colloidal composition may comprise no more than about 1 wt %, no more than about 0.95 wt %, no more than about 0.9 wt %, no more than about 0.85 wt %, no more than about 0.8 wt %, no more than about 0.75 wt %, no more than about 0.7 wt %, no more than about 0.65 wt %, no more than about 0.6 wt %, or no more than about 0.55 wt % phospholipids.

In embodiments, the phospholipids may act as an emulsifier of the colloidal composition.

In embodiments of any of the colloidal compositions disclosed herein, the colloidal composition may have a pH of at between about 5 and about 7.

In embodiments of any of the colloidal compositions disclosed herein, the colloidal composition may have a zeta potential magnitude, at a temperature of 20° C. and a pH of between 5 and 7, of at least about 10 mV, at least about 15 mV, or at least about 20 mV. The colloidal composition may, but need not, have a dynamic viscosity at 20° C. and 1 atm of between about 1.5 cP and about 25,000 cP, or at a temperature of between 0° C. and 25° C. and 1 atm of between about 200 cP and about 2,100 cP.

In embodiments of any of the colloidal compositions disclosed herein, the colloidal composition may have a contact angle on a silicon wafer, at a temperature of 25° C. and a pressure of 1 atm, of at least about 45°. The contact angle may, but need not, be between about 45° and about 75°.

In embodiments of any of the colloidal compositions disclosed herein, the filamentous fungal particles may comprise at least one compound selected from the group consisting of vitamins, lipids, glycolipids, polysaccharides, sugar alcohols, and @-3 fatty acids.

In embodiments of any of the colloidal compositions disclosed herein, the filamentous fungal particles may comprise at least one substance that improves an aesthetic or sensory quality of the filamentous fungus, wherein the substance is selected from the group consisting of pigments, inks, dyes, and fragrances.

In embodiments of any of the colloidal compositions disclosed herein, the colloidal composition may be substantially free of lactose and the filamentous fungal particles may comprise one or more β-glucans.

In embodiments of any of the colloidal compositions disclosed herein, the filamentous fungal particles may comprise at least one hydrophobin. The at least one hydrophobin may, but need not, make up at least about 1 wt % of a total protein content of the colloidal composition.

In embodiments of any of the colloidal compositions disclosed herein, the filamentous fungal particles may comprise at least one ice-structuring protein.

In another aspect of the present disclosure, a particle-stabilized colloidal food product comprises a dispersed phase; a dispersion medium; and filamentous fungal particles, wherein at least a portion of the filamentous fungal particles are positioned at an interface between the dispersed phase and the dispersion medium to stabilize the colloidal food product.

In embodiments, the filamentous fungal particles may have a hydrophilic-lipophilic balance of between about 3 and about 16.

In embodiments, the filamentous fungal particles may have an average particle size of between about 2 microns and about 10 microns, between about 10 microns and about 20 microns, between about 20 microns and about 50 microns, between about 50 microns and about 75 microns, or between about 75 microns and about 120 microns.

In embodiments, the dispersed phase may comprise at least one of nitrogen, oxygen, carbon dioxide, argon, and helium and the dispersion medium may comprise at least one monosaccharide, disaccharide, or polysaccharide. The dispersion medium may, but need not, comprise at least one monosaccharide or disaccharide and at least one polysaccharide.

In embodiments, the dispersed phase may comprise an oil and the dispersion medium may comprise at least one of water, coconut water, soy milk, almond milk, oat milk, and a fruit juice.

In another aspect of the present disclosure, a method for preparing a colloidal food product as disclosed herein is provided.

In another aspect of the present disclosure, a Pickering emulsion comprises a dispersed phase; a continuous phase; and filamentous fungal particles, wherein at least a portion of the filamentous fungal particles adsorb onto an interface between the continuous phase and the dispersed phase to stabilize the emulsion by the Pickering phenomenon.

In embodiments, the continuous phase may comprise water.

In another aspect of the present disclosure, a method for preparing a Pickering emulsion as disclosed herein comprises combining a dispersed phase material, a continuous phase, and filamentous fungal particles to form a mixture; and agitating the mixture to form the Pickering emulsion.

In embodiments, the continuous phase may comprise water.

In another aspect of the present disclosure, a colloid comprises a first phase; a second phase; and filamentous fungal particles, the colloid having a zeta potential magnitude, at a temperature of 20° C. and a pH of between 5 and 7, of at least about 10 mV, at least about 15 mV, or at least about 20 mV.

In another aspect of the present disclosure, a method for preparing an ice cream analog food product comprises (a) heating a first mixture to a first temperature, the first mixture comprising a fungal dispersion, the fungal dispersion comprising particles of filamentous fungus dispersed in a liquid; (b) adding at least one monosaccharide, disaccharide, or polysaccharide to the first mixture to form a fungus- and saccharide-containing mixture; (c) heating the fungus- and saccharide-containing mixture to a second temperature; (d) heating the fungus- and saccharide-containing mixture to a third temperature and maintaining this temperature for at least about two minutes to form an emulsion; (e) cooling the emulsion to a fourth temperature; (f) churning the emulsion to incorporate air into the emulsion; and (g) freezing the emulsion to a fifth temperature.

In embodiments, the method may further comprise, during step (b), between steps (b) and (c), during step (c), between steps (c) and (d), or during step (d), adding a fatty substance to the fungus- and saccharide-containing mixture.

In embodiments, at least one of the first mixture and the fatty substance may comprise a flavoring ingredient.

In embodiments, at least one of the following may be true: (i) the first temperature is about 40° C.; (ii) the second temperature is between about 45° C. and about 70° C.; (iii) the third temperature is about 82° C.; (iv) the fourth temperature is about 5° C.; and (v) the fifth temperature is about −18° C.

In embodiments, the method may further comprise, between steps (e) and (f) or during step (f), adding a flavoring ingredient to the emulsion.

In embodiments, the method may further comprise, between steps (b) and (c) or during step (c), adding a foam stabilizer to the second mixture.

In embodiments, the first mixture may comprise at least one monosaccharide or disaccharide and at least one polysaccharide.

In embodiments, a freezing temperature of the fungal dispersion may be greater than −0.5° C.

In embodiments, the fungal dispersion may have a CIELAB lightness value L* of at least about 64.

In embodiments, the fungal dispersion may have a dietary fiber content of at least about 2 wt %.

In another aspect of the present disclosure, an ice cream analog food product is made by a method as disclosed herein.

The advantages of the present invention will be apparent from the disclosure contained herein.

As used herein, “at least one,” “one or more,” and “and/or” are open-ended expressions that are both conjunctive and disjunctive in operation. For example, each of the expressions “at least one of A, B, and C,” “at least one of A, B, or C,” one or more of A, B, and C,” “one or more of A, B, or C,” and “A, B, and/or C” means A alone, B alone, C alone, A and B together, A and C together, B and C together, or A, B, and C together.

It is to be noted that the term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The embodiments and configurations described herein are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is a flowchart illustrating a method for preparing an ice cream analog food product, according to embodiments of the present invention.

FIG. 2 is a graph illustrating results of viscosity testing of an aqueous filamentous fungal homogenate, according to embodiments of the present invention.

FIG. 3 is a graph illustrating results of viscosity testing of an aqueous filamentous fungal homogenate treated with a protease, according to embodiments of the present invention.

FIG. 4 is a graph illustrating results of viscosity testing of an aqueous filamentous fungal homogenate treated with glycine, according to embodiments of the present invention.

FIG. 5 is a graph illustrating results of viscosity testing of an aqueous filamentous fungal homogenate treated with saponins, according to embodiments of the present invention.

FIGS. 6A and 6B are graphs illustrating results of viscosity testing of an aqueous filamentous fungal homogenate, respectively before and after replacement of the supernatant with a potassium chloride solution, according to embodiments of the present invention.

FIGS. 7A, 7B, and 7C are images of the morphology of vanilla ice cream analog products made with a drum-dried filamentous fungal flour, a spray-dried filamentous fungal flour, and a filamentous fungal milk, respectively, according to embodiments of the present invention.

FIGS. 8A, 8B, and 8C are images of the morphology of strawberry ice cream analog products made with a drum-dried filamentous fungal flour, a spray-dried filamentous fungal flour, and a filamentous fungal milk, respectively, according to embodiments of the present invention.

FIGS. 9A, 9B, and 9C are images of the morphology of chocolate ice cream analog products made with a drum-dried filamentous fungal flour, a spray-dried filamentous fungal flour, and a filamentous fungal milk, respectively, according to embodiments of the present invention.

FIGS. 10A and 10B are images of dairy-based emulsions and fungal-based emulsions, respectively, according to embodiments of the present invention.

FIG. 11 are images of the emulsions of FIGS. 10A and 10B after dilution with boiling water.

FIGS. 12A and 12B are images of two of the dairy-based emulsions of FIG. 11 after straining with a stainless-steel kitchen strainer.

FIGS. 13A and 13B are images of two of the fungal-based emulsions of FIG. 11 after straining with a stainless-steel kitchen strainer.

FIGS. 14A, 14B, 14C, 14D, 14E, 14F, and 14G are visual microscopy images illustrating the morphology of fungal “milks” (aqueous dispersions of fungal particles) using size-reduced Fusarium strain flavolapis biomat particles, submerged fermentation-derived Fusarium strain flavolapis particles, spray-dried Fusarium strain flavolapis particles, drum-dried Fusarium strain flavolapis particles, size-reduced oyster mushroom particles, size-reduced portobello mushroom particles, and size-reduced shiitake mushroom particles, respectively.

FIG. 15 is a graph of the evolution of temperature in viscosity testing of ice cream analog precursor mixes according to the present disclosure.

FIGS. 16A through 16H are scanning electron microscopy (SEM) images of eight ice cream analog food products according to the present disclosure at 500× magnification.

FIGS. 17A through 17H are scanning electron microscopy (SEM) images of eight ice cream analog food products according to the present disclosure at 1,000× magnification.

FIG. 18 is an SEM image of an ice cream analog food product according to the present disclosure at 200× magnification, with annotations depicting various microscopic structural features within the ice cream analog food product.

### DETAILED DESCRIPTION OF THE INVENTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary of the Invention prevails unless otherwise stated.

As used herein, unless otherwise specified, the term “analog” or “analog food product” refers to a food product comprising edible fungi that bears an aesthetic, culinary, nutritional, and/or sensory equivalence or resemblance to an identified non-fungal food product. By way of non-limiting example, an “ice cream food analog product,” as that term is used herein, refers to a food product comprising edible fungi that bears an aesthetic, culinary, nutritional, and/or sensory equivalence or resemblance to conventional ice cream made from animal milk, and a “mayonnaise food analog product,” as that term is used herein, refers to a food product comprising edible fungi that bears an aesthetic, culinary, nutritional, and/or sensory equivalence or resemblance to conventional mayonnaise made using animal products.

As used herein, unless otherwise specified, the term “colloid” refers to a mixture in which particles of one substance (the “dispersed phase”) are dispersed throughout a volume of a different substance (the “dispersion medium”); for example, the dispersed phase can comprise or consist of microscopic bubbles, particles, etc. Where the dispersed phase and the dispersion medium of a colloid are specifically identified herein, they are separated by a hyphen, with the dispersed phase identified first, e.g., a reference herein to an “oil-water colloid” refers to a colloid in which an oil is the dispersed phase and water is the dispersion medium.

As used herein, unless otherwise specified, the term “emulsion” refers to a colloid in which both the dispersed phase and the dispersion medium are liquids. Examples of emulsions as that term is used herein include but are not limited to butter (when melted), margarine (when melted), mayonnaise and milk.

As used herein, unless otherwise specified, the term “foam” refers to a colloid in which the dispersed phase is a gas, and the dispersion medium is a liquid. Examples of foams as that term is used herein include but are not limited to egg white foam (i.e., the product of whisking, or otherwise incorporating, air into egg white) and whipped cream.

As used herein, unless otherwise specified, the term “foam stability” refers to the proportion of an initial volume of a foam that is retained by the foam after a specified interval. By way of non-limiting example, a foam that has an initial volume of five liters and a volume of four liters 14 days later thus has 80% stability over 14 days. Unless otherwise specified, a “stable” foam, as that term is used herein, is a foam that has at least 50% stability after a specified interval.

As used herein, unless otherwise specified, the term “gel” refers to a colloid in which the dispersed phase is a liquid, and the dispersion medium is a solid. Examples of gels as that term is used herein include but are not limited to blancmange, butter (when cold), custard (after it is cooked), jam, jelly (after it is set), and margarine (when cold). Gels, as that term is used herein, may behave as solids or semi-solids and typically have an elastic modulus greater than their dynamic (or loss) modulus, and thus do not readily flow.

As used herein, unless otherwise specified, the term “liquid aerosol” refers to a colloid in which the dispersed phase is a liquid, and the dispersion medium is a gas.

As used herein, unless otherwise specified, the term “sol” refers to a colloid in which the dispersed phase is a solid and the dispersion medium is a liquid. Examples of sols as that term is used herein include but are not limited to custard (before it is cooked) and jelly (before it is set).

As used herein, unless otherwise specified, the term “solid aerosol” refers to a colloid in which the dispersed phase is a solid and the dispersion medium is a gas.

As used herein, unless otherwise specified, the term “solid foam” refers to a colloid in which the dispersed phase is a gas, and the dispersion medium is a solid. Examples of solid foams as that term is used herein include but are not limited to bread, cake, ice cream, and meringue.

As used herein, unless otherwise specified, the term “solid sol” refers to a colloid in which both the dispersed phase and the dispersion medium are solids.

As used herein, unless otherwise specified, the term “vegan” refers to a food product that is substantially free of food components or ingredients, such as protein, derived from animals. Specific examples of non-vegan food ingredients or products include blood, eggs, isinglass, meat (and components thereof, e.g., animal fats), milk, rennet, and foods made using any one or more of these ingredients (e.g., ice cream, mayonnaise, etc.). As disclosed herein, some vegan food products may be analogs of non-vegan food products.

To comply with applicable written description and enablement requirements, the following references are incorporated herein by reference in their entireties:
Yousef Al-Doory and Howard W. Larsh, “Quantitative studies of total lipids of pathogenic fungi,” 10 (6) Applied Microbiology 492 (November 1962).
Leslie R. Barran and Ian de la Roche, “Effect of temperature on phospholipid composition of mid-log hyphal cells of Fusarium oxysporum f. sp. lycopersici,” 73 (1) Transactions of the British Mycological Society 166 (August 1979).
D. M. Lösel, “Lipids in the Structure and Function of Fungal Membranes,” in Paul J. Kuhn et al. (eds.), Biochemistry of Cell Walls and Membranes in Fungi (1990).
H. Douglas Goff, “Colloidal aspects of ice cream—a review,” 7 (6-7) International Dairy Journal 363 (June-July 1997).
Han A. B. Wösten, “Hydrophobins: multipurpose proteins,” 55 Annual Review of Microbiology 626 (October 2001).
B. Baderschneider et al., “Sequence analysis and resistance to pepsin hydrolysis as part of an assessment of the potential allergenicity of ice structuring protein type III HPLC 12,” 40 (7) Food and Chemical Toxicology 965 (July 2002).
Robert T. Marshall et al., Ice Cream (6th ed. 2003).
U.S. Patent Application Publication 2006/0024417, entitled “Aerated food products,” published 2 Feb. 2006 to Berry et al.
U.S. Patent Application Publication 2006/0024419, entitled “Frozen products,” published 2 Feb. 2006 to Aldred et al.
U.S. Patent Application Publication 2007/0286936, entitled “Low fat frozen confectionery product,” published 13 Dec. 2007 to Bramley et al.
Marilyn C. Erickson, “Chemistry and Function of Phospholipids,” in Casimir C. Akoh and David B. Min (eds.), Food Lipids: Chemistry, Nutrition, and Biotechnology (3d ed. 2008).
U.S. Patent Application Publication 2008/0213453, entitled “Aerated food products and methods for producing them,” published 4 Sep. 2008 to Burmester et al.
U.S. Pat. No. 7,442,769, entitled “Antifreeze proteins from basidiomycetes,” issued 28 Oct. 2008 to Hoshino et al.
U.S. Pat. No. 7,981,313, entitled “Use of hydrophobins to prevent ice from forming on surfaces,” issued 19 Jul. 2011 to Baus et al.
Tuija Sarlin et al., “Identification and characterization of gushing-active hydrophobins from Fusarium graminearum and related species,” 52 (2) Journal of Basic Microbiology 184 (April 2012).
Hina Bansal et al., “A comparative study of antifreeze proteins from Antarctomyces psychrotrophicus and Typhula ishikariensis using computational tools and servers,” 5 (1) VIVECHAN International Journal of Research 21 (2014).
PCT Application Publication WO 2014/026885, entitled “Stabilized aerated frozen confection containing hydrophobin,” published 20 Feb. 2014 to Cox et al.
Mohammadreza Khalesi et al., “Recent advances in fungal hydrophobin towards using in industry,” 34 The Protein Journal 243 (July 2015).
David Julian McClements and Cansu Ekin Gumus, “Natural emulsifiers biosurfactants, phospholipids, biopolymers, and colloidal particles: molecular and physicochemical basis of functional performance,” 234 Advances in Colloid and Interface Science 3 (August 2016).
PCT Application Publication WO 2016/193292, entitled “Use of ice structuring protein AFP 19 expressed in filamentous fungal strains for preparing food,” published 8 Dec. 2016 to Dekker et al.
T. Finnigan et al., “Mycoprotein: A Healthy New Protein with a Low Environmental Impact,” in Sudarshan R. Nadathur et al. (eds.), Sustainable Protein Sources (2017).
Yuanzheng Wu et al., “Fungal and mushroom hydrophobins: a review,” 15 (1) Journal of Mushroom 1 (March 2017).
Abdelmoneim H. Ali et al., “Natural phospholipids: occurrence, biosynthesis, separation, identification, and beneficial health aspects,” 59 (2) Critical Reviews in Food Science and Nutrition 253 (October 2017).
Tuyen Truong et al., Dairy Fat Products and Functionality (2020).
Aneta Białkowska et al., “Ice binding proteins: diverse biological roles and applications in different types of industry,” 10 (2) Biomolecules 274 (February 2020).
J. Lonchamp et al., “Sonicated extracts from the Quorn fermentation co-product as oil-lowering emulsifiers and foaming agents,” 246 European Food Research and Technology 767 (February 2020).
Eleonora Loffredi et al., “Effects of different emulsifier substitutes on artisanal ice cream quality,” 137 LWT 110499 (February 2021).

Embodiments of the present invention include colloidal suspensions of filamentous fungi, typically colloidal suspensions of edible filamentous fungi, and most typically colloidal food compositions, i.e., edible colloidal compositions that are adapted for consumption by humans or domesticated, farmed (e.g., agriculture or aquaculture), or livestock animals, that include filamentous fungal particles. In some embodiments, the colloidal food composition may be a food product that is analogous to a conventional or known food product comprising a dairy or otherwise animal-derived ingredient (milk, egg, etc.), wherein the filamentous fungal particles are provided in addition to or in lieu of the animal-derived ingredient. In some embodiments, the colloidal food composition may be a non-dairy composition or food product and may be a vegan (i.e., no animal-derived components) composition or food product. Embodiments of colloidal food compositions include, without limitation, blancmange, bread, butter, cake, creamers (e.g., for coffee and tea), custard, egg white foam, ice cream, jam, jelly, margarine, mayonnaise, meringue, milk, and whipped cream, and analogs thereof. It is to be expressly understood that any reference herein to “filamentous fungal particles” may refer to “dry” particles, i.e., particles from which (or derived from a biomass from which) moisture has been removed, or “wet” particles, i.e., particles that are accompanied by or are part of a biomass that includes a significant quantity of moisture, such as a biomat that may contain up to at least about 75 wt % water.

In some embodiments, the colloidal food compositions include food products comprising a first phase of a gas, e.g., air and a second phase comprising sugars, wherein the filamentous fungal particles provide a source of protein and/or physical structure (e.g., a web of fungal filaments interwoven with the dispersion medium) for the food product. Examples of such products include desserts, such as an ice cream analog food product, wherein the filamentous fungal particles provide a source of protein in addition to or in lieu of milk. In some embodiments, the colloidal food compositions include food products comprising a first oily or lipid-rich phase and a second aqueous phase, wherein the oily or lipid-rich phase is dispersed throughout the aqueous phase and the filamentous fungal particles are provided in addition to or in lieu of egg yolk but provide a similar colloid stabilizing effect. Examples of such products include mayonnaise, butter, margarine, cream cheese, etc. The colloidal food composition may be any type of colloid in which the filamentous fungal particles may act to stabilize interfacial tension of an interface between any two of air, water, and oil, such as, by way of non-limiting example, a water-oil colloid, an oil-water colloid, and/or an air-water colloid, as well as “double” or more complex colloids (e.g. air-in-oil-in-water, air-in-water-in-oil, water-in-oil-in-water, oil-in-water-in-oil, air-in-water-in-oil, etc.).

In many embodiments, the colloidal food composition may include “dry” filamentous fungal particles (e.g., in the form of a powder or “flour” from which moisture has been removed) in amounts of between about 2.5 wt % and about 17.0 wt %, or between about 6.0 wt % and about 17.0 wt %, or between about 12.8 wt % and about 17.0 wt %, or alternatively in any subrange from any tenth of a weight percent between 2.5 wt % and 17.0 wt % (inclusive) to any other tenth of a weight percent between 2.5 wt % and 17.0 wt % (inclusive). Alternatively, the colloidal food composition may include “wet” filamentous fungal particles (i.e. a combination of filamentous fungal particles and water, such as in the form of an undried or undehydrated biomass derived from a surface fermentation process, a submerged fermentation process, or a solid substrate fermentation process) that provides an equivalent weight of filamentous fungal tissue; by way of non-limiting example, a biomass that is 75 wt % water and 25 wt % solids may provide “wet” filamentous fungal particles to the colloidal food composition in amounts of between 10.0 wt % and about 68.0 wt %, or between about 24.0 wt % and about 68.0 wt %, or between about 51.2 wt % and about 68.0 wt %, or alternatively in any subrange from any tenth of a weight percent between 10.0 wt % and 68.0 wt % (inclusive) to any other tenth of a weight percent between 10.0 wt % and 68.0 wt % (inclusive) of the colloidal food composition.

In many embodiments, the filamentous fungal particles of the colloidal food composition will provide a substantial fraction, and generally at least the majority, of the protein in the colloidal food composition. Particularly, the filamentous fungal particles may provide at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, at least about 96 wt %, at least about 97 wt %, at least about 98 wt %, at least about 99 wt %, or substantially all of the protein in the colloidal food composition. In some embodiments the protein content of the filamentous fungal particles may allow the filamentous fungal particles to take the place of a protein-rich ingredient found in an analogous conventional food product, particularly an animal-derived ingredient (e.g., milk, egg, etc.), whereas in other embodiments the filamentous fungal particles may be provided in addition to or as a partial replacement for a protein-rich ingredient to augment the protein content of the food product. The filamentous fungal particles may comprise at least about 30%, at least about 31 wt %, at least about 32 wt %, at least about 33 wt %, at least about 34 wt %, at least about 35 wt %, at least about 36 wt %, at least about 37 wt %, at least about 38 wt %, at least about 39 wt %, at least about 40 wt %, at least about 41 wt %, at least about 42 wt %, at least about 43 wt %, at least about 44 wt %, at least about 45 wt %, at least about 46 wt %, at least about 47 wt %, at least about 48 wt %, at least about 49 wt %, at least about 50 wt %, at least about 51 wt %, at least about 52 wt %, at least about 53 wt %, at least about 54 wt %, at least about 55 wt %, at least about 56 wt %, at least about 57 wt %, at least about 58 wt %, at least about 59 wt %, at least about 60 wt % protein content, at least about 61 wt %, at least about 62 wt %, at least about 63 wt %, at least about 64 wt %, at least about 65 wt %, at least about 66 wt %, at least about 67 wt %, at least about 68 wt %, at least about 69 wt %, at least about 70 wt % protein content, at least about 71 wt %, at least about 72 wt %, at least about 73 wt %, at least about 74 wt %, at least about 77 wt %, at least about 76 wt %, at least about 77 wt %, at least about 78 wt %, at least about 79 wt %, or at least about 80 wt % protein content. Alternatively, in embodiments of the invention, filamentous fungi can comprise protein in a range between 30 wt % and 80 wt % or in any whole number percentage range between 30 wt % and 80 wt %. As a result, the colloidal food compositions of the present invention may thus have a notably high or enriched protein content, which may in embodiments be about at least about 4.0 wt %, at least about 4.5 wt %, at least about 5.0 wt %, at least about 5.5 wt %, at least about 6.0 wt %, at least about 6.5 wt %, at least about 7.0 wt %, at least about 7.5 wt %, at least about 8.0 wt %, at least about 8.5 wt %, at least about 9.0 wt %, at least about 9.5 wt %, at least about 10.0 wt %, at least about 10.5 wt %, at least about 11.0 wt %, at least about 11.5 wt %, at least about 12.0 wt %, or at least about 12.5 wt % of the colloidal food composition.

In addition to having a high overall protein content, filamentous fungal particles in colloidal food compositions of the present invention may provide advantageous protein compositions or chemistries. By way of first non-limiting example, the filamentous fungal particles may represent a “complete” protein source by providing all nine essential amino acids and/or all 20 proteinogenic amino acids. By way of second non-limiting example, the filamentous fungal particles may comprise at least one branched-chain amino acid (e.g., leucine, isoleucine, valine), and may in some embodiments contain such amino acids in amounts of at least about 10 wt %, at least about 15 wt %, at least about 20 wt %, at least about 25 wt %, or at least about 30 wt %.

Filamentous fungal particles may provide various other nutritional or compositional advantages to the colloidal food compositions of the present invention as well. By way of first non-limiting example, the filamentous fungal particles may have an advantageously high content of dietary fiber to allow for the creation of high-fiber food products (and in particular high-fiber alternatives to or analogs of conventional food products that may have lower fiber contents); in some embodiments, the filamentous fungal particles may comprise at least about 27 wt %, at least about 28 wt %, at least about 29 wt %, at least about 30 wt %, at least about 31 wt %, at least about 32 wt %, at least about 33 wt %, at least about 34 wt %, at least about 35 wt %, or at least about 36 wt % dietary fiber. A high fiber content may be advantageous for any one or more additional reasons not directly related to nutritional composition, e.g. improved hydration properties (such as decreased water activity to allow for easier preparation/storage and longer shelf life), increased satiation or “fullness” upon eating (which may encourage consumers to eat more moderate portions of “indulgence” products such as ice cream analog food products or mayonnaise analog food products and thereby aid in preventing or mitigating adverse health effects such as high cholesterol), improved digestibility, etc.

By way of second non-limiting example, the filamentous fungal particles may be dried to have an advantageously low moisture content, which may in some embodiments allow for the formation of more stable colloids, longer shelf life, etc.; in some embodiments, a moisture content of the filamentous fungal particles may be no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, no more than about 6 wt %, no more than about 5 wt %, or no more than about 4 wt %.

One advantageous nutritional or compositional feature provided by the filamentous fungal particles in colloidal food compositions of the present invention is that these particles may provide a beneficially high content of phospholipids, i.e., lipid molecules having both a hydrophilic “head” (containing a negatively charged phosphate group) and two hydrophobic “tails” (derived from fatty acids and joined by an alcohol residue). Because phospholipids have appreciable non-polar and polar regions within the same molecule, they are amphiphilic molecules that can adsorb to oil-water interfaces and stabilize lipid droplets in a colloid. As a result of these properties, phospholipids can act as emulsifiers and are the major components of lecithin, a substance found in egg yolk that is widely used as a food emulsifier (including, especially, in conventional mayonnaise); however, some commercial lecithin ingredients are not particularly good at stabilizing oil-in-water emulsions when used in isolation because they have low or intermediate hydrophilic-lipophilic balance numbers (HLB values between about 2 and about 8). These same properties allow phospholipids to act as an emulsifying agent in milk (and therefore in dairy-based colloids such as ice cream), preventing the fat globules in the milk from aggregating and coalescing in the aqueous environment of the milk and thus preventing separation, or “creaming,” of the milk for an extended period, and have further been shown to improve the heat stability of dairy products. Thus, in the practice of the present invention, it is possible to provide filamentous fungal particles that, because they include phospholipids in substantial quantities, naturally act as an emulsifier to stabilize the colloidal composition, which may in embodiments allow the quantity of other emulsifiers to be reduced or even eliminated when preparing the colloidal composition to produce a “cleaner” product (as some conventional emulsifiers may produce a “gummy,” “sticky,” or “tacky” texture) and promote or control release of flavoring ingredients. In some embodiments, the filamentous fungal particles may comprise phospholipids in amounts of at least about 11.0 μmol/g, at least about 11.5 μmol/g, at least about 12.0 μmol/g, at least about 12.5 μmol/g, at least about 13.0 μmol/g, at least about 13.5 μmol/g, at least about 14.0 μmol/g, or at least about 14.5 μmol/g. The filamentous fungal particles may, additionally or alternatively, comprise phospholipids in amounts of at least about 0.01 wt %, at least about 0.02 wt %, at least about 0.03 wt %, at least about 0.04 wt %, at least about 0.05 wt %, at least about 0.1 wt %, at least about 0.15 wt %, at least about 0.2 wt %, at least about 0.25 wt %, at least about 0.3 wt %, at least about 0.35 wt %, at least about 0.4 wt %, at least about 0.45 wt %, at least about 0.5 wt %, at least about 0.6 wt %, at least about 0.7 wt %, at least about 0.8 wt %, at least about 0.9 wt %, at least about 1.0 wt %, at least about 1.1 wt %, at least about 1.2 wt %, at least about 1.3 wt %, at least about 1.4 wt %, at least about 1.5 wt %, at least about 1.6 wt %, at least about 1.7 wt %, at least about 1.8 wt %, at least about 1.9 wt %, at least about 2.0 wt %, at least about 2.1 wt %, at least about 2.2 wt %, at least about 2.3 wt %, at least about 2.4 wt %, at least about 2.5 wt %, at least about 2.6 wt %, at least about 2.7 wt %, at least about 2.8 wt %, at least about 2.9 wt %, or at least about 3.0 wt %. In turn, the colloidal composition as a whole may comprise phospholipids in amounts of at least about 0.01 wt %, at least about 0.02 wt %, at least about 0.03 wt %, at least about 0.04 wt %, at least about 0.05 wt %, at least about 0.1 wt %, at least about 0.15 wt %, at least about 0.2 wt %, at least about 0.25 wt %, at least about 0.3 wt %, at least about 0.35 wt %, at least about 0.4 wt %, at least about 0.45 wt %, at least about 0.5 wt %, at least about 0.6 wt %, at least about 0.7 wt %, at least about 0.8 wt %, at least about 0.9 wt %, at least about 1.0 wt %, at least about 1.1 wt %, at least about 1.2 wt %, at least about 1.3 wt %, at least about 1.4 wt %, at least about 1.5 wt %, at least about 1.6 wt %, at least about 1.7 wt %, at least about 1.8 wt %, at least about 1.9 wt %, at least about 2.0 wt %, at least about 2.1 wt %, at least about 2.2 wt %, at least about 2.3 wt %, at least about 2.4 wt %, at least about 2.5 wt %, at least about 2.6 wt %, at least about 2.7 wt %, at least about 2.8 wt %, at least about 2.9 wt %, or at least about 3.0 wt %.

It is to be expressly understood that any one or more of various other chemical constituents of filamentous fungi may also serve as emulsifiers, surfactants, or surface-active agents (e.g., to reduce surface tension between the oil phase and the aqueous phase, and/or to coat oil droplets to prevent them from coalescing, in a mayonnaise analog food product), foam stabilizers, etc. Without wishing to be bound by any particular theory, non-limiting examples of such constituents may include proteins, saccharides (e.g. polysaccharides, mono- and diglycerides of fatty acids, lactic acid esters, propylene glycol esters, etc.), amphiphilic compounds other than phospholipids, extracellular polymeric substances (EPSs), or even compounds present on the surface of fungal cells as residues left over from fermentation processes (e.g. salts or nutrients from a fungal growth medium). In some embodiments, the filamentous fungus as a whole, or a single compound or group of compounds therein, may serve multiple functions; for example, as the solid or semi-solid phase of an ice cream analog food product is itself a complex colloid of water ice, sugars, etc., the fungal particles, or a single compound or group of compounds therein, may act as both an emulsifier (of the various solid- and/or liquid-phase species that make up the dispersion medium for air) and a foam stabilizer (of air in the dispersion medium). The fungal particles may, in some embodiments, even act to provide still further advantageous chemical, mechanical, and/or rheological properties to the colloidal food compositions of the invention, in some cases improving these properties even beyond those of conventional non-fungal food products to which the compositions are analogous; by way of non-limiting example, the fungal particles may raise the freezing point of the colloidal food composition and in some embodiments may do so to a greater extent than common stabilizers such as locust bean gum or guar gum (e.g. to allow ice cream analog food products to remain solid at higher temperatures than conventional ice creams), thicken or bind the dispersion medium (e.g. as a matrix material substituting for gluten to provide a gluten-free bread or cake analog food product), and so on.

A further nutritional or compositional advantage provided by the colloidal food compositions of the present invention is that the filamentous fungi may be produced by methods that enable the filamentous fungi to contain functional compounds that may not be present in, or cannot be delivered by, conventional food products. By way of first non-limiting example, the growth media in which filamentous fungi are produced may be imparted with any one or more beneficial nutrients or compounds (vitamins, lipids, glycolipids, polysaccharides, sugar alcohols, ω-3 fatty acids, etc.) that may be taken up by the fungus and thus passed on to the consumer of the colloidal food product. By way of second non-limiting example, the growth media in which filamentous fungi are produced may be imparted with any one or more compounds (e.g., pigments, inks, dyes, fragrances, etc.) that may be taken up by the fungus and improve an aesthetic or sensory quality of the filamentous fungus.

A further nutritional or composition advantage provided by the colloidal food compositions of the present invention is that the compositions may be free of allergens and/or animal-derived products that may otherwise prevent persons with allergenic sensitivities or dietary restrictions (e.g., vegans) from consuming analogous conventional food products. By way of non-limiting example, analogs of a wide variety of conventional colloidal food products (e.g., ice cream, mayonnaise, etc.) that are lactose-free, egg-free, soy-free, and dairy-free may be produced according to the present invention. Even more advantageously, these problematic ingredients can in some embodiments be replaced by components having nutritional benefits, e.g., lactose may be replaced by one or more β-glucans.

In embodiments, at least a portion of the filamentous fungal particles may be provided as a “flour,” i.e., as relatively fine particles suitable for dispersion in a colloidal dispersion medium and/or stabilization of other phases in a colloidal system. Often, filamentous fungal particles suitable for use in colloidal food compositions according to the invention will have a length of between about 0.05 mm and about 500 mm, a width of between about 0.03 mm and about 7 mm, and a height of between about 0.03 mm and about 1.0 mm, and most often will have a particle size of between about 0.03 mm and 0.4 mm. In some embodiments, filamentous fungal particles provided as a flour may have an average particle size of between about 75 microns and about 100 microns, and in some embodiments may have a 5th percentile particle size of about 75 microns and a 95th percentile particle size of about 180 microns. In other embodiments, filamentous fungal particles provided as a flour may have a 10th percentile particle size of between about 1 micron and about 5 microns or of about 3.9 microns, a median particle size of between about 10 microns and about 15 microns or of about 12.6 microns, and a 90th percentile particle size of between about 20 microns and about 30 microns or of about 27.4 microns.

In particular embodiments, no more than about 36.2% of the filamentous fungal particles may have a particle size of less than about 53 microns, and/or between about 10.7% and about 67.1% of the filamentous fungal particles may have a particle size of less than about 105 microns, and/or no more than about 69.8% of the filamentous fungal particles may have a particle size of between about 53 microns and about 105 microns, and/or between about 2.7% and about 59.6% of the filamentous fungal particles may have a particle size of between about 105 microns and about 177 microns, and/or no more than about 28.6% of the filamentous fungal particles may have a particle size of between about 177 microns and about 250 microns, and/or no more than about 42.6% of the filamentous fungal particles may have a particle size of between about 250 microns and about 350 microns, and/or no more than about 41.8% of the filamentous fungal particles may have a particle size of between about 350 microns and about 590 microns; and/or no more than about 4.8% of the filamentous fungal particles may have a particle size of between about 590 microns and about 1190 microns. Additionally, or alternatively, a circular equivalent mean particle size of the filamentous fungal particles may be between about 3.64 microns and about 4.64 microns, or between about 1.46 microns and about 6.42 microns. Additionally, or alternatively, the filamentous fungal particles may have a length of between about 1 micron and about 50 microns or any tenth of a micron therebetween, or alternatively in any range between 1 micron and 50 microns, or in any range from any tenth of a micron between 1 micron and 50 microns to any other tenth of a micron between 1 micron and 50 microns.

In some embodiments, a “dry” filamentous fungal flour (i.e. a filamentous fungal powder with a relatively low moisture content, typically between about 4 wt % and about 14 wt % and most typically no more than about 12 wt %) may be used directly in the colloidal food composition, whereas in other embodiments the filamentous fungal particles may be dispersed in a suitable dispersion medium (typically water) to form a “milk” that may be used to produce the colloidal food composition. Typically, a weight ratio of water to fungal particles in such dispersions may be between about 1:10 and about 10:1, or in any subrange therebetween. Alternatively, the ratio may be between about 2.5 and about 3.5, or between about 2.6 and about 3.4, or between about 2.7 and about 3.3, or between about 2.8 and about 3.2, or between about 2.9 and about 3.1, or about 3.0.

In embodiments, the filamentous fungal particles may be provided as a “homogenate,” i.e., as a paste-like or slurry-like material, which may be formed by agitating, mixing, and/or blending the filamentous fungal particles together with a binder or dispersion medium (typically water) or in situ by, e.g., a submerged fermentation process. Typically, a weight ratio of water to fungal particles in such homogenates may be between about 1:10 and about 10:1, or in any subrange therebetween. Alternatively, the ratio may be between about 2.5 and about 3.5, or between about 2.6 and about 3.4, or between about 2.7 and about 3.3, or between about 2.8 and about 3.2, or between about 2.9 and about 3.1. In some embodiments, filamentous fungal particles provided as a homogenate may have a 10^{th}-percentile particle size of between about 1 micron and about 5 microns or of about 4 microns, a median particle size of between about 10 microns and about 15 microns or of about 11 microns, and a 90^{th}-percentile particle size of between about 20 microns and about 30 microns or of about 23 microns.

The filamentous fungi suitable for use in the invention (either as biomats or as particles in food materials) may be selected from the phyla or divisions zygomycota, glomermycota, chytridiomycota, basidiomycota or ascomycota. The phylum (or division) basidiomycota comprises, inter alia, the orders Agaricales, Russulales, Polyporales and Ustilaginales; the phylum ascomycota comprises, inter alia, the orders Pezizales and Hypocreales; and the phylum zygomycota comprises, inter alia, the order Mucorales. The particles of edible filamentous fungi of the present invention belong to an order selected from Ustilaginales, Russulales, Polyporales, Agaricales, Pezizales, Hypocreales and Mucorales.

In some embodiments, the filamentous fungi of the order Ustilaginales are selected from the family Ustilaginaceae. In some embodiments, the filamentous fungi of the order Russulales are selected from the family Hericiaceae. In some embodiments, the filamentous fungi of the order Polyporales are selected from the families Polyporaceae or Grifolaceae. In some embodiments, the filamentous fungi of the order Agaricales are selected from the families Lyophyllaceae, Strophariaceae, Lycoperdaceae, Agaricaceae, Pleurotaceae, Physalacriaceae, or Omphalotaceae. In some embodiments, the filamentous fungi of the order Pezizales are selected from the families Tuberaceae or Morchellaceae. In some embodiments, the filamentous fungi of the order Mucorales are selected from the family Mucoraceae.

In some embodiments, the filamentous fungi may be selected from the genera Fusarium, Aspergillus, Trichoderma, Rhizopus, Ustilago, Hericululm, Polyporous, Grifola, Hypsizygus, Calocybe, Pholiota, Calvatia, Stropharia, Agaricus, Hypholoma, Pleurotus, Morchella, Sparassis, Disciotis, Cordyceps, Ganoderma, Flammulina, Lentinula, Ophiocordyceps, Trametes, Ceriporia, Leucoagaricus, Handkea, Monascus and Neurospora.

Examples of the species of filamentous fungi include, without limitation, Ustilago esculenta, Hericululm erinaceus, Polyporous squamosus, Grifola fondrosa, Hypsizygus marmoreus, Hypsizygus ulmariuos (elm oyster) Calocybe gambosa, Pholiota nameko, Calvatia gigantea, Agaricus bisporus, Stropharia rugosoannulata, Hypholoma lateritium, Pleurotus eryngii, Pleurotus ostreatus (pearl), Pleurotus ostreatus var. columbinus (Blue oyster), Tuber borchii, Morchella esculenta, Morchella conica, Morchella importuna, Sparassis crispa (cauliflower), Fusarium venenatum, Fusarium strain flavolapis, Disciotis venosa, Cordyceps militaris, Ganoderma lucidum (reishi), Flammulina velutipes, Lentinula edodes, Ophiocordyceps sinensis. Additional examples include, without limitation, Trametes versicolor, Ceriporia lacerate, Pholiota gigantea, Leucoagaricus holosericeus, Pleurotus djamor, Calvatia fragilis, Handkea utriformis, Rhizopus oligosporus, and Neurospora crassa.

In some embodiments, the filamentous fungus is a Fusarium species. In some embodiments, the filamentous fungus is the Fusarium strain flavolapis that was deposited with the American Type Culture Collection, 1081 University Boulevard, Manassas, Virginia, USA and assigned ATCC Accession Deposit No. PTA-10698. Fusarium strain flavolapis ATCC Accession Deposit No. PTA-10698 was previously reported to be a Fusarium oxysporum strain and was originally referred to by the designation MK7. However, it has subsequently been identified as not being an oxysporum strain and is considered a novel strain of Fusarium that has been provisionally named Fusarium str. flavolapis. In some embodiments, the filamentous fungus is the Fusarium strain Fusarium venenatum.

Fungal biomass from which the filamentous fungal particles in colloidal food compositions of the invention are derived may be produced by a surface fermentation process as described in PCT Application Publication WO 2017/151684, a submerged fermentation process, a solid-state or solid substrate fermentation process, and/or a method as disclosed in PCT Application Publication WO2019/099474 (“the '474 publication”), the entirety of which is incorporated herein by reference. The filamentous fungal particles can be derived from a fungal biomass that is completely or substantially completely formed of mycelium. For filamentous fungi that form fruiting bodies, the fungal biomass can be completely or substantially completely formed of fruiting bodies. Further, the filamentous fungal particles can be derived from a fungal biomass that comprises conidia. In addition, the filamentous fungal particles can comprise a mixture of mycelium, conidia, and fruiting body material in any proportions.

The colloidal food compositions of the present invention may advantageously have a relatively high pH and/or a pH that is higher than that of an analogous conventional colloidal food product. Particularly, this higher pH may improve the heat stability of the colloidal food compositions, as it has been observed that many conventional or alternative colloidal food compositions of lower pH separate more rapidly when heated; for example, both conventional cream cheeses and vegan cream cheese analogs have been observed to separate at temperatures as low as 50° C. when the pH of these products is relatively low. Thus, embodiments of the present invention include colloidal food compositions having a pH of at least about 0, at least about 1, at least about 2, at least about 3, at least about 4, at least about 5, at least about 6, at least about 7, at least about 8, at least about 9, at least about 10, at least about 11, at least about 12, at least about 13, or at least about 14.

Alternatively, the colloidal food compositions of the present invention may advantageously have a relatively low pH and/or a pH that is lower than that of an analogous conventional colloidal food product. Particularly, this lower pH may improve the coagulation properties and/or rheology of the colloidal food compositions for certain applications, as it has been observed that colloidal food compositions may thicken at lower pH due to aggregation of proteins. Thus, embodiments of the present invention include colloidal food compositions having a pH of no more than about 14, no more than about 13, no more than about 12, no more than about 11, no more than about 10, no more than about 9, no more than about 8, no more than about 7, no more than about 6, no more than about 5, no more than about 4, no more than about 3, no more than about 2, no more than about 1, or no more than about 0.

A chemical and/or physical characteristic of the colloidal food compositions of the present invention is the stability of the colloid, i.e., the degree to which the two phases of the colloid remain homogeneously mixed with each other over a period. The stability of the colloid not only allows the colloidal food composition to maintain desired aesthetic, chemical, physical, or textural properties over an extended period, but may enable the colloid to be stored and/or transported for a significant period after formulation, providing stable product integrity, texture, taste, and eating experience. As known in the prior art, both viscosity and surface charge of dispersed colloidal particles are key enablers of colloidal compositions. Viscosity and zeta potential measurements of colloidal dispersions comprising Fusarium strain flavolapis are summarized in Table 6. In these samples, zeta potential ranged from −20.9 mV to −35.62 mV, which points towards the charge density that is required for a colloidal dispersion to maintain stability and reduce creaming, agglomeration, or flocculation of the dispersed phase. One skilled in the prior art can apply common additives such as salts, surfactants, stabilizers, and so on to further improve the charge density difference between colloidal particles and suspending medium. In embodiments, the dispersed phase and the dispersion medium of colloidal food compositions of the present invention may remain substantially homogenously mixed, and/or do may not visibly separate, for at least about one day, at least about two days, at least about three days, at least about four days, at least about five days, at least about six days, at least about one week, at least about two weeks, at least about three weeks, at least about one month, at least about two months, at least about three months, at least about four months, at least about five months, at least about six months, at least about seven months, at least about eight months, at least about nine months, at least about ten months, at least about eleven months, at least about twelve months, at least about thirteen months, at least about fourteen months, at least about fifteen months, at least about sixteen months, at least about seventeen months, or at least about eighteen months after formation of the colloidal composition.

The stability of colloidal food compositions of the present invention may, in some embodiments, be quantified in terms of the zeta potential of the colloid. The zeta potential of the colloid is the electric potential difference between the dispersion medium and a stationary layer of fluid attached to the dispersed particle; it is caused by the net electrical charge contained within the region bounded by, and depends on the location of, the slipping plane. Zeta potential may be expressed using either positive or negative units of voltage (depending on the charge). Generally, colloids with large positive or large negative zeta potential are considered electrically stabilized, while emulsions with zeta potentials closer to zero tend to be physically unstable and can exhibit rapid aggregation or flocculation of the dispersed phase. Zeta potential is thus a key parameter for predicting the physical stability of a colloid, alongside other parameters such as interfacial layer thickness, viscosity, temperature, pH, and the presence or absence of additives that may affect the interfacial surface charge between two phases on either side of an interface (air, water, lipid, etc., as well as complex combinations thereof as in double colloids). In embodiments of the present invention, the colloidal food product may have a zeta potential magnitude, at 20° C. and a pH of between 5 and 7, of at least about 5 mV, at least about 10 mV, at least about 15 mV, at least about 20 mV, at least about 25 mV, at least about 30 mV, at least about 35 mV, at least about 40 mV, at least about 45 mV, at least about 50 mV, at least about 55 mV, or at least about 60 m V.

In embodiments, it may be possible to control the zeta potential and viscosity, and thus the stability, of colloidal food compositions of the present invention by employing particular production and handling techniques of components of the compositions, particularly including the filamentous fungal particles or a fungal biomass from which they are derived. By way of first non-limiting example, a stability and/or zeta potential of the colloidal food composition may be controlled, selected, or tuned by the use of a selected technique (e.g. passive dehydration, drum drying, spray drying, etc.) for drying fungal biomass before it is size-reduced to form the filamentous fungal particles; without wishing to be bound by any particular theory, each of these drying techniques may result in a different viscosity of the colloidal food composition and/or average size of particles of the dispersed phase in the colloidal food composition, each of which may affect colloidal stability. By way of second non-limiting example, a stability and/or zeta potential of the colloidal food composition may be controlled, selected, or tuned by forming the colloidal food composition a selected length of time after growth of the fungal biomass and/or formation of the filamentous fungal particles, e.g., by aging the biomass or particles. By way of third non-limiting example, the morphology, structure, and/or degree of “entanglement” of a network of fungal filaments may be controlled, which may provide for greater ability of fungal filaments to stabilize particles of the dispersed phase within or at the surface of these filaments. By way of fourth non-limiting example, pretreatment of the fungal material (e.g., by heating and/or hydration) before incorporation into the colloidal food composition may increase the viscosity of the dispersion medium and allow for proper water activity and/or other chemical “activation” of the fungal particles, thereby producing a more stable colloid. By way of fifth non-limiting example, the distribution, diversity, and/or range of particle sizes of the filamentous fungal particles may be controlled or selected to allow for higher or lower stability in some food products (e.g., without wishing to be bound by any particular theory, by stabilizing different sizes of particles of the dispersed phase). Thus, in the practice of the present invention, it is possible to provide filamentous fungal particles that naturally act as an emulsifier and/or stabilizer of the colloidal composition, which may in embodiments allow the quantity of other non-fungal-derived emulsifiers and/or stabilizers to be reduced or even eliminated, e.g. to less than about 3 wt %, less than about 2.5 wt %, less than about 2 wt %, less than about 1.5 wt %, less than about 1 wt %, less than about 0.75 wt %, less than about 0.5 wt %, less than about 0.4 wt %, less than about 0.3 wt %, less than about 0.2 wt %, or less than about 0.1 wt % of the colloidal food composition; in some embodiments, the colloidal composition may be substantially free of non-fungal-derived emulsifiers, stabilizers, and/or surfactants. Further non-limiting examples of parameters that may be leveraged to control, select, or tune the stability and/or zeta potential of the colloidal food composition include particle size distribution, surface area, morphology, porosity, surface energy, and fungal particle chemistry (e.g., protein content, relative abundance of amino acids, etc.). Some or all of these parameters may allow for the control, selection, or tuning of stability of colloidal food compositions in which the dispersed phase is in any phase of matter (i.e., where the dispersed phase comprises solid particles, liquid droplets, and/or gas bubbles).

In embodiments of the present invention in which the colloidal food composition is a foam or solid foam, the stability parameter of interest is foam stability, i.e., the proportion of an initial volume of a foam or solid foam that is retained by the foam or solid foam after a specified interval, to allow for the creation of a foam or solid foam that does not rapidly spontaneously collapse. The foaming process can include whipping with a whipping appliance, incorporation of compressed gases, or other conventional foaming processes, and will generally result in the formation of gas bubbles in a variety of sizes. The larger bubbles tend to pop after sitting or being poured, but smaller bubbles may remain in suspension for a long time to form a stable foam or solid foam product. A foam or solid foam material of the invention can have an increased volume (i.e., overrun) by incorporation of air of at least about 10%, at least about 20%, at least about 30%, at least about 40%, at least about 50%, at least about 75%, at least about 100%, at least about 200%, at least about 300%, at least about 400%, or at least about 500%, as compared to the starting volume of the liquid or solid dispersion medium prior to foaming. In various embodiments, a foam or solid foam of the invention may have a foam stability of at least about 50%, at least about 60%, at least about 70%, at least about 80%, at least about 90%, or at least about 95% for at least about 1 day, at least about 2 days, at least about 3 days, at least about 4 days, or at least about 5 days, at least about 6 days, at least about 7 days, at least about 8 days, at least about 9 days, at least about 10 days, at least about 11 days, at least about 12 days, at least about 13 days, at least about 14 days, or at least about 15 days, at least about 16 days, at least about 17 days, at least about 18 days, at least about 19 days, at least about 20 days, at least about 21 days, at least about 22 days, at least about 23 days, at least about 24 days, or at least about 25 days, at least about 26 days, at least about 27 days, at least about 28 days, at least about 29 days, or at least about 30 days. In some embodiments, the foam or solid foam may retain this stability for at least about one month, at least about two months, at least about three months, at least about four months, at least about five months, at least about six months, at least about seven months, at least about eight months, at least about nine months, at least about ten months, at least about eleven months, at least about twelve months, at least about thirteen months, at least about fourteen months, at least about fifteen months, at least about sixteen months, at least about seventeen months, or at least about eighteen months.

In some embodiments, the colloidal food composition may be a particle-stabilized colloid; such colloids in which both the dispersed phase and the dispersion medium are liquid are referred to as Pickering emulsions. In these embodiments, the filamentous fungal particles may stabilize the colloid by adsorbing onto the interface between the dispersed phase and the dispersion medium, e.g., the interface between air bubbles and the solid phase in an ice cream analog food product or the interface between oil droplets and water in a mayonnaise analog food product.

Filamentous fungal particles may be provided that have a desired hydrophilic-lipophilic balance (HLB) of between about 3 and about 16, in some embodiments between about 3 and about 6 (e.g., to stabilize a water-in-oil emulsion) or between about 8 and about 16 (e.g., to stabilize an oil-in-water emulsion, such as a mayonnaise analog food product).

Another important parameter related to the stability of colloidal food compositions according to the present invention is contact angle, i.e., the angle formed by two phase interfaces (generally between a liquid-gas interface, e.g., at the surface of a liquid droplet, and a liquid-solid interface, e.g., where a liquid droplet rests on a solid substrate). A low contact angle (e.g., close to) 0° demonstrates high surface energy, as the liquid droplet tends to spread across and adhere to the solid surface, whereas a high contact angle (e.g., close to) 90° demonstrates the solid surface's tendency to repel the liquid droplet. In embodiments of the present invention, the contact angle of the colloidal food composition on a solid surface such as a silicon wafer, at ambient conditions (e.g. about 25° C. and about 1 atm of pressure) may generally be between about 45° and about 75°; the surface energy, and thus the contact angle, of the colloidal food composition may, in some embodiments be controlled, selected, and/or tuned by use of different types of filamentous fungal particles (e.g. particles produced by different techniques, such as spray drying vs. drum drying, or provided in different forms, such as homogenate vs. liquid dispersion). Without wishing to be bound by any particular theory, it is believed that controlling, selecting, and/or tuning these and other similar parameters may allow for the formulation of colloidal food compositions having excellent stability, e.g., including filamentous fungal particles having high water wettability (for highly stable oil-in-water emulsions), high oil wettability (for highly stable water-in-oil emulsions), and/or a balance between these two characteristics.

Particle-stabilized colloidal food compositions according to the present invention may particularly benefit from the use of relatively fine filamentous fungal particles, e.g. particles having a particle size of no more than about 120 microns, such as those that may be characterized as filamentous fungal “flours;” without wishing to be bound by any particular theory, it is believed that relatively finer or smaller particles of the filamentous fungus may more easily adsorb onto the interface between phases without causing collapse or rupture of the interface. Methods for preparing particle-stabilized colloidal food compositions are contemplated and are within the scope of the present invention.

Embodiments of the invention include ice cream analog food products. Like conventional ice creams, ice cream analog food products according to the present invention are generally solid foams, comprising a colloidal dispersion of air in a solid second phase comprising water ice and one or more sugars. However, in addition to or in lieu of cow's milk or similar dairy ingredients, the ice cream analog food products of the present invention include particles of filamentous fungus as the major source of protein, and in some embodiments as a source of additional nutrients (dietary fiber, fats (e.g., phospholipids), etc.). The filamentous fungal particles may also serve as an emulsifier (to prevent or slow separation of the various solid ingredients—water ice, sugars, proteins, lipids, etc.—from each other) and/or a foam stabilizer (to prevent or slow loss of air from the solid phase), which may, in embodiments, allow for decreased use or even elimination of other emulsifiers, foam stabilizers, and surfactants commonly used in ice cream (mono- and diglycerides, locust bean gum, guar gum, carob bean gum, cellulose gum, fatty oils, and the like).

In some embodiments, the use of filamentous fungal particles in ice cream analog food products according to the present invention may stabilize ice crystals in the food product within a network of fungal filaments, which may in turn allow such products to remain solid and resist significant melting at room temperature for longer than conventional ice creams, in some embodiments at least as much as 30 minutes; without wishing to be bound by any particular theory, this phenomenon may be attributable to any of several mechanisms, such as increasing viscosity, gelation of fungal particles due to complex networking with water, freezing of the fungal particles themselves, or arrangement of fungal particles into an amorphous, semi-crystalline, or crystalline form that resists flow.

Alternatively, however, ice cream analog food products or other frozen food products according to the present invention may have a melting and/or softening profile, i.e., melting and/or softening at a temperature and at a time scale, similar to that of conventional dairy ice creams or other conventional frozen food products to which they may be analogous. Such food products may be particularly desirable for use in applications in which the melting and/or softening profile provides commercial or aesthetic value, e.g., where it is desirable, from the consumer's perspective, for the frozen food product of the present invention to mimic the performance attributes of a conventional food product to which it may be analogous. In embodiments, ice cream analog food products or other frozen food products according to the present invention may have a melting temperature of no more than about 15° C., no more than about 14° C., no more than about 13° C., no more than about 12° C., no more than about 11° C., no more than about 10° C., no more than about 9° C., no more than about 8° C., no more than about 7° C., no more than about 6° C., no more than about 5° C., no more than about 4° C., no more than about 3° C., no more than about 2° C., no more than about 1° C., no more than about 0° C., no more than about −1° C., no more than about −2° C., no more than about −3° C., no more than about −4° C., no more than about −5° C., no more than about −6° C., no more than about −7° C., no more than about −8° C., no more than about −9° C., or no more than about −10° C.

Relative to similar commercially available non-dairy ice cream analogs, another potential advantage of ice cream analog food products according to the present invention is that they may provide a texture or “mouthfeel” that more closely approximates conventional dairy ice creams. Even more advantageously, the ice cream analog food products of the present invention may, in embodiments, achieve this desirable texture or mouthfeel without any source of protein other than the filamentous fungal particles, whereas many currently available non-dairy ice cream analogs require the use of proteins derived from plants (e.g., pea proteins, cashew proteins, etc.), which may present allergenic concerns or other difficulties, to achieve this effect.

The solid dispersion medium of ice cream analog food products according to the present invention includes at least one monosaccharide or disaccharide, most typically in an amount of between about 10 wt % and about 35 wt % or any tenth of a percentage point by weight therebetween, or alternatively in any range between 10 wt % and 35 wt %, or in any range from any tenth of a percentage point by weight between 10 wt % and 35 wt % to any other tenth of a percentage point by weight between 10 wt % and 35 wt %. In embodiments, the monosaccharide or disaccharide may be sucrose, dextrose, glucose, or any combination or mixture thereof.

The solid dispersion medium of ice cream analog food products according to the present invention may further include at least one polysaccharide, most typically in an amount of between about 5 wt % and about 10 wt % or any hundredth of a percentage point by weight therebetween, or alternatively in any range between 5 wt % and 10 wt %, or in any range from any hundredth of a percentage point by weight between 5 wt % and 10 wt % to any other tenth of a percentage point by weight between 5 wt % and 10 wt %. In embodiments, the polysaccharide may comprise at least one inulin, which may be provided to augment the dietary fiber content of the ice cream analog food product.

Ice cream analog food products according to the present invention include filamentous fungal particles, most typically in an amount of between about 10 wt % and about 20 wt % or any tenth of a percentage point by weight therebetween, or alternatively in any range between 10 wt % and 20 wt %, or in any range from any tenth of a percentage point by weight between 10 wt % and 20 wt % to any other tenth of a percentage point by weight between 10 wt % and 20 wt %. In embodiments, the filamentous fungal particles may be provided as part of an aqueous homogenate or dispersion, wherein a weight of ratio water to filamentous fungal particles in the aqueous homogenate or dispersion is between about 0.1 and about 10 or within any subrange therebetween, or alternatively between about 2.5 and about 3.5.

Colloidal food products, including but not limited to ice cream analog food products, according to the present invention may, in embodiments, include at least one fatty substance, most typically in an amount of between about 4.5 wt % and about 60.0 wt % or any tenth of a percentage point by weight therebetween, or alternatively in any range between 4.5 wt % and 60.0 wt %, or in any range from any tenth of a percentage point by weight between 4.5 wt % and 60.0 wt % to any other tenth of a percentage point by weight between 4.5 wt % and 60.0 wt %. The fatty substance may be provided for any number of several functions, e.g., to increase the fat content of the food product, to give the food product an appropriate texture and/or mouthfeel, as an emulsifier or surfactant, etc. In embodiments, the fatty substance may comprise any one or more of canola oil, palm oil, palm kernel oil, sunflower oil, vegetable oil, and refined coconut oil, by way of non-limiting example.

Ice cream analog food products according to the present invention may further include a foam stabilizer (in addition to filamentous fungal particles), most typically in an amount of between about 0.05 wt % and about 0.5 wt % or any hundredth of a percentage point therebetween, or alternatively in any range between 0.05 wt % and 0.5 wt %, or in any range from any hundredth of a percentage point by weight between 0.05 wt % and 0.5 wt % and any other hundredth of a percentage point by weight between 0.05 wt % and 0.5 wt %. The foam stabilizer may be provided to improve the stability of the solid foam, i.e., to prevent or slow collapse of air bubbles in the ice cream analog food product or escape of air or moisture from the solid dispersion medium. In embodiments, the foam stabilizer may comprise locust bean gum, guar gum, carob bean gum, cellulose gum, or other stabilizer that acts to inhibit ice crystal growth by influencing viscosity and other rheological properties to limit the mobility of water in the liquid phase prior to freezing.

Colloidal food compositions according to the present invention that are adapted to be frozen, such as ice cream or other dairy analog frozen food products, or a mix or precursor used to make a frozen food product according to the present invention, may have a dynamic viscosity at 20° C. and 1 atm of between about 1.5 cP and about 25,000 cP, or of between about 200 cP and about 2,100 cP. Additionally or alternatively, such frozen food products according to the present invention, or a mix or precursor used to make a frozen food product according to the present invention, may have a dynamic viscosity at 20° C. and 1 atm, before or after heat treatment (e.g., to greater than about 50° C., 60° C., 70° C., 80° C., or 90° C.), of greater than about 250 cP, greater than about 300 cP, greater than about 350 cP, greater than about 400 cP, greater than about 450 cP, greater than about 500 cP, greater than about 550 cP, greater than about 600 cP, greater than about 650 cP, greater than about 700 cP, greater than about 750 cP, greater than about 800 cP, greater than about 850 cP, greater than about 900 cP, greater than about 950 cP, greater than about 1,000 cP, greater than about 1,250 cP, greater than about 1,500 cP, greater than about 1,750 cP, or greater than about 2,000 cP.

Ice cream analog food products according to the present invention may further include any one or more flavoring ingredients to provide a flavored ice cream analog food product. Most typically, flavoring ingredients may be provided in an amount of between about 0.01 wt % and about 40 wt % or any hundredth of a percentage point therebetween, or alternatively in any range between 0.01 wt % and 40 wt %, or in any range from any hundredth of a percentage point by weight between 0.01 wt % and 40 wt % to any other hundredth of a percentage point by weight between 0.01 wt % and 40 wt %. Non-limiting examples of such flavoring ingredients include vanilla beans or vanilla paste (to produce a vanilla ice cream analog food product), strawberry puree and optionally lemon juice (to produce a strawberry ice cream analog food product), cacao powder (to produce a chocolate ice cream analog food product), and so on.

Colloidal food compositions, including but not limited to ice cream analog food products, according to the present invention may further include proteins, such as a hydrophobin. These are low molecular weight proteins, ranging from about 100 to 150 amino acids in length, and are amphipathic molecules that are capable of self-assembly at a hydrophobic-hydrophilic interface into amphipathic films. Hydrophobins function to stabilize colloidal compositions. Various uses for hydrophobins have been described in the art including as emulsifiers, thickeners, surfactants, for hydrophilizing hydrophobic surfaces, for improving the water stability of hydrophilic substrates, and for preparing oil-in-water emulsions or water-in oil emulsions, and they have applications in pharmaceutical, cosmetic as well as in food compositions. In food products, they have been shown impact formation and stability of air bubbles, thus assisting in foamability and foam stabilization (for instance they provide foam volume stability and inhibition of coarsening of foods), inhibit growth of ice crystals in frozen food products, and affect agglomeration of fats, thus improving the texture, stability, and storage time of aerated and/or frozen food compositions.

Accordingly, some embodiments of the present invention may include a hydrophobin. Hydrophobins are generally classified into class I and class II; while class I hydrophobins are relatively insoluble, class II hydrophobins readily dissolve in a variety of solvents and therefore are generally preferred. Hydrophobins and like proteins have been identified in filamentous fungi and bacteria, and their sequences described in the art. All of these proteins, including class I and class II, are encompassed by the present invention. Hydrophobins suitable for use in the present invention may be isolated from natural sources, or by recombinant means. In some embodiments, the hydrophobins may be added to the food compositions as purified proteins. In some embodiments, the hydrophobins may be expressed by the filamentous fungal species used in the food composition and thus supplied as part of the fungal biomass.

Ice cream analog food products according to the present invention may further include ice-structuring proteins (ISPs), also known as ice-binding proteins (IBPs) or anti-freeze proteins (AFPs). ISPs are used as additives to improve the quality of stored frozen products, e.g., to improve texture and stability of the product and to increase the time of storage. ISPs have been identified in a variety of organisms including fungi, plants, fish, insects, bacteria, and lichen; sequences for many such proteins are publicly available and known in the art. (e.g., protein HPLC-12 from ocean pout, Accession No. P19614 in the Swiss-Prot protein database). ISPs can be obtained by purifying them from the native organism or through recombinant technology means such as by overexpressing them in the same native organism or expressing them in other organisms and isolating them.

Those of ordinary skill in the art will understand and appreciate how to select appropriate flavoring ingredients and other additives, and the amounts thereof for a colloidal food products, including but not limited to ice cream analog food products, and one advantage of the colloidal food products of the present invention is that they may generally be designed according to the same or similar guidelines as govern the design of conventional food products to which they are analogous. By way of first non-limiting example, ice cream analog food products, or analogs of other conventional food products which typically have high fat contents, according to the present invention may have a total fat content of less than about 20 wt %, 19 wt %, 18 wt %, 17 wt %, 16 wt %, 15 wt %, 14 wt %, 13 wt %, 12 wt %, 11 wt %, 10 wt %, 9 wt %, 8 wt %, 7 wt %, 6 wt %, or 5 wt %. By way of second non-limiting example, ice cream analog food products, or analogs of other conventional food products which typically have high fat contents, according to the present invention may have a total nonfat solids content (excluding water ice and/or liquid water) of no more than about 10 wt %. By way of third non-limiting example, the total content of fats and nonfat solids (excluding water ice and/or liquid water) in ice cream analog food products, or analogs of other conventional food products which typically have high fact contents, according to the present invention may be between about 16 wt % and about 22 wt %. By way of fourth non-limiting example, the total solids content (excluding water ice and/or liquid water) of ice cream analog food products, or analogs of other conventional food products which typically have high fat contents, according to the present invention may be between about 37 wt % and about 42 wt %. By way of fifth non-limiting example, a total sweetening power of all sugars and other sweetening ingredients in ice cream analog food products according to the present invention may be equivalent to between about 16 wt % sucrose and about 23 wt % sucrose.

The present invention may be particularly suitable for preparing ice cream analog food products, or analogs of other typically high-fat conventional food products, that have a lower content of total fats and/or specifically of saturated fats than analogous non-fungal food products. By way of non-limiting example, ice cream analog food products that have a total fat content of less than about 10 wt %, less than about 9 wt %, less than about 8 wt %, less than about 7 wt %, less than about 6 wt %, or less than about 5 wt % may be produced that still maintain the typically “fatty” or “creamy” mouthfeel of ice cream, compared to conventional ice creams typically having fat contents of between about 10 wt % and about 16 wt % and (for some especially indulgent ice creams) as high as 20 wt %. By way of further non-limiting example, ice cream analog food products that have a saturated fat content of less than about 55 wt % of the total fat content, less than about 50 wt % of the total fat content, less than about 45 wt % of the total fat content, or less than about 40 wt % of the total fat content, and/or less than about 5.5 wt % of the total colloidal food composition, less than about 5 wt % of the total colloidal food composition, less than about 4.5 wt % of the total colloidal food composition, less than about 4 wt % of the total colloidal food composition, less than about 3.5 wt % of the total colloidal food composition, less than about 3 wt % of the total colloidal food composition, less than about 2.5 wt % of the total colloidal food composition, or less than about 2 wt % of the colloidal food composition, compared to conventional ice creams typically having saturated fat contents of between about 58 wt % and about 65 wt % of the total fat content and between about 6 wt % and about 10 wt % of the composition. The nutritional advantages and benefits of providing low-fat and/or low-saturated-fat food products, and indulgence food products particularly, are well-known, and may further provide a commercial advantage, as health-conscious consumers may be more likely to purchase these food products.

In other embodiments, by contrast, the present invention may be particularly suitable for preparing ice cream analog food products, or analogs of other typically high-fat conventional food products, that have a comparable, or even higher, content of total fats and/or specifically of saturated fats than analogous non-fungal food products, as in some such foods the high fat content is an important content of the nutritional content, taste, texture, and/or culinary properties of the analogous non-fungal food product. By way of non-limiting example, the present invention may be particularly suitable for making analogs of (1) high-fat dairy products, e.g., half-and-half (10.5 to 18 wt % fat), light cream (18 to 30 wt % fat), whipping cream (30 to 36 wt % fat), heavy cream (at least about 36 wt % fat), and/or manufacturer's cream (at least about 40 wt % fat); (2) colloidal sauces and/or spreads with significant fat content, e.g., béchamel sauce, espagnole sauce, hollandaise sauce, hummus, Russian dressing, tartar sauce, Thousand Island dressing, velouté sauce, etc.; and/or (3) particularly fatty or otherwise decadent conventional colloidal food products, e.g. foie gras (typically about 44 wt % fat).

Colloidal food compositions according to the present invention that are adapted to be frozen, such as ice cream or other dairy analog frozen food products, may, when frozen, exhibit a low degree of “iciness,” defined as the degree to which ice crystals are immediately perceived when the food product is placed in the mouth. This perception, generally considered undesirable, results when a significant proportion of the water ice in the food product is in the form of relatively large (e.g., at least about 25 μm) ice crystals. The iciness of a product may be quantified in any of several ways, either objectively (e.g., by measuring a size distribution of the ice crystals in the food product) or subjectively (e.g., by subjecting the frozen food product to taste-testing by a panel of trained testers who rate the iciness on a numerical scale). In some embodiments, frozen colloidal food compositions according to the present invention may be characterized by an ice crystal size distribution wherein at least about 10% (by number, volume, and/or weight), at least about 20% (by number, volume, and/or weight), at least about 30% (by number, volume, and/or weight), at least about 40% (by number, volume, and/or weight), at least about 50% (by number, volume, and/or weight), at least about 60% (by number, volume, and/or weight), at least about 70% (by number, volume, and/or weight), at least about 80% (by number, volume, and/or weight), at least about 90% (by number, volume, and/or weight), at least about 91% (by number, volume, and/or weight), at least about 92% (by number, volume, and/or weight), at least about 93% (by number, volume, and/or weight), at least about 94% (by number, volume, and/or weight), at least about 95% (by number, volume, and/or weight), at least about 96% (by number, volume, and/or weight), at least about 97% (by number, volume, and/or weight), at least about 98% (by number, volume, and/or weight), or at least about 99% (by number, volume, and/or weight) of the ice crystals in the colloidal food composition have particle sizes of less than about 25 μm, less than about 24 μm, less than about 23 μm, less than about 22 μm, less than about 21 μm, less than about 20 μm, less than about 19 μm, less than about 18 μm, less than about 17 μm, less than about 16 μm, less than about 15 μm, less than about 14 μm, less than about 13 μm, less than about 12 μm, less than about 11 μm, less than about 10 μm, less than about 9 μm, less than about 8 μm, less than about 7 μm, less than about 6 μm, or less than about 5 μm. In some embodiments, frozen colloidal food compositions according to the present invention may be characterized by a subjective iciness score, when evaluated by trained taste-testers, of no more than about 5, no more than about 4, no more than about 3, no more than about 2, or no more than about 1 on a scale of 0 to 10, or equivalents of these values on another numerical scale.

Colloidal food compositions according to the present invention that are adapted to be frozen, such as ice cream or other dairy analog frozen food products, may, when frozen, exhibit a degree of real or perceived firmness, defined as the amount of force needed to compress a portion of the food product when spooning the food product out of a vessel or placing the food product between the tongue and the palate, that is comparable to conventional frozen food products. In some embodiments, frozen food products according to the present invention may be characterized by a subjective firmness score in the mouth, when evaluated by trained taste-testers, of between about 3 and about 7 on a scale of 0 to 10, or equivalents of these values on another numerical scale.

Colloidal food compositions according to the present invention that are adapted to be frozen, such as ice cream or other dairy analog frozen food products, may, when frozen, exhibit a degree of perceived creamy mouthfeel, defined as the subjective intensity of the “creamy” textural perception when the food product is placed in the mouth, that is comparable to conventional frozen food products. In some embodiments, frozen food products according to the present invention may be characterized by a subjective creamy mouthfeel score, when evaluated by trained taste-testers, of between about 3 and about 6 on a scale of 0 to 10, or equivalents of these values on another numerical scale.

Colloidal food compositions according to the present invention that are adapted to be frozen, such as ice cream or other dairy analog frozen food products, may, when frozen, exhibit a degree of perceived creamy mouthcoating, defined as the subjective intensity of the “creamy” textural perception after the food has been swallowed (or expectorated) and is thus no longer present in the mouth, that is comparable to conventional frozen food products. In some embodiments, frozen food products according to the present invention may be characterized by a subjective creamy mouthcoating score, when evaluated by trained taste-testers, of between about 3 and about 5 on a scale of 0 to 10, or equivalents of these values on another numerical scale.

Colloidal food compositions according to the present invention that are adapted to be frozen, such as ice cream or other dairy analog frozen food products, may be characterized by air bubbles in the food product being predominantly (i.e., more than 50%, more than 60%, more than 70%, more than 80%, more than 90%) small air bubbles, e.g., wherein a number-average, volume-average, and/or weight-average size of air bubbles in the ice cream analog food product is less than about 10 μm, less than about 9 μm, less than about 8 μm, less than about 7 μm, less than about 6 μm, or less than about 5 μm. In addition to being small, air bubbles may, in embodiments, be substantially homogeneously and/or uniformly distributed throughout the ice cream analog food product.

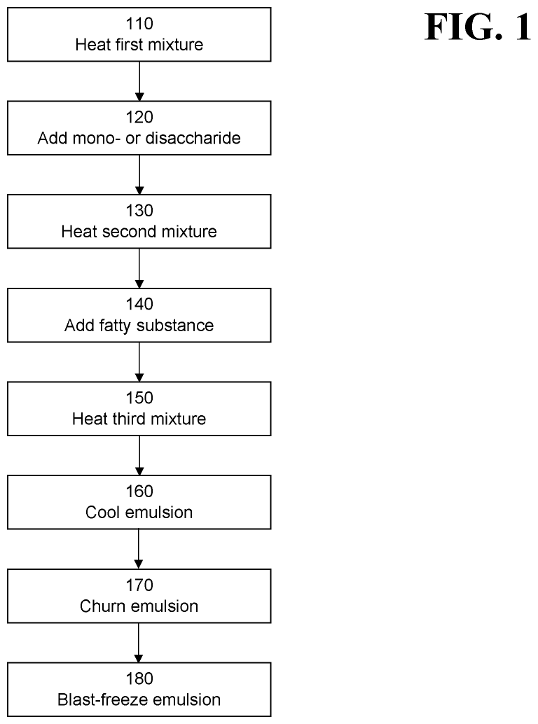

The present invention further provides a method 100 for preparing an ice cream analog food product, illustrated in FIG. 1. In a first step 110 of the method 100, a first mixture, comprising a dispersion of filamentous fungal particles in water (and optionally one or more other ingredients, such as a flavoring ingredient), is heated to a temperature of about 40° C. In a second step 120 of the method 100, at least one monosaccharide or disaccharide, e.g., sucrose, dextrose, glucose, or a combination thereof, is added to the first mixture to form a second mixture. In a third step 130 of the method 100, the second mixture is heated to a temperature of between about 45° C. and about 70° C.; in some embodiments, a foam stabilizer (e.g., locust bean gum) may be added to the second mixture between second step 120 and third step 130 or during third step 130. In an optional fourth step 140 of the method 100, a fatty substance is added to the second mixture to form a third mixture; in some embodiments, the fatty substance may comprise a flavoring ingredient (e.g., cacao powder may be melted together with an oil to form a fatty substance suitable for use in a chocolate ice cream analog food product). In a fifth step 150 of the method 100, the third mixture (or second mixture, if optional fourth step 140 is omitted) is heated to a temperature of about 82° C. and maintained at this temperature for a period of at least about two minutes to form an emulsion. In a sixth step 160 of the method 100, the emulsion is cooled to a temperature of about 5° C. In a seventh step 170 of the method 100, the emulsion is churned to colloidally disperse air throughout the emulsion; in some embodiments, a flavoring ingredient may be added to the emulsion between sixth step 160 and seventh step 170 or during seventh step 170. In an eighth step 180, the emulsion is blast-frozen to a temperature of no more than about −10° C. to form the ice cream analog food product. It is to be expressly understood that the method depicted in FIG. 1 is non-limiting and that ice cream analog food products according to the present invention can be made by other methods.

The invention is further illustrated by way of the following non-limiting Examples.

### Example 1

### Particle Size Distribution of Milled Flours

Filamentous fungal biomats were produced and dried according to a surface fermentation method as described in PCT Application Publication 2020/176758 (“the '758 publication”), the entirety of which is incorporated herein by reference. Two samples of filamentous fungal particles were produced by milling samples of these biomats to 16 mill mesh and 80 mill mesh, respectively. The moisture contents of these particle samples were assayed and determined to between 3.7 wt % and 8.7 wt % and thus suitable for use as a filamentous fungal “flour.” Particle size distributions for each of these two samples were measured and are given in Table 1 below.

TABLE 1

| Size range | 16 mill mesh | 80 mill mesh |
|---|---|---|
| (μm) | % of particles | % of particles |
| <53 | ND | 18.1 |
| 53-105 | ND | 34.9 |
| <105 | 24.8 | 53.0 |
| 105-177 | 16.9 | 45.4 |
| 177-250 | 14.3 | 0.5 |
| 250-350 | 21.3 | 0.5 |
| 350-590 | 20.9 | 0.3 |
| 590-1190 | 2.4 | ND |

### Example 2

### Nutritional Content of Filamentous Fungal Particles

The 80 mill mesh particles produced in Example 1 were subjected to compositional analysis to determine their nutritional content. The results are given in Table 2.

TABLE 2

| Analyte | Amount per 100 g | |
|---|---|---|
| Calories | 387.6 | |
| Total fat | 8.13 | g |
| Monounsaturated fat | 1.25 | g |
| Polyunsaturated fat | 4.75 | g |
| Saturated fat | 1.76 | g |
| Trans fat | <0.10 | g |
| Cholesterol | <0.8 | g |
| Sodium | 13.0 | mg |
| Potassium | 759 | mg |
| Total carbohydrate | 32.2 | g |
| Dietary fiber | 32.15 | g |
| Total sugars | <0.25 | g |
| Fructose | <0.25 | g |
| Glucose | <0.25 | g |
| Lactose | <0.25 | g |
| Maltose | <0.25 | g |
| Sucrose | <0.25 | g |
| Protein | 46.41 | g |
| Calcium | 505 | mg |
| Iron | 3.2 | mg |
| Water | 8.83 | g |
| Ash | 4.42 | g |
| Vitamin D2 | <0.75 | mcg |
| Vitamin D3 | <0.75 | mcg |
| Total Vitamin D | <0.55 | mcg |

### Example 3

### Filamentous Fungal Particle Size and Shape

Three samples (“A1,” “A2,” and “A3”) of a spray-dried filamentous fungal “flour” were produced according to a method as described in the '758 publication and mechanically size-reduced. For each sample, approximately 500 mg of flour was dispersed in approximately 25 mL of water and stirred on a magnetic stir plate for five minutes. To obtain a more suitable concentration and minimize coincidence effects for image analysis, 1 mL of this preparation was further diluted into 5 mL of water prior to transfer to a microscope slide. A coverslip was placed over the sample prior to observation and analysis. The particulates observed under the microscope included bead-shaped particles typical of spray-dried materials, as well as broken filaments (small rod-shaped particles).

Separately, three samples (“M1,” “M2,” and “M3”) of an aqueous filamentous fungal “homogenate” were produced by blending one part by weight fungal biomass produced according to a method as described in the '758 publication with three parts by weight water in a conventional kitchen blender. These homogenate samples were frozen until ready for analysis. After thaw, each sample was prepared in the same manner as the spray-dried flour samples. An aliquot of sample was diluted in water and several drops of 1% Triton X-100 and vortexed for five minutes; some large fiber clusters present were sieved off using an 850 μm sieve. Episcopic dark-field illumination was found to provide sufficient contrast for the material present.

The morphologies of samples M2 and M3 were observed to be dissimilar from that of M1; as opposed to fibrous material, M2 consisted of plate-like particulates, while M3 contained irregular elongated particulates. Neither M2 nor M3 contained large agglomerates after dispersing in the same manner as M1, and the 850 μm sieve was thus not used, as it was unnecessary.

All six samples were subjected to static image analysis using a Malvern Morphologi 4-ID instrument. Measurements of circular equivalent (CE) diameter, aspect ratio, and circularity for each sample are given in Tables 3, 4, and 5, respectively. In Tables 3, 4, and 5, “D [n,x]” and “D [v,x]” denote values of the measured parameter such that a number share or volume share, respectively, of particles have an observed value for that parameter lower than the indicated value; for example, in Table 3, a D [v,0.50] value of 25 μm indicates that 50 vol % of particles have a CE diameter less than 25 μm.

TABLE 3
Circular Equivalent (CE) Diameter

| | | | | Number | | | | |
|---|---|---|---|---|---|---|---|---|
| Sample | D[n, 0.10] | D[n, 0.50] | D[n, 0.90] | average | D[v, 0.10] | D[v, 0.50] | D[v, 0.90] | Volume |
| ID | (μm) | (μm) | (μm) | (μm) | (μm) | (μm) | (μm) | average |
| A1 | 0.91 | 2.60 | 9.30 | 4.08 | 6.71 | 13.93 | 21.87 | 14.43 |
| A2 | 0.81 | 2.46 | 8.67 | 3.89 | 6.68 | 14.82 | 23.55 | 15.31 |
| A3 | 1.27 | 3.41 | 8.87 | 4.39 | 5.62 | 11.89 | 19.44 | 12.40 |
| M1 | 1.15 | 3.81 | 9.92 | 5.18 | 7.85 | 20.68 | 51.01 | 25.98 |
| M2 | 1.18 | 2.01 | 4.36 | 2.70 | 14.30 | 66.64 | 140.2 | 19.57 |
| M3 | 1.25 | 2.73 | 7.06 | 3.68 | 5.55 | 14.85 | 48.81 | 21.87 |

TABLE 4
Aspect Ratio

| Sample | | | | Number | | | |
|---|---|---|---|---|---|---|---|
| ID | D[n, 0.10] | D[n, 0.50] | D[n, 0.90] | average | D[v, 0.10] | D[v, 0.50] | D[v, 0.90] |
| A1 | 0.468 | 0.758 | 0.915 | 0.726 | 0.602 | 0.797 | 0.922 |
| A2 | 0.470 | 0.753 | 0.915 | 0.724 | 0.608 | 0.806 | 0.931 |
| A3 | 0.467 | 0.751 | 0.915 | 0.721 | 0.562 | 0.776 | 0.915 |
| M1 | 0.441 | 0.715 | 0.902 | 0.690 | 0.118 | 0.292 | 0.853 |
| M2 | 0.586 | 0.786 | 0.919 | 0.772 | 0.493 | 0.649 | 0.860 |
| M3 | 0.415 | 0.678 | 0.891 | 0.667 | 0.302 | 0.606 | 0.843 |

TABLE 5
Circularity

| Sample | | | | Number | | | |
|---|---|---|---|---|---|---|---|
| ID | D[n, 0.10] | D[n, 0.50] | D[n, 0.90] | average | D[v, 0.10] | D[v, 0.50] | D[v, 0.90] |
| A1 | 0.697 | 0.795 | 0.881 | 0.792 | 0.742 | 0.817 | 0.887 |
| A2 | 0.685 | 0.780 | 0.868 | 0.778 | 0.744 | 0.812 | 0.881 |
| A3 | 0.700 | 0.784 | 0.866 | 0.784 | 0.736 | 0.801 | 0.868 |
| M1 | 0.536 | 0.809 | 0.941 | 0.771 | 0.238 | 0.459 | 0.919 |
| M2 | 0.795 | 0.943 | 0.983 | 0.914 | 0.414 | 0.568 | 0.828 |
| M3 | 0.620 | 0.856 | 0.967 | 0.824 | 0.413 | 0.634 | 0.857 |

Portions of each of the spray-dried flour samples A1, A2, A3 were also placed in a Malvern 3000 recirculator for particle size analysis. Observations by visual light microscopy were also made. The results of these observations are given in Table 6 below.

TABLE 6

| | D[v, 0.10] | D[v, 0.50] | D[v, 0.90] | Visual |
|---|---|---|---|---|
| Sample | (μm) | (μm) | (μm) | observations |
| A1 | 4.31 | 11.1 | 25.3 | Fines less than 8 μm, |
| | | | | irregular particles from |
| | | | | 8 to 32 μm and up to 64 μm |
| A2 | 4.57 | 11.8 | 24.4 | Fines less than 8 μm, |
| | | | | semi-spherical, irregular |
| | | | | particles from 8 to 56 μm |
| A3 | 4.36 | 11.8 | 25.8 | Fines less than 8 μm, |
| | | | | irregular particles from |
| | | | | 8 to 100 μm |

### Example 4

### Native Thixotropic Rheology of Fungal Homogenate

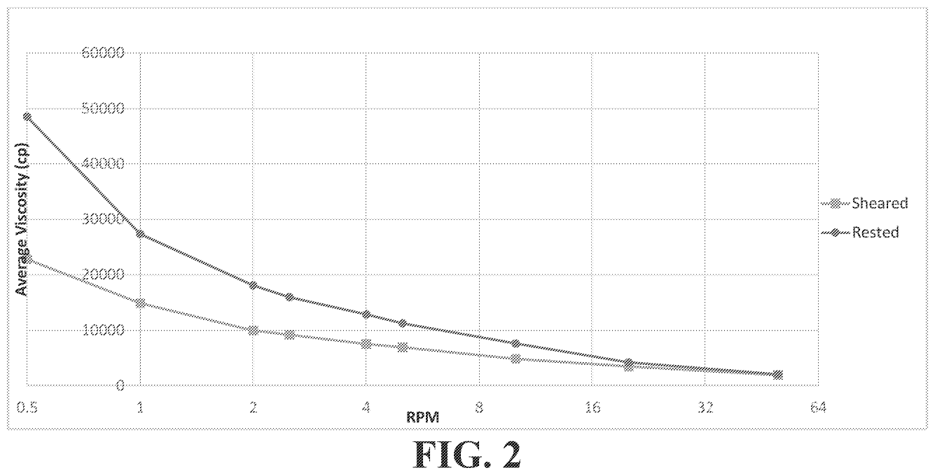

An aqueous filamentous fungal homogenate as produced in Example 3 was subjected to viscosity testing in a laboratory shear rheometer immediately after stirring, then again after one hour at rest. The results are illustrated in FIG. 2. As shown, shear history affects homogenate viscosity in a time-dependent fashion, and structural strength (and therefore viscosity) recovers after resting.

### Example 5

### Effect of Protease Treatment on Thixotropy

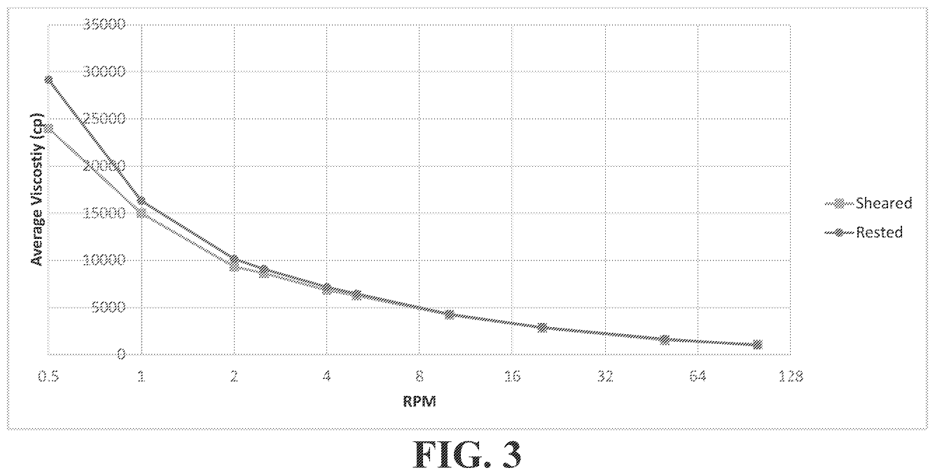

The procedure of Example 4 was repeated, except that 100 μL of proteinase K enzyme was added to 175 g of the homogenate during stirring. The results are illustrated in FIG. 3. As shown, protease treatment greatly reduces the thixotropy of the homogenate.

### Example 6

### Effect of Glycine Treatment on Thixotropy

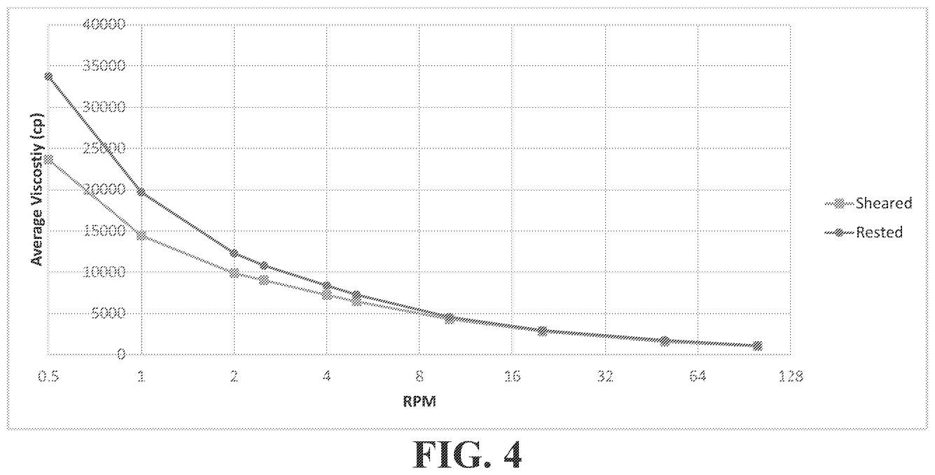

The procedure of Example 4 was repeated, except that 100 mg of glycine was added to 125 g of the homogenate during stirring. The results are illustrated in FIG. 4. As shown, glycine treatment reduces the thixotropy of the homogenate, although not to the same extent as protease treatment.

### Example 7

### Effect of Saponin Treatment on Thixotropy

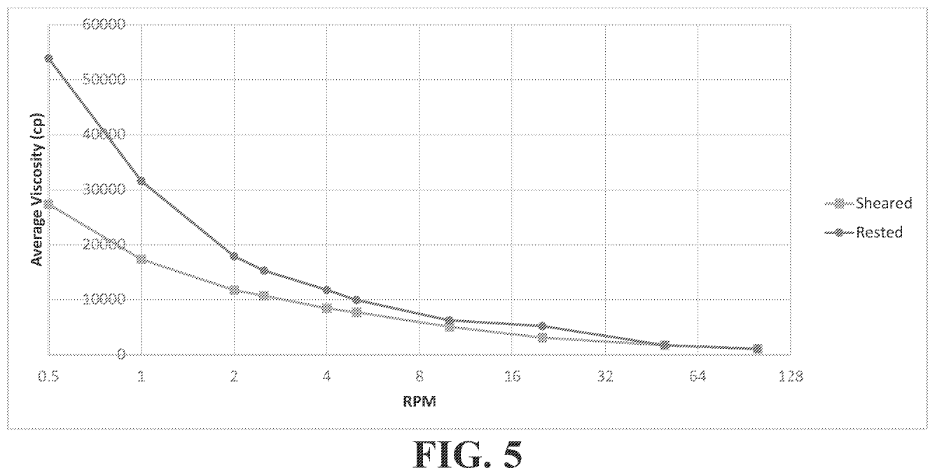

The procedure of Example 4 was repeated, except that 100 mg of T&L “Foamation” was added to 125 g of the homogenate during stirring. The results are illustrated in FIG. 5. As shown, the surface-active small molecules of the Foamation product (quillaja saponins) slightly increase the thixotropy and overall viscosity of the homogenate.

### Example 8

### Effect of Replacement of Soluble Phase on Thixotropy

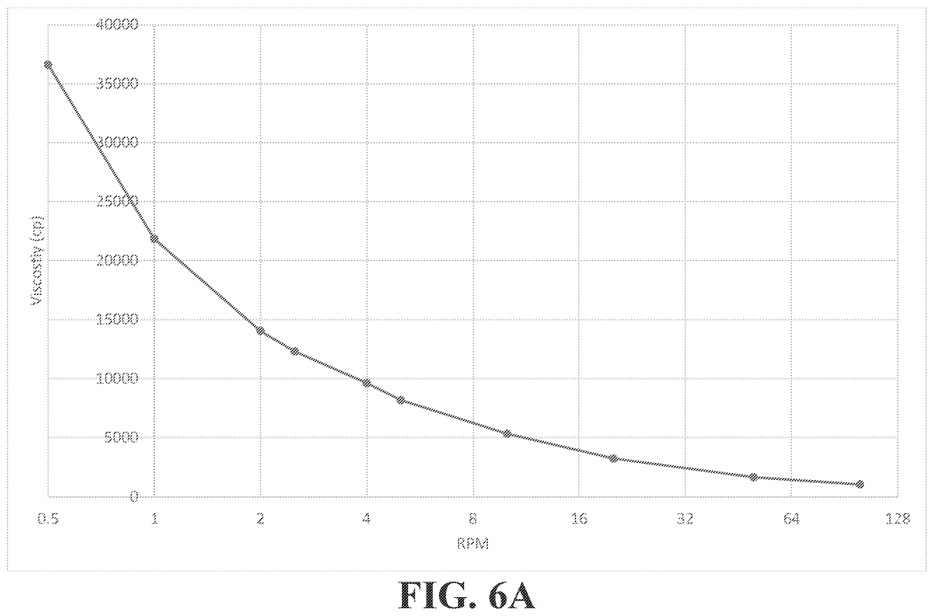

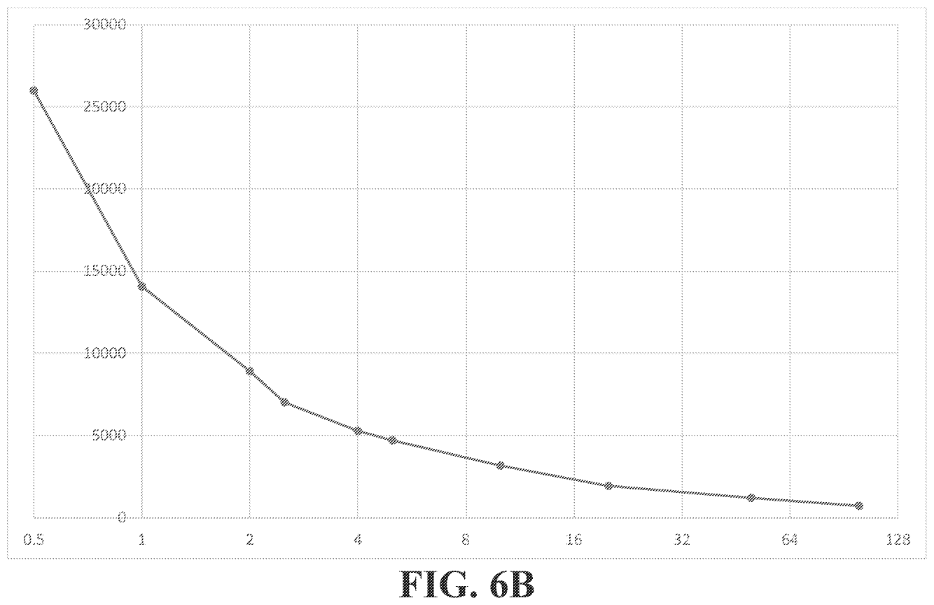

An aqueous filamentous fungal homogenate as produced in Example 3 was subjected to viscosity testing in a laboratory shear rheometer in a rested state, both before and after equal-weight replacement of the supernatant with 1M potassium chloride solution. The total solids content in the supernatant was 0.1 mg/mL. The results are illustrated in FIGS. 6A (before replacement) and 6B (after replacement). As shown, the overall viscosity of the homogenate is slightly reduced upon addition of potassium chloride salt.

### Example 9

### Vanilla Ice Cream Analog Food Product

A vanilla ice cream analog food product was made according to the general method outlined in FIG. 1. Specifically, 850 g of a dispersion of filamentous fungal flour particles in water was prepared, having a 3:1 weight ratio of water to fungal particles. This dispersion was mixed with 100 g of inulins and 10 g of vanilla paste (approximately to one half of a vanilla bean), and the resulting mixture was heated to 40° C. To this mixture, 200 g of sucrose, 30 g of dextrose powder, 30 g of glucose powder, and 1 g of locust bean gum were added, and the resulting mixture was further heated to 45° C. To this mixture, 115 g of refined coconut oil was added, and the resulting mixture was further heated to 82° C.; this temperature was maintained for two minutes, whereupon the mixture had fully emulsified. The emulsion was then cooled to 5° C., at which point it was churned to introduce colloidally dispersed air bubbles into the emulsion. Finally, the air-infused colloid was blast-frozen to −18° C. and then frozen for long-term storage at −10° C. The resulting vanilla ice cream analog food product performed very well in terms of visual appearance, taste, texture, and mouthfeel, all of which were comparable to conventional vanilla ice cream.

The vanilla ice cream analog food product was also found to have a total fat content of 9.9 wt %, of which 76% (7.5 wt % of the total composition) consisted of saturated fats. This total fat content is notably lower than conventional ice creams, which most typically contain between about 10 wt % and about 16 wt % fat but may contain as much as 20 wt % fat. The saturated fat content of the vanilla ice cream analog food product is also comparable to or lower than the saturated fat content of conventional ice creams, which typically ranges from about 6 wt % to about 10 wt %.

### Example 10

### Strawberry Ice Cream Analog Food Product

A strawberry ice cream analog food product was made according to the general method outlined in FIG. 1. Specifically, 750 g of a dispersion of fungal particles as described in Example 9 was mixed with 100 g of inulins, and the resulting mixture was heated to 40° C. To this mixture, 180 g of sucrose, 30 g of dextrose powder, and 30 g of glucose powder were added, and the resulting mixture was further heated to 45° C. To this mixture, 75 g of refined coconut oil was added, and the resulting mixture was further heated to 82° C.; this temperature was maintained for two minutes, whereupon the mixture had fully emulsified. The emulsion was cooled to 5° C., at which point 150 g of strawberry puree and 5 g of lemon juice were added; the emulsion was then churned to introduce colloidally dispersed air bubbles into the emulsion. Finally, the air-infused colloid was blast-frozen to −18° C. and then frozen for long-term storage at −10° C. The resulting strawberry ice cream analog food product performed very well in terms of visual appearance, taste, texture, and mouthfeel, all of which were comparable to conventional strawberry ice cream.

### Example 11

### Chocolate Ice Cream Analog Food Product

A chocolate ice cream analog food product was made according to the general method outlined in FIG. 1. Specifically, 700 g of a dispersion of fungal particles as described in Example 9 was heated to 40° C. To this dispersion, 200 g of sucrose, 30 g of dextrose, and 30 g of glucose were added, and the resulting mixture was further heated to 70° C. Separately, 75 g of refined coconut oil was melted and mixed with 100 g of cacao powder (22-24% fat); this fat/cacao mixture was then combined with the fungal/sugar mixture, and the resulting combined mixture was further heated to 82° C. and held at that temperature for two minutes, whereupon the mixture had fully emulsified. The emulsion was then cooled to 5° C., at which point it was churned to introduce colloidally dispersed air bubbles into the emulsion. Finally, the air-infused colloid was blast-frozen to −18° C. and then frozen for long-term storage at −10° C. The resulting chocolate ice cream analog food product performed very well in terms of visual appearance, taste, texture, and mouthfeel, all of which were comparable to conventional chocolate ice cream.

### Example 12

### Zeta Potential

The zeta potentials of three samples of each of the ice cream analog food products of Examples 9, 10, and 11 were measured at approximately 20° C. using a Zeta-Meter 4.0 instrument. For each flavor, one sample was made using drum-dried particles of fungal flour, another sample was made using spray-dried particles of fungal flour, and the third sample was made using a fungal “milk” (an aqueous dispersion of fungal particles). The results are given in Table 6.

TABLE 7

| Flavor | Sample | Zeta potential (mV) |
|---|---|---|
| Vanilla | Drum-dried | −32.65 |
| | Spray-dried | −20.90 |
| | Milk | −35.62 |
| | Average | −29.72 |
| Strawberry | Drum-dried | −32.79 |
| | Spray-dried | −25.83 |
| | Milk | −25.89 |
| | Average | −28.17 |
| Chocolate | Drum-dried | −34.78 |
| | Spray-dried | −28.05 |
| | Milk | −29.41 |
| | Average | −30.75 |

### Example 13

### Contact Angle

Droplets of each of the ice cream analog samples of Example 12 approximately 5 μL in volume were placed on a silicon wafer substrate and a Teflon substrate, and the contact angle of the droplets was measured at 25° C. using a VCA 2500XE Video Contact Angle System to assess the relative hydrophobicity of the ice cream materials. The results are given in Table 8 (the contact angle of deionized water is also given for comparison).

TABLE 8

| | | Silicon wafer | Teflon |
|---|---|---|---|
| Flavor | Sample | contact angle (°) | contact angle (°) |
| Vanilla | Drum-dried | 53.31 | 76.63 |
| | Spray-dried | 50.70 | 68.10 |
| | Milk | 49.98 | 72.86 |
| Strawberry | Drum-dried | 61.54 | 81.38 |
| | Spray-dried | 55.74 | 74.26 |
| | Milk | 53.74 | 87.57 |
| Chocolate | Drum-dried | 70.20 | 60.98 |
| | Spray-dried | 54.25 | 79.30 |
| | Milk | 61.18 | 76.78 |

| | | |
|---|---|---|
| Deionized water | 34.85 | 91.43 |

### Example 14

### Morphology of Ice Cream Analog Food Products

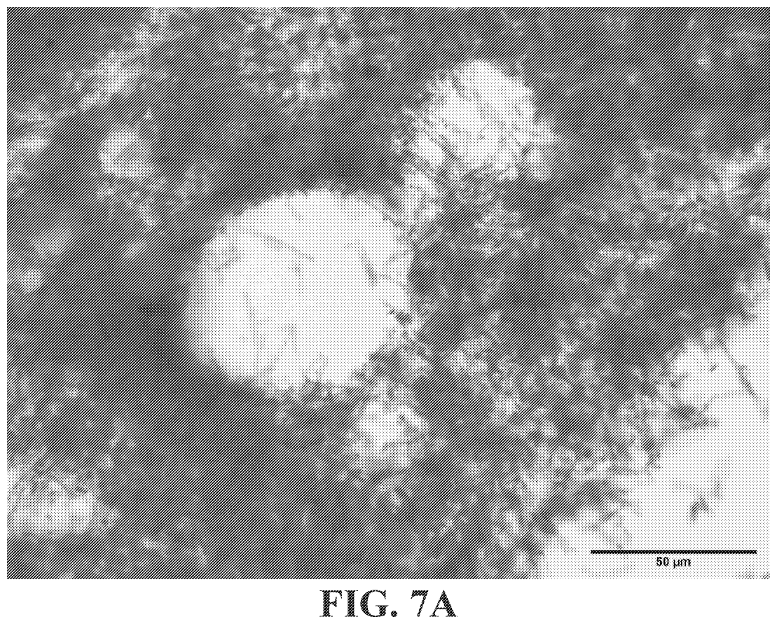

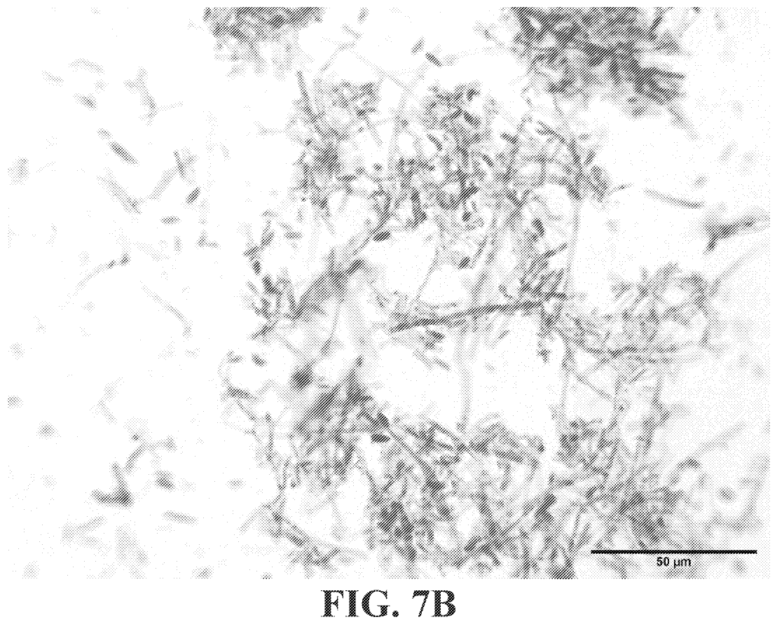

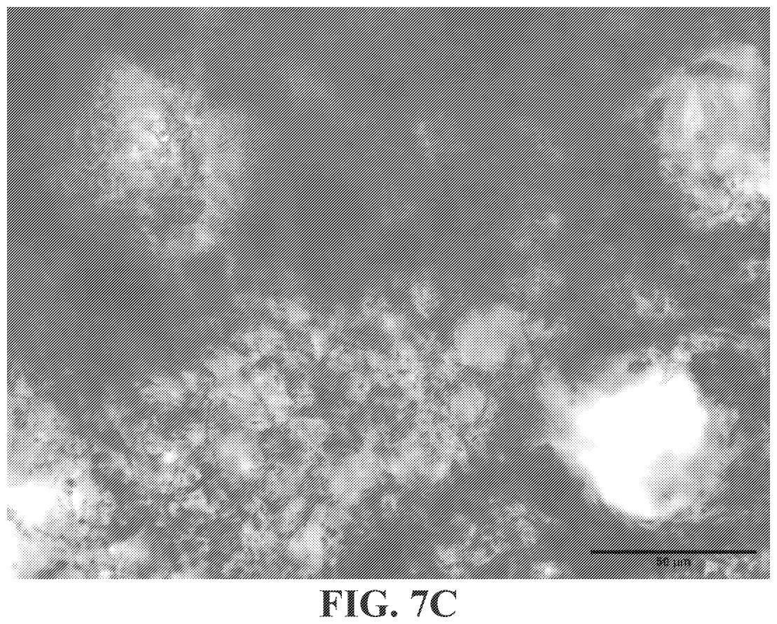

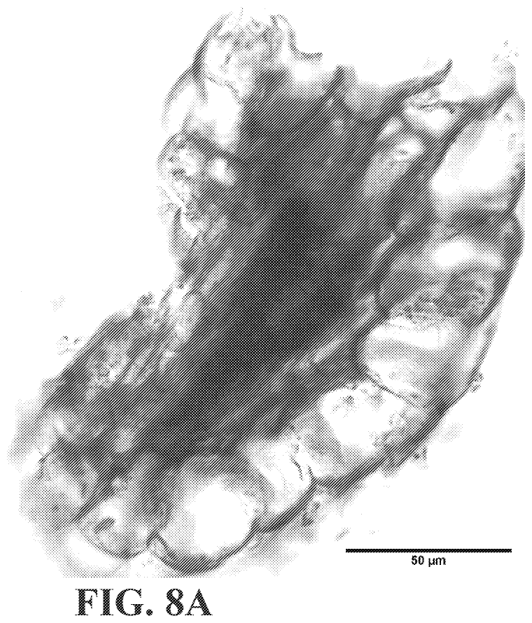

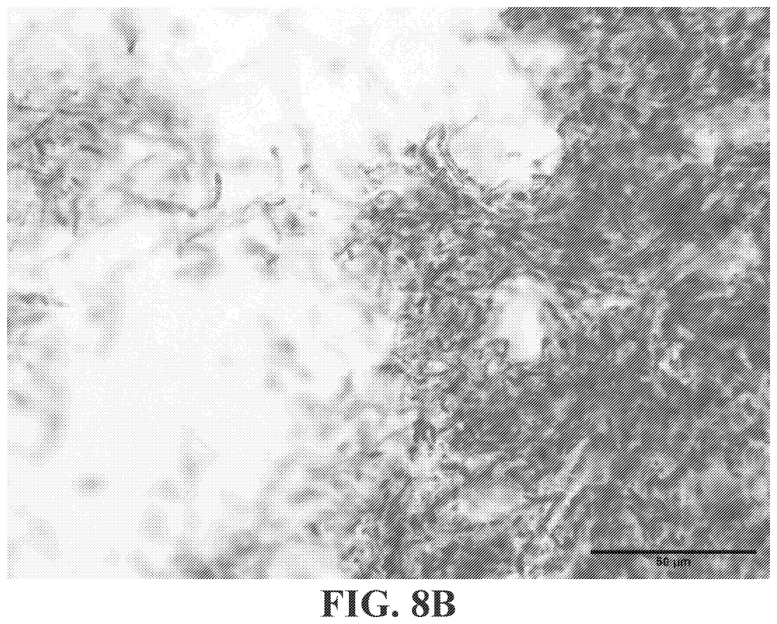

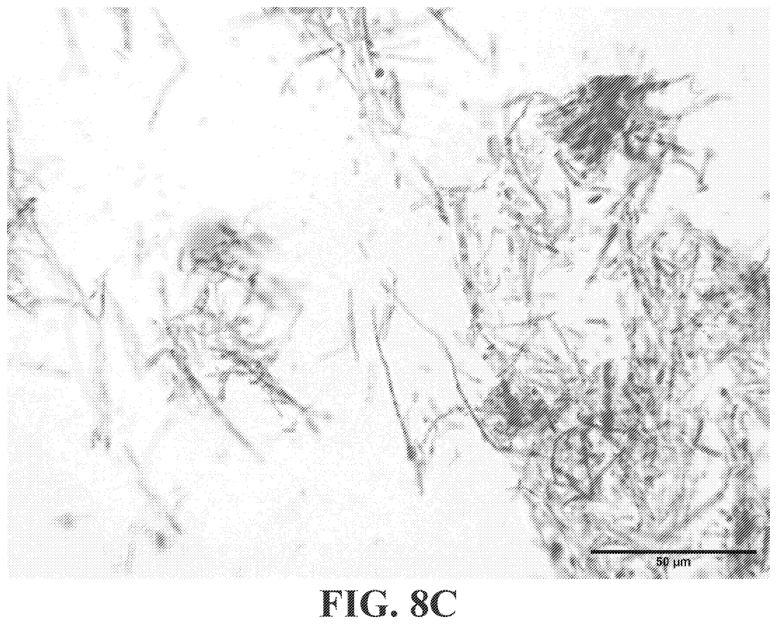

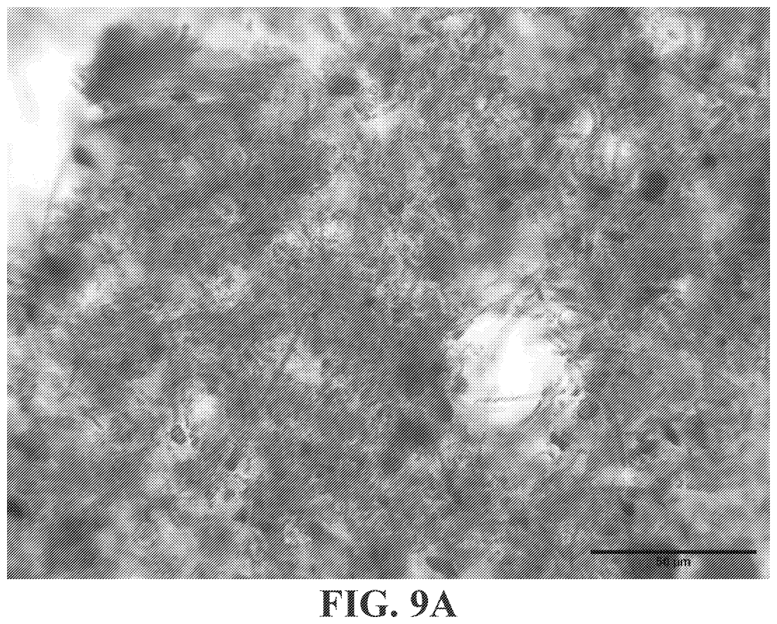

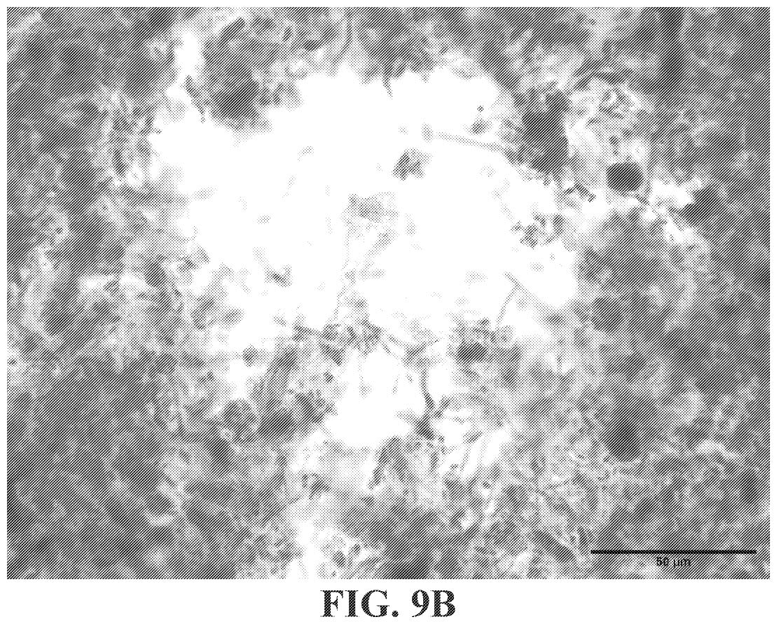

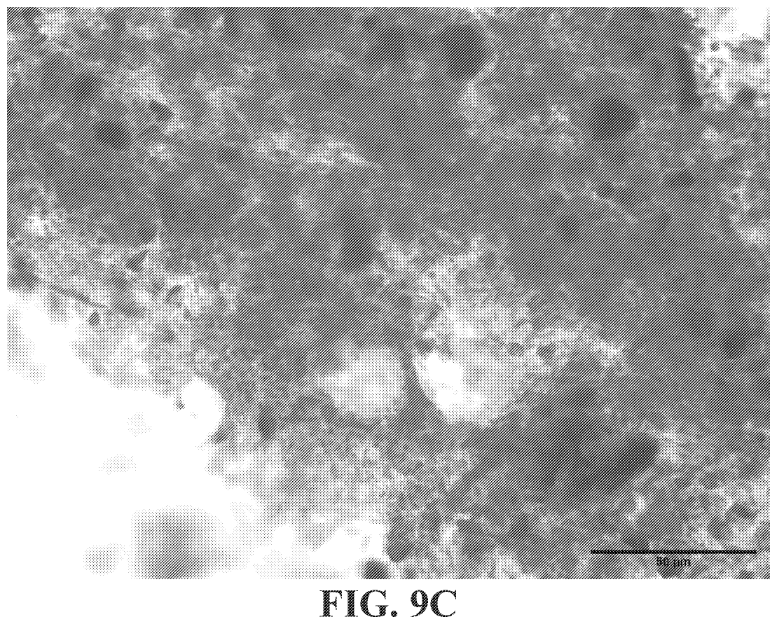

Micrographs at 400× magnification of the nine ice cream analog samples of Example 12 were obtained and are shown as FIGS. 7A (drum-dried vanilla), 7B (spray-dried vanilla), 7C (milk-based vanilla), 8A (drum-dried strawberry), 8B (spray-dried strawberry), 8C (milk-based strawberry), 9A (drum-dried chocolate), 9B (spray-dried chocolate), and 9C (milk-based chocolate).

### Example 15

### Comparative Stability of Dairy Colloids and Fungal Colloids

Four dairy-based colloidal emulsions (“D1,” “D2,” “D3,” and “D4”) and two filamentous fungus-based colloidal emulsions (“F1” and “F2”) were prepared according to the compositions in Table 9. In Table 9, a “3:1 F-milk” refers to a homogenate of one part by weight filamentous fungal particles blended with three parts by weight water.

TABLE 9

| | D1 | | D2 | | D3 | | D4 | | F1 | | F2 | |
|---|---|---|---|---|---|---|---|---|---|---|---|---|
| 2% milk | 685.5 | g | 543 | g | 699 | g | 585 | g | n/a | | n/a | |
| 3:1 F-milk | n/a | | n/a | | n/a | | n/a | | 685.5 | g | 543 | g |
| Canola oil | 64.5 | g | 64.5 | g | 51 | g | 52.5 | g | 64.5 | g | 64.5 | g |
| Cane sugar | n/a | | 142.5 | g | n/a | | 112.5 | g | n/a | | 142.5 | g |
| Total | 750 | g | 750 | g | 750 | g | 750 | g | 750 | g | 750 | g |

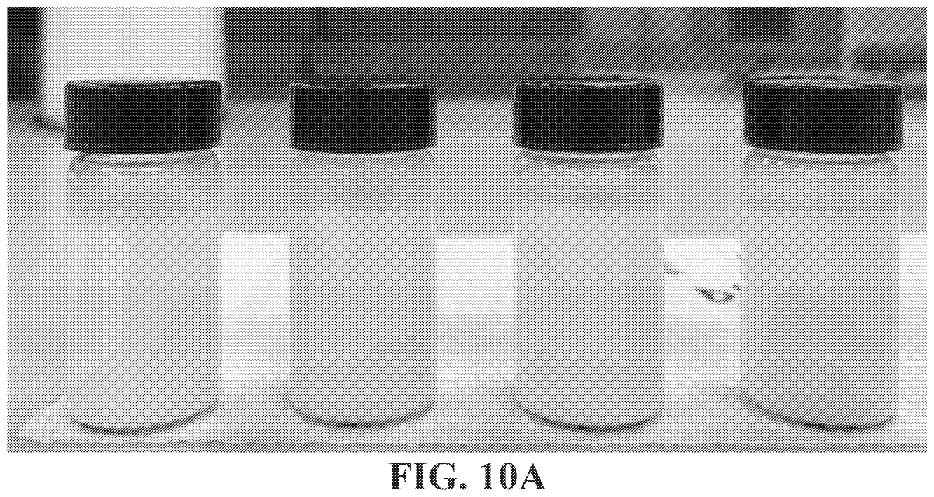

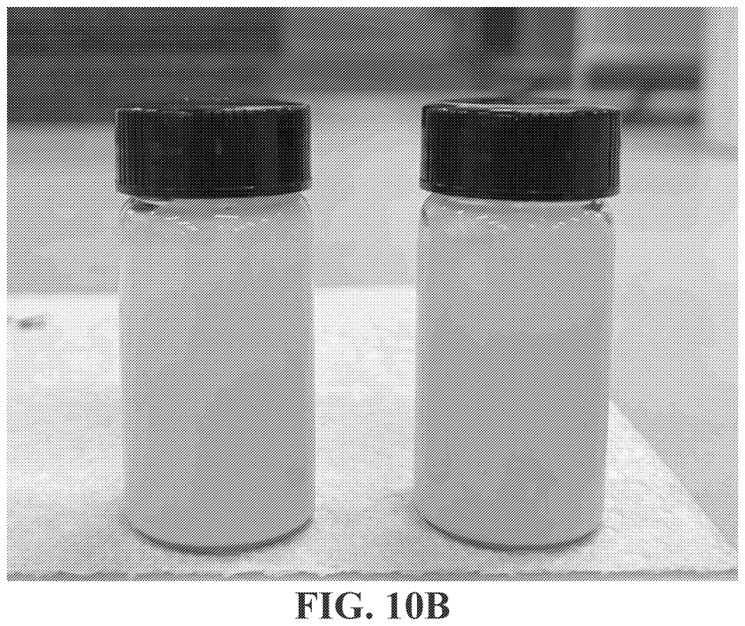

Each colloidal emulsion was prepared by adding all ingredients to a Thermomix blender and blending at high speed (speed “10,” the highest setting) for three minutes, then storing for 24 hours at ambient temperature (70 to 72° F.). Samples of the starting dairy emulsions are illustrated in FIG. 10A (from left to right, D1, D2, D3, and D4), and samples of the starting fungal emulsions are illustrated in FIG. 10B (F1 on left, F2 on right).

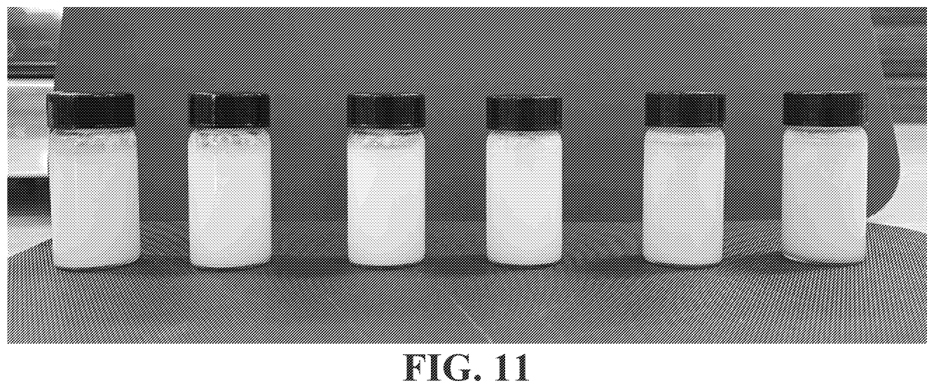

To reduce the viscosity and therefore accelerate the destabilization of the colloidal emulsions, samples of each emulsion were diluted with an equal part by weight of boiling water (with mixing sufficient to ensure homogeneity of the boiling water in the emulsion) and stored for 24 hours at ambient temperature (70 to 72° F.). The diluted samples are illustrated in FIG. 11 (from left to right, D1, D2, D3, D4, F1, and F2).

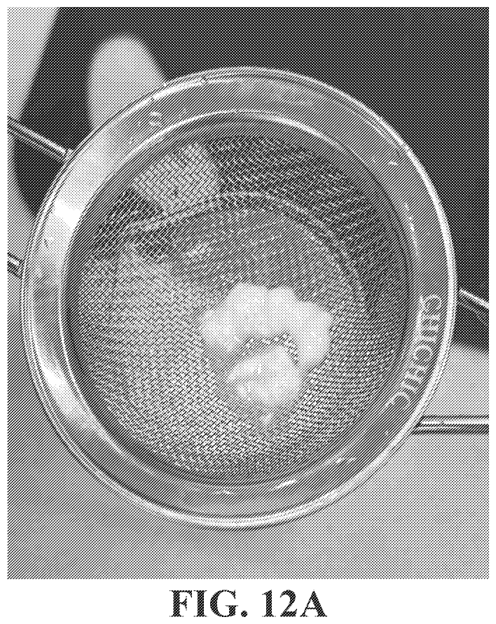

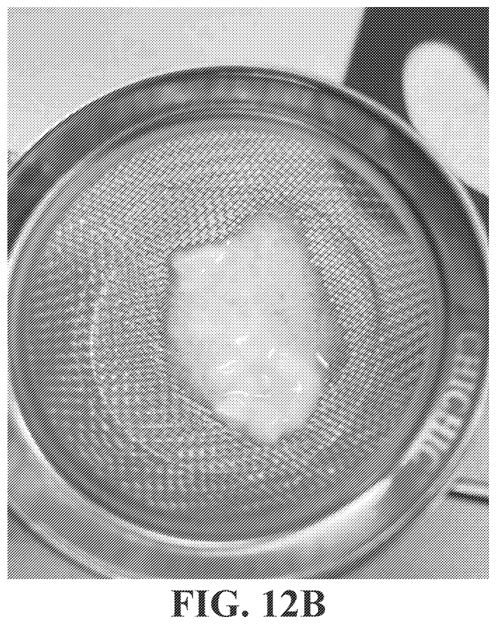

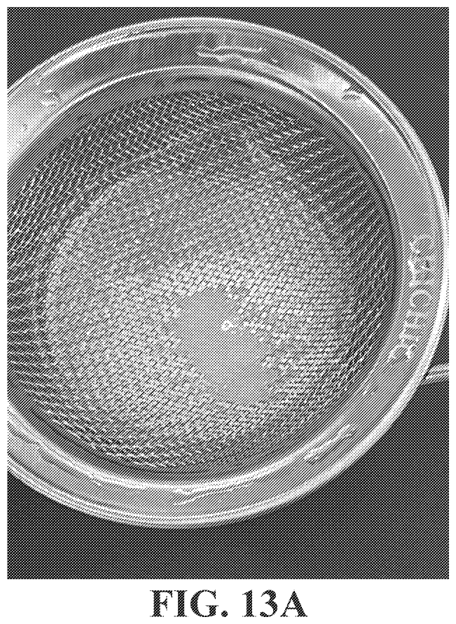

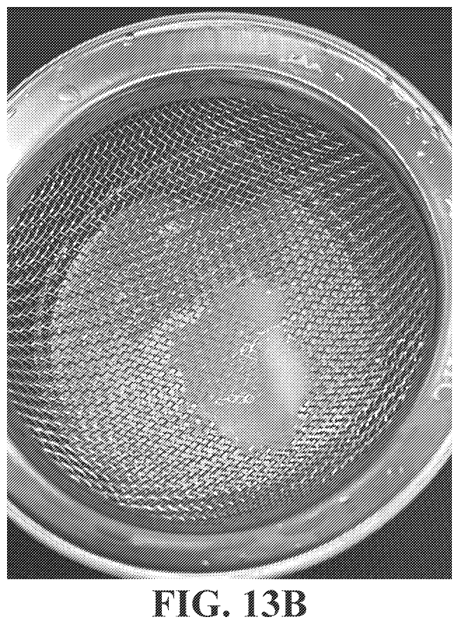

After 24 hours, the diluted emulsions were strained using a stainless-steel kitchen strainer to determine whether any visible creaming (separation of fats) or flocculation had occurred. The dairy-based colloidal emulsions showed extensive creaming that manifested as significant aggregation of fat droplets on the strainer, as illustrated in FIGS. 12A (for emulsion D1) and 12B (for emulsion D2). By contrast, the fungal-based colloidal emulsions showed no signs of creaming, as illustrated in FIGS. 13A (for emulsion F1) and 13B (for emulsion F2), indicating improved emulsion stability. Without wishing to be bound by any particular theory, it is believed that in fungal colloids, even those prepared without any added stabilizers or emulsifiers, the surface charge difference between the fungal particles and the dispersion medium can be sufficient to keep fat particles uniformly sized and dispersed throughout the dispersion medium.

### Example 16

### Colorimetry of Aqueous Dispersions of Fungal Particles

Eight fungal “milks” (aqueous dispersion of fungal particles) were made using, respectively, (1) size-reduced oyster mushrooms, (2) size-reduced portobello mushrooms, (3) size-reduced white button mushrooms, (4) size-reduced shiitake mushrooms, (5) Fusarium strain flavolapis biomass obtained from a submerged fermentation process, (6) drum-dried particles of Fusarium strain flavolapis, (7) spray-dried particles of Fusarium strain flavolapis, and (8) a size-reduced biomat of Fusarium strain flavolapis obtained by a surface fermentation process. In each case, the dispersions consisted of about 75 wt % water and about 25 wt % fungal particles and blended in a conventional kitchen blender.

Each milk was analyzed by a colorimeter and the CIELAB color values for each milk were obtained. The CIELAB color values are given in Table D.

TABLE 10

| Milk | L* | a* | b* |
|---|---|---|---|
| Oyster | 57.00 | 2.17 | 16.68 |
| Portobello | 11.78 | 4.81 | 8.68 |
| White button | 28.67 | 9.61 | 18.79 |
| Shiitake | 40.48 | 7.22 | 19.56 |
| Submerged F. flavolapis | 71.15 | 1.57 | 15.70 |
| Drum-dried F. flavolapis | 71.36 | 4.68 | 21.38 |
| Spray-dried F. flavolapis | 81.46 | 2.10 | 17.73 |
| F. flavolapis biomat | 80.13 | 2.15 | 13.26 |

As the results shown in Table 10 illustrate, fungal “milks” according to the present disclosure can have a wide range of colors, which may be suitable for making any of a variety of different colloidal food compositions as disclosed herein. By way of non-limiting example, a light-colored, near-white milk, e.g., a milk made from spray-dried or biomat-derived Fusarium strain flavolapis particles, may be most suitable for making a light-colored colloidal food composition (e.g., a vanilla ice cream analog food product), whereas a darker brown milk, e.g., a milk made from portobello mushroom particles, may be most suitable for making a dark-colored colloidal food composition.

### Example 17

### Comparative Morphology of Fungal Milks

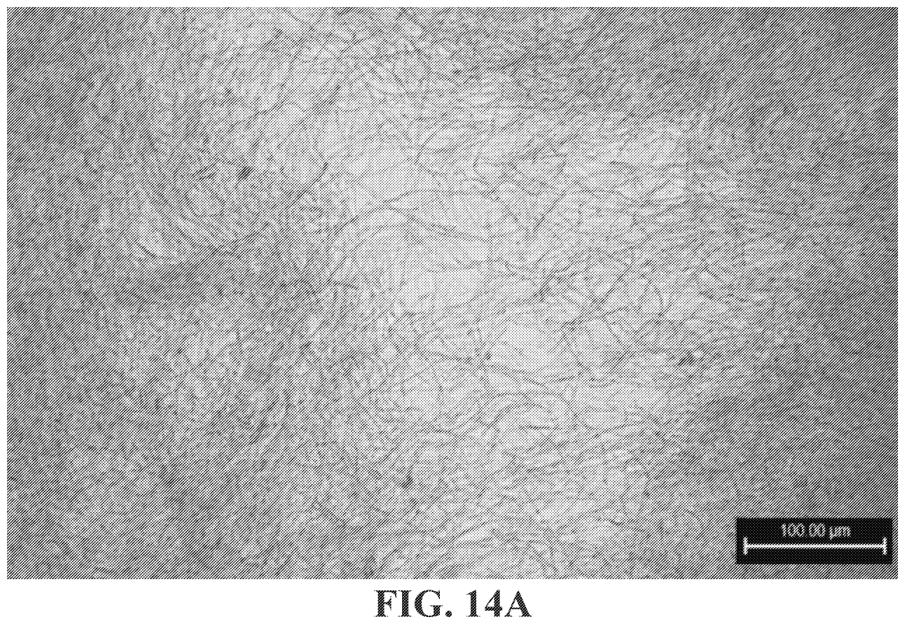

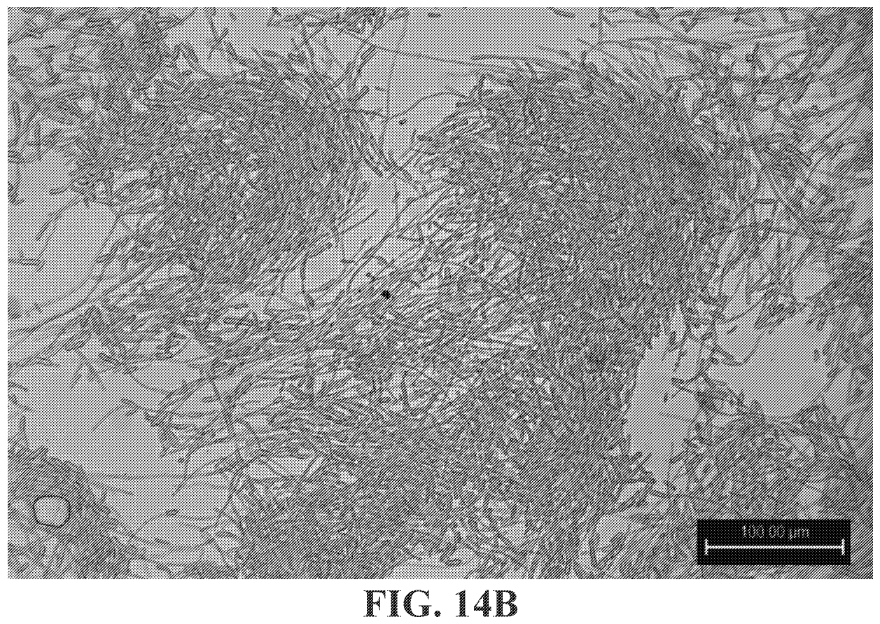

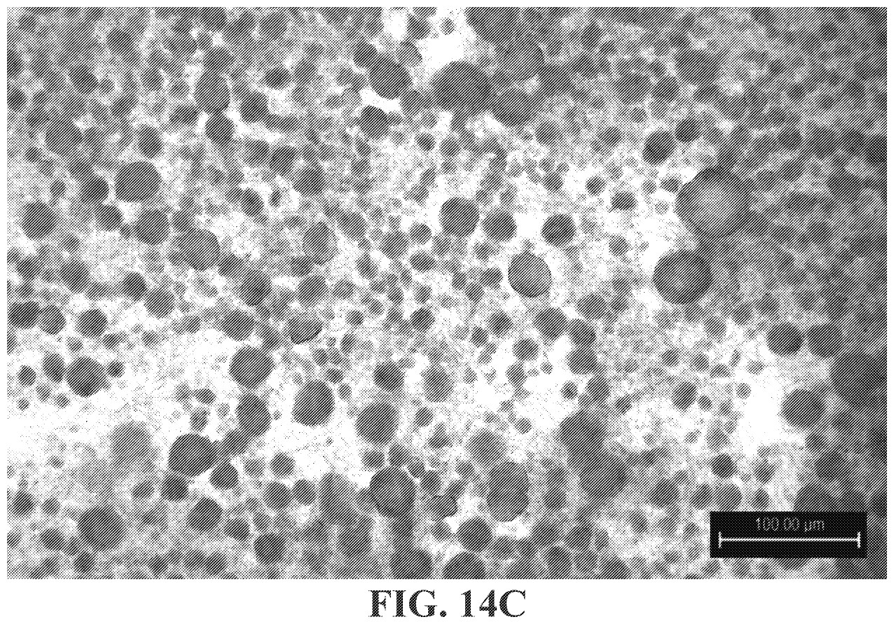

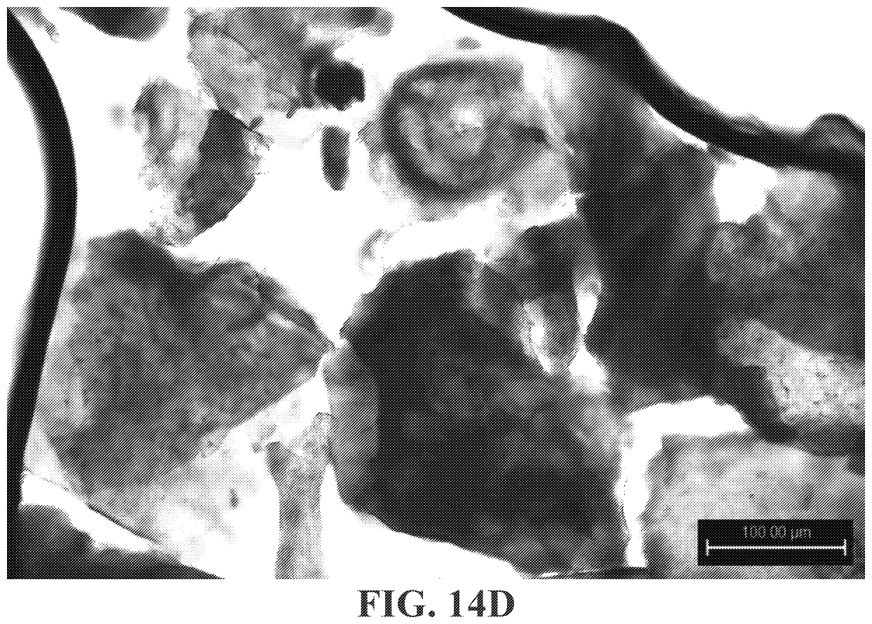

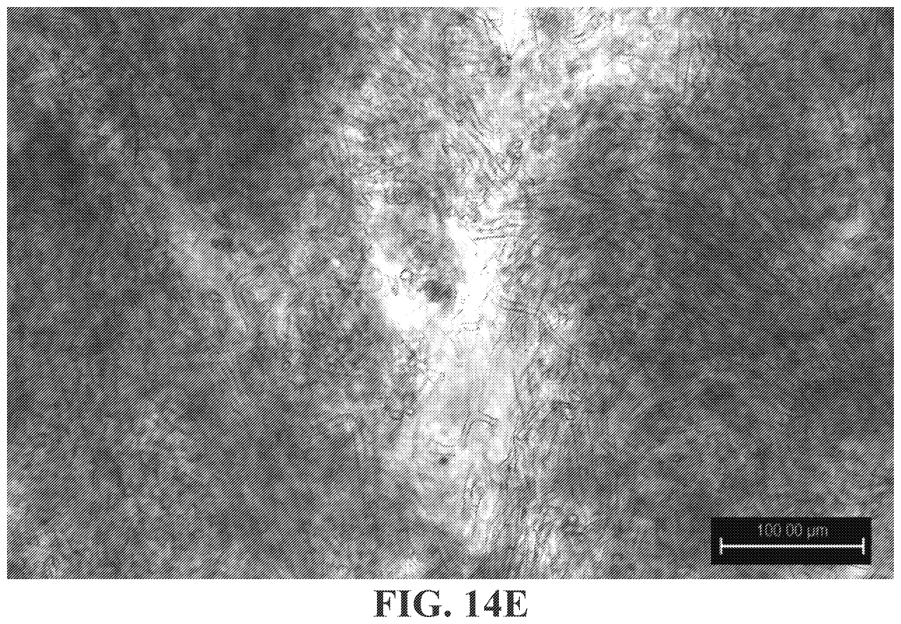

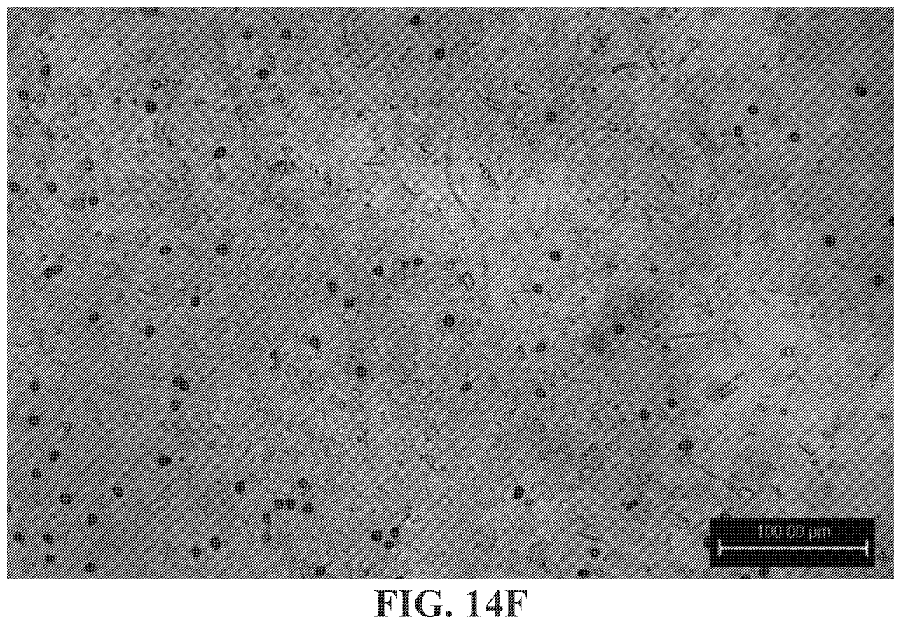

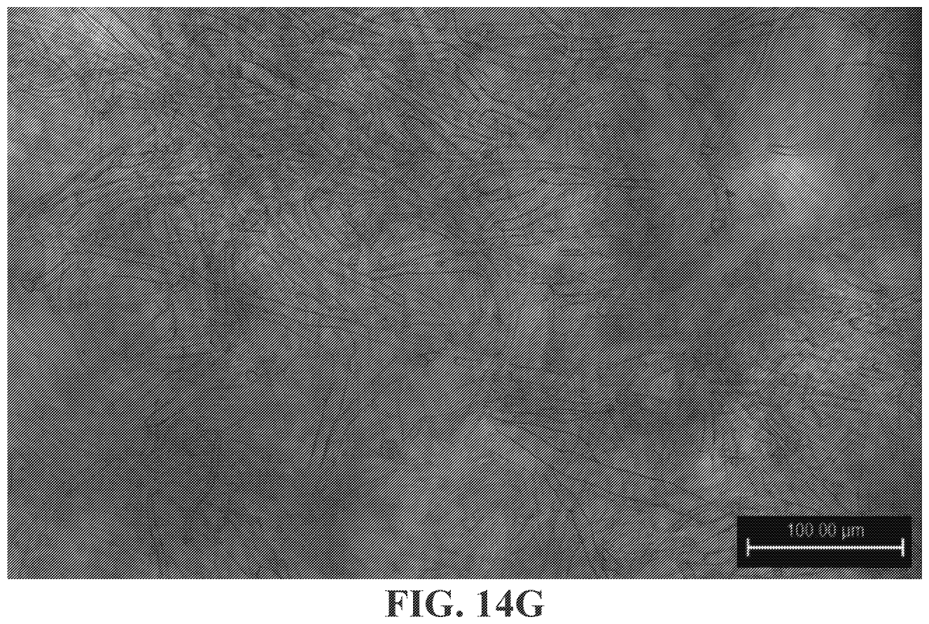

The “fungal milk” liquid dispersions prepared in Example 16 were analyzed by visible-light microscopy. Micrographs of these milks are shown in FIGS. 14A (Fusarium strain flavolapis biomat), 14B (submerged fermentation-derived Fusarium strain flavolapis), 14C (spray-dried Fusarium strain flavolapis), 14D (drum-dried Fusarium strain flavolapis), 14E (oyster mushroom), 14F (portobello mushroom), and 14G (shiitake mushroom). As FIGS. 14A through 14G illustrate, the Fusarium strain flavolapis biomat-derived milk (FIG. 14A) has a mycelial network made up principally of hyphae and filamentous particles that are smaller than the particles in milks derived from mushroom fruiting bodies (FIGS. 14E through 14G) but include fewer conidia than the submerged-fermentation derived milk (FIG. 14B). It can also be observed that the milk derived from spray-dried particles (FIG. 14C) has generally smaller fungal particles than the milk derived from drum-dried particles (FIG. 14D). As described elsewhere throughout this disclosure, each of these morphologies may impart different stability characteristics to fungal “milks” and thus different textural characteristics to colloidal food compositions made therefrom; those skilled in the art may therefore be able to select an appropriate form of fungal starting material to make a fungal-based colloidal food composition based on desired attributes of texture and stability.

### Example 18

### Boiling Points of Fungal Milks

The boiling points of the “fungal milk” liquid dispersions prepared in Example 16, and the time needed to heat these milks from room temperature to boiling, were analyzed under ambient conditions at a facility located approximately 180 meters above sea level. The results are given in Table 11.

TABLE 11

| Fungal particle source | Boiling point (° F.) | Time (min) |
|---|---|---|
| F. flavolapis biomat | 200 | 7 |
| Spray-dried F. flavolapis | 209 | 16 |
| Drum-dried F. flavolapis | 200 | 9:38 |
| Oyster mushroom | 195 | 3:40 |
| Portobello mushroom | 185.9 | 3:07 |
| Shiitake mushroom | 210 | 5 |
| White button mushroom | 182 | 3:50 |

### Example 19

### Nutritional Content of Fungal Milks

The nutritional contents of the “fungal milk” liquid dispersions prepared in Example 16 were analyzed. The total dietary fiber, protein, fat, and moisture contents of each milk are given in Table 12, and the amino acid contents of each milk are given in Table 13; all values in both tables are in weight percent. Amino acids are referred to by their one-letter codes in Table 13; values for asparagine and glutamine were not recorded.

TABLE 12

| Fungal particle source | Total dietary fiber | Protein | Fat | Moisture |
|---|---|---|---|---|
| F. flavolapis biomat | 2.2 | 2.95 | 0.36 | 93.77 |
| Spray-dried F. flavolapis | 2.2 | 2.98 | 0.30 | 93.58 |
| Drum-dried F. flavolapis | 4 | 4.05 | 0.97 | 88.66 |
| Oyster mushroom | 1.8 | 1.09 | 0.33 | 93.40 |
| Portobello mushroom | 1 | 1.50 | 0.34 | 93.64 |
| Shiitake mushroom | 1.4 | 0.62 | 0.28 | 94.35 |
| White button mushroom | 0.8 | 0.94 | 0.29 | 93.35 |

TABLE 13

| Fungal particle source | A | R | D | E | G | H | I | L | F |
|---|---|---|---|---|---|---|---|---|---|
| F. flavolapis biomat | 0.16 | 0.15 | 0.25 | 0.29 | 0.12 | 0.06 | 0.12 | 0.19 | 0.1 |
| Submerged-ferm F. flavolapis | 0.24 | 0.23 | 0.33 | 0.4 | 0.17 | 0.08 | 0.16 | 0.26 | 0.1 |
| Spray-dried F. flavolapis | 0.15 | 0.13 | 0.23 | 0.27 | 0.12 | 0.06 | 0.12 | 0.18 | 0.1 |
| Drum-dried F. flavolapis | 0.32 | 0.29 | 0.49 | 0.58 | 0.24 | 0.12 | 0.24 | 0.39 | 0.22 |
| Oyster mushroom | 0.13 | 0.11 | 0.15 | 0.25 | 0.1 | 0.04 | 0.09 | 0.12 | 0.08 |
| Portobello mushroom | 0.15 | <0.05 | 0.16 | 0.34 | 0.09 | 0.05 | 0.07 | 0.1 | 0.06 |
| Shiitake mushroom | 0.09 | 0.06 | 0.11 | 0.28 | 0.05 | 0.03 | 0.04 | 0.05 | <0.03 |
| White button mushroom | 0.16 | <0.05 | 0.16 | 0.32 | 0.08 | 0.05 | 0.07 | 0.11 | 0.06 |
| | P | S | T | K | Y | W | V | C | M |
| F. flavolapis biomat | 0.12 | 0.13 | 0.14 | 0.2 | 0.08 | 0.04 | 0.28 | 0.02 | 0.04 |
| Submerged-ferm F. flavolapis | 0.15 | 0.17 | 0.18 | 0.29 | 0.13 | 0.06 | 0.28 | 0.03 | 0.07 |
| Spray-dried F. flavolapis | 0.1 | 0.11 | 0.13 | 0.2 | 0.09 | 0.04 | 0.25 | 0.02 | 0.04 |
| Drum-dried F. flavolapis | 0.25 | 0.25 | 0.28 | 0.4 | 0.14 | 0.08 | 0.53 | 0.03 | 0.08 |
| Oyster mushroom | 0.08 | 0.08 | 0.09 | 0.06 | 0.07 | 0.03 | 0.16 | 0.02 | 0.03 |
| Portobello mushroom | 0.06 | 0.06 | 0.09 | 0.1 | <0.04 | 0.04 | 0.2 | <0.01 | 0.02 |
| Shiitake mushroom | <0.05 | 0.06 | 0.06 | 0.08 | <0.04 | 0.02 | 0.13 | <0.01 | <0.01 |
| White button mushroom | 0.06 | 0.06 | 0.09 | 0.1 | <0.04 | 0.03 | 0.19 | <0.01 | 0.02 |

As Tables 12 and 13 illustrate, milks produced from Fusarium strain flavolapis generally had higher amounts of dietary fiber and of most amino acids (and, thus, of total protein) than milks produced from mushroom fruiting bodies. As those skilled in the art will appreciate, this result allows for the selection of an appropriate fungal source based on a desired fiber or amino acid/protein content or profile of the desired end food product; by way of non-limiting example, a Fusarium strain flavolapis source may be selected for a high-fiber and/or high-protein food product, whereas a fruiting body source may be selected for a food product in which the fiber or protein content is not a consideration or is desired to be lower, and a blend of Fusarium strain flavolapis with mushroom fruiting bodies may be called for to produce a food product having an intermediate fiber and/or protein content.

### Example 20

### Viscosity of Mixes for Ice Cream Analog Food Products

Seventeen precursor mixes for vanilla ice cream analog food products were made according to the general method outlined in FIG. 1. Specifically, all but one of the precursor mixes was made as follows: 850 g of a dispersion of filamentous fungal particles in water was prepared. This dispersion was mixed with 100 g of inulins, and the resulting mixture was heated to 40° C. To this mixture, 200 g of sucrose, 60 g of glucose powder, and a stabilizer were added, and the resulting mixture was further heated to 70° C. To this mixture, 115 g of refined coconut oil was added, and the resulting mixture was further heated to 80-82° C.; this temperature was maintained, with mixing via an immersion blender, until each mixture had fully emulsified. The emulsion was then cooled to 5° C., at which point 10 g of vanilla paste was added and the mix was churned to introduce colloidally dispersed air bubbles into the emulsion. The remaining precursor mix, hereinafter referred to as “V9,” was made by the same method, except that the refined coconut oil was added before the sucrose, glucose powder, and stabilizer.

The seventeen precursor mixes differed from each other in terms of (1) the type of fungal particles, (2) the weight ratio of water to fungal particles in the initial aqueous dispersion, and (3) the identity and amount of the stabilizer. The identifiers for each mix and the differences between them are shown in Table 14.

TABLE 14

| | | H₂O:fungus wt | |
|---|---|---|---|
| | | ratio in | |
| Mix ID | Fungal particle type | dispersion | Stabilizer |
| Fy mat | Size-reduced F. flavolapis biomat | 3:1 | 1 g locust bean gum |
| DD Fy | Drum-dried F. flavolapis | 3:1 | 1 g locust bean gum |
| SD Fy | Spray-dried F. flavolapis | 3:1 | 1 g locust bean gum |
| Portobello | Size-reduced portobello mushroom | 3:1 | 1 g locust bean gum |
| Oyster | Size-reduced oyster mushroom | 3:1 | 1 g locust bean gum |
| Shiitake | Size-reduced shiitake mushroom | 3:1 | 1 g locust bean gum |
| White button | Size-reduced white button mushroom | 3:1 | 1 g locust bean gum |
| V1 | F. flavolapis biomat | 6:1 | 1 g locust bean gum |
| V2 | F. flavolapis biomat | 4.5:1 | 1 g locust bean gum |
| V3 | F. flavolapis biomat | 3:1 | 0.5 wt % gum arabic |
| V4 | F. flavolapis biomat | 3:1 | 1 wt % gum arabic |
| V5 | F. flavolapis biomat | 3:1 | 3 wt % gum arabic |
| V6 | F. flavolapis biomat | 3:1 | 0.1 wt % lecithin |
| V7 | F. flavolapis biomat | 3:1 | 0.3 wt % lecithin |
| V8 | F. flavolapis biomat | 3:1 | 1 wt % lecithin |
| V9 | F. flavolapis biomat | 3:1 | 1 g locust bean gum |
| V11 | Submerged-fermentation F. flavolapis | 3:1 | 1 g locust bean gum |

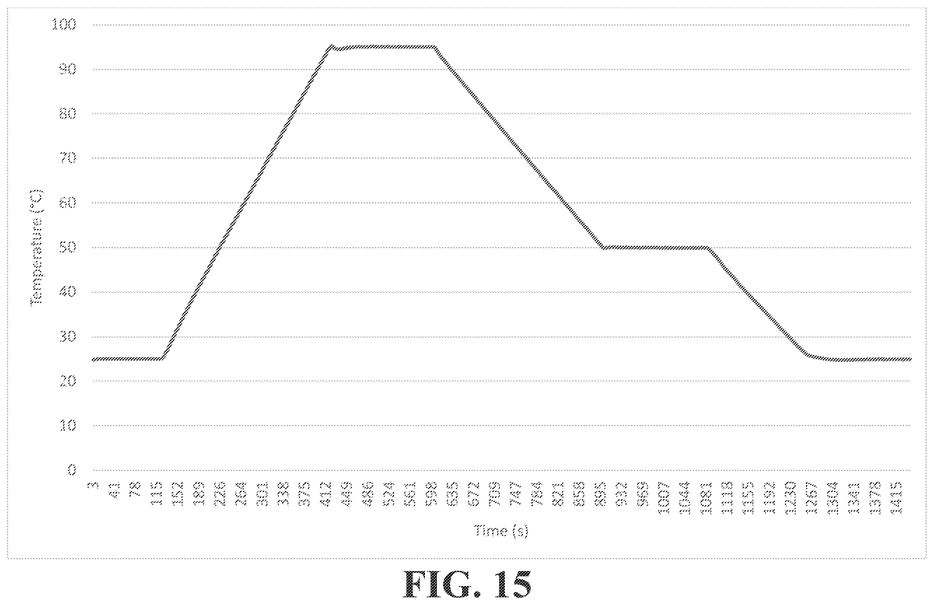

Each of the seventeen mixes listed in Table 14 was subjected to viscosity analysis using a PerkinElmer Rapid Visco Analyser (RVA) at a speed of 150 rpm over a period of 24 minutes. A graph of the temperature of each sample during the analysis is shown in FIG. 15. The initial and final viscosities of each mix are given in Table 15.

TABLE 15

| | Initial viscosity | Final viscosity |
|---|---|---|
| Mix ID | (cP) | (cP) |
| Fy mat | 667 | 784 |
| DD Fy | 570 | 691 |
| SD Fy | 583 | 785 |
| Portobello | 403 | 484 |
| Oyster | 397 | 428 |
| Shiitake | 570 | 691 |
| White button | 381 | 500 |
| V1 | 1663 | 2045 |
| V2 | 1235 | 681 |
| V3 | 1028 | 1025 |
| V4 | 770 | 974 |
| V5 | 1281 | 1116 |
| V6 | 640 | 549 |
| V7 | 1157 | 695 |
| V8 | 1073 | 665 |
| V9 | 1249 | 744 |
| V11 | 363 | 270 |

As Table 15 illustrates, ice cream analog precursor mixes and similar colloidal compositions according to the present disclosure can have a wide range of viscosities, which may be suitable for making any of a variety of different colloidal food compositions as disclosed herein. Generally, these colloidal compositions recover their initial viscosities after heat treatment, with compositions including a higher content of stabilizer having higher viscosities both initially and after heat treatment. Notably, the ice cream analog precursor mix made with particles derived from a submerged fermentation process (V11) had a lower viscosity than mixes made with fungal particles derived from other sources.

### Example 21

### Particle Size Distributions in Mixes for Ice Cream Analog Food Products

The distributions of particle sizes in the ice cream analog precursor mixes of Example 20 were characterized by laser diffraction using a Mastersizer 3000 instrument. Statistics and observations describing the particle size distributions are shown in Table 16. In Table 16, “peak” refers to the volume-weighted mean particle size, and “span” refers to the difference between the 90^{th} percentile and 10^{th} percentile particle sizes, divided by the median particle size (i.e., (D₉₀−D₁₀)/D₅₀).

TABLE 16

| Formulation | Peak (μm) | Span | Distribution |
|---|---|---|---|
| V1 | 18.2 | 2.19 | unimodal |
| V2 | 19.5 | 2.15 | unimodal |
| V3 | 19 | 2.34 | unimodal |
| V4 | 15.9 | 2.49 | unimodal |
| V5 | 20.8 | 2.59 | unimodal |
| V6 | 22.3 | 2.49 | unimodal |
| V7 | 786 | 2.48 | bimodal |
| V8 | 725 | 2.85 | bimodal |
| V9 | 286 | 40.49 | bimodal |
| V11 | 19.6 | 6.17 | unimodal |

Formulations V1-6 and V11 had particle sizes under 25 μm, indicating those formulations will produce ice cream with high creaminess and smooth mouthfeel. The increased gum levels in formulations V7-V9 caused increased particle size, indicating that use of gum in these quantities inhibits stabilization and other desired emulsification properties.

### Example 22

### Zeta Potential of Mixes for Ice Cream Analog Food Products

The zeta potentials of each of the ice cream analog precursor mixes of Example 20 were measured at room temperature (21 to 23° C.). For each precursor mix, a small amount of precursor mix was mixed with 30 mL Nanopure water in a vortex mixer and measured by a Zeta-Meter 4.0 instrument 10 to 13 separate times. The results are given in Table 17.

TABLE 17

| Mix ID | Zeta potential (mV) |
|---|---|
| Fy mat | −37.23 ± 5.03 |
| DD Fy | −30.38 ± 3.20 |
| SD Fy 10 g | −26.83 ± 4.59 |
| Portobello | −31.33 ± 6.17 |
| Oyster | −29.18 ± 5.44 |
| Shiitake | −19.30 ± 4.70 |
| White button | −30.23 ± 6.52 |
| V1 | −32.59 ± 5.16 |
| V2 | −41.15 ± 6.88 |
| V3 | −43.48 ± 5.76 |
| V4 | −45.82 ± 5.71 |
| V5 | −51.23 ± 8.10 |
| V6 | −36.61 ± 6.57 |
| V7 | −28.00 ± 3.38 |
| V8 | −58.89 ± 5.28 |
| V9 | −30.92 ± 5.10 |
| V11 | −43.15 ± 7.26 |

### Example 23

### Contact Angle of Mixes for Ice Cream Analog Food Products

The same ice cream analog precursor mixes assessed in Example 22 were measured for contact angle at room temperature on each of two substrates: silicon wafer and Teflon. For each precursor mix, a small amount of precursor mix was mixed with 30 mL Nanopure water in a vortex mixer and then measured using a video contact angle system. Each sample was measured three times.

Some samples were so viscous that there were two angles along the side of each droplet: an angle at the air/solid/liquid interface, and another angle higher on the surface of the drop resulting from the attractive forces of molecules within the sample. For these droplets, the first of these angles (i.e., the angle best matching that of the liquid touching the silicon or Teflon surface) was measured.

The results are given in Table 18 (the contact angle of deionized water is also given for comparison).

TABLE 18

| | Silicon wafer contact angle | Teflon contact angle |
|---|---|---|
| Mix ID | (°) | (°) |
| DI water | 54.70 ± 1.37 | 88.83 ± 7.23 |
| Fy mat | 53.97 ± 3.29 | 90.60 ± 2.11 |
| DD Fy | 54.95 ± 2.08 | 97.90 ± 5.63 |
| SD Fy 10 g | 58.02 ± 3.85 | 86.05 ± 4.68 |
| Portobello | 47.60 ± 3.33 | 82.98 ± 5.83 |
| Oyster | 48.18 ± 1.90 | 85.72 ± 1.70 |
| Shiitake | 47.92 ± 3.94 | 93.03 ± 6.06 |
| White button | 47.37 ± 1.32 | 82.98 ± 5.83 |
| V1 | 60.57 ± 1.55 | 82.57 ± 4.34 |
| V2 | 53.60 ± 3.28 | 85.60 ± 6.86 |
| V3 | 52.58 ± 3.08 | 82.80 ± 2.16 |
| V4 | 59.07 ± 3.39 | 82.50 ± 10.23 |
| V5 | 58.63 ± 0.68 | 86.72 ± 11.59 |
| V6 | 53.70 ± 0.86 | 83.83 ± 15.60 |
| V7 | 55.08 ± 4.15 | 93.40 ± 2.04 |
| V8 | 54.75 ± 6.50 | 80.78 ± 8.89 |
| V9 | 55.57 ± 6.03 | 82.68 ± 11.91 |
| V11 | 48.88 ± 2.44 | 90.32 ± 7.19 |

### Example 24

### Morphology of Ice Cream Analog Food Products

Ice cream analog precursor mixes Fy mat, V3, V4, V5, V6, V7, V8, and V11 described in Example 21 were made into ice cream analog food products by being blast-frozen to −18° C. and then frozen for long-term storage at −10° C. Surface micrographs of samples of each ice cream analog food product were then obtained by scanning electron microscopy (SEM) using a Zeiss scanning electron microscope.

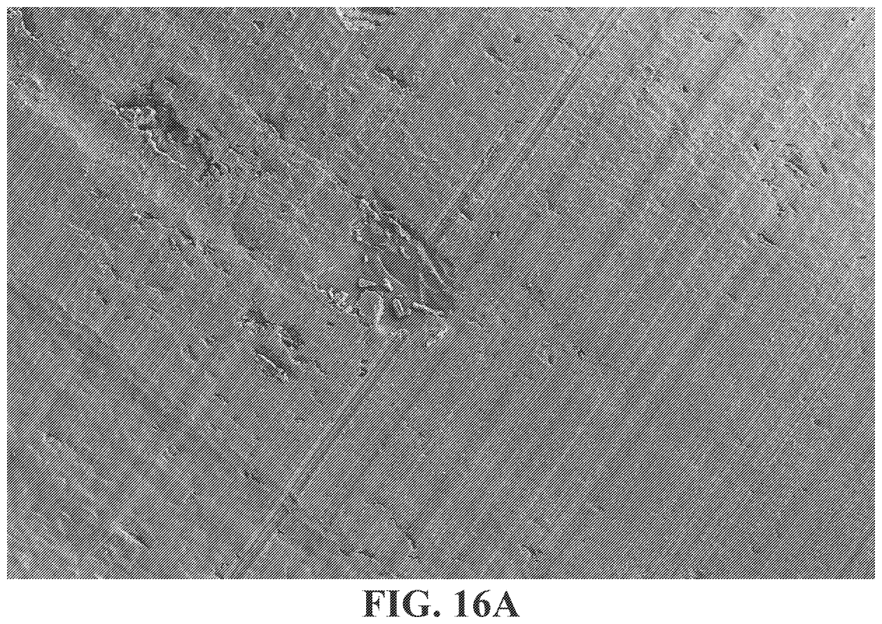

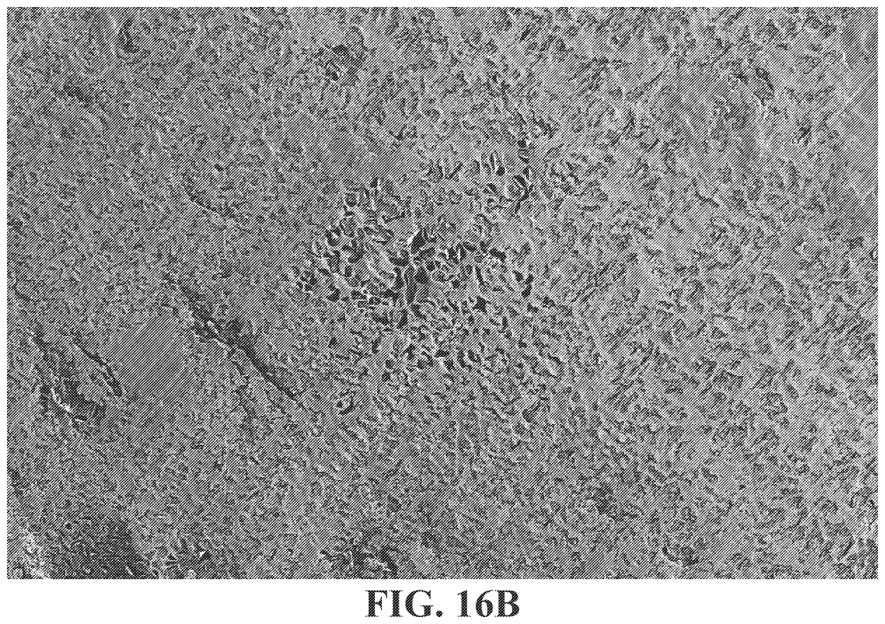

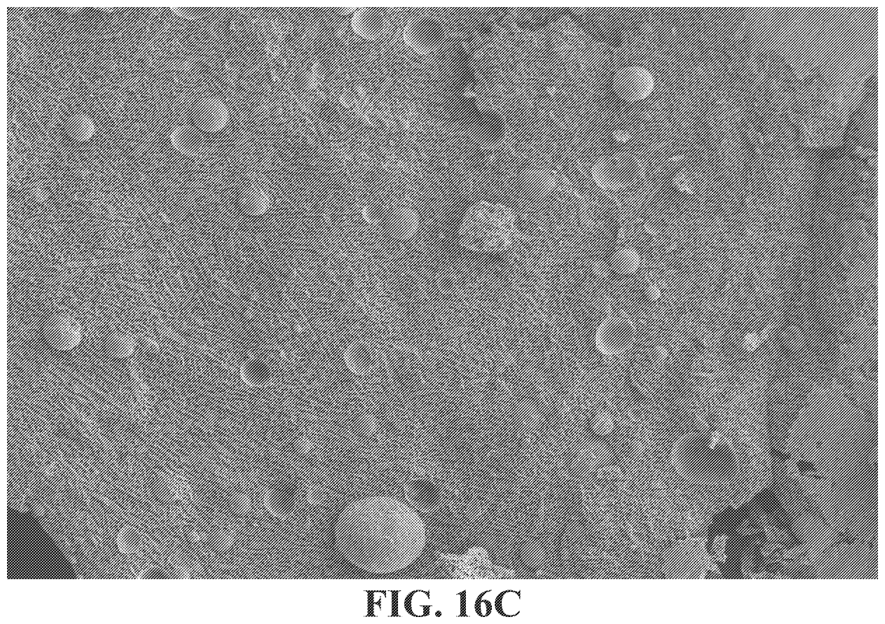

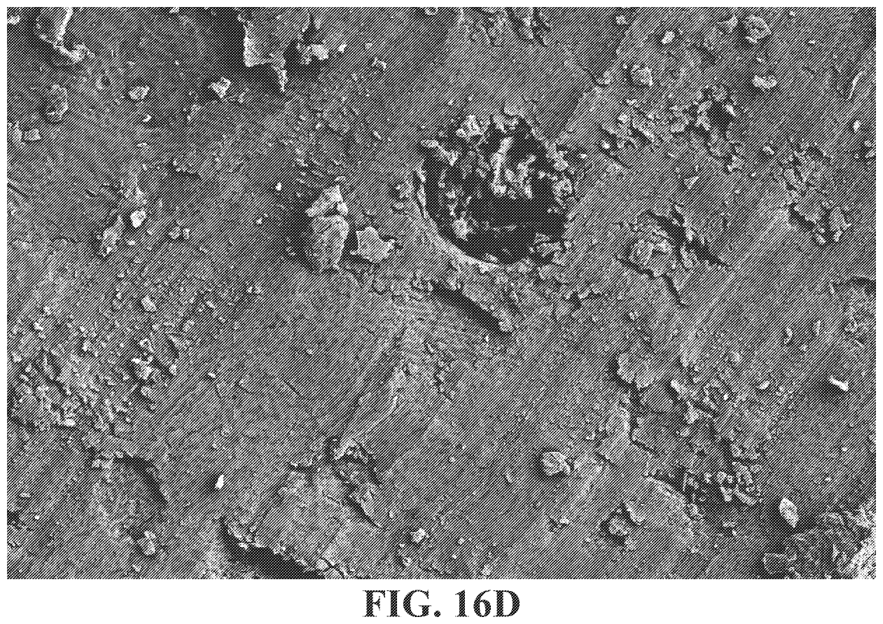

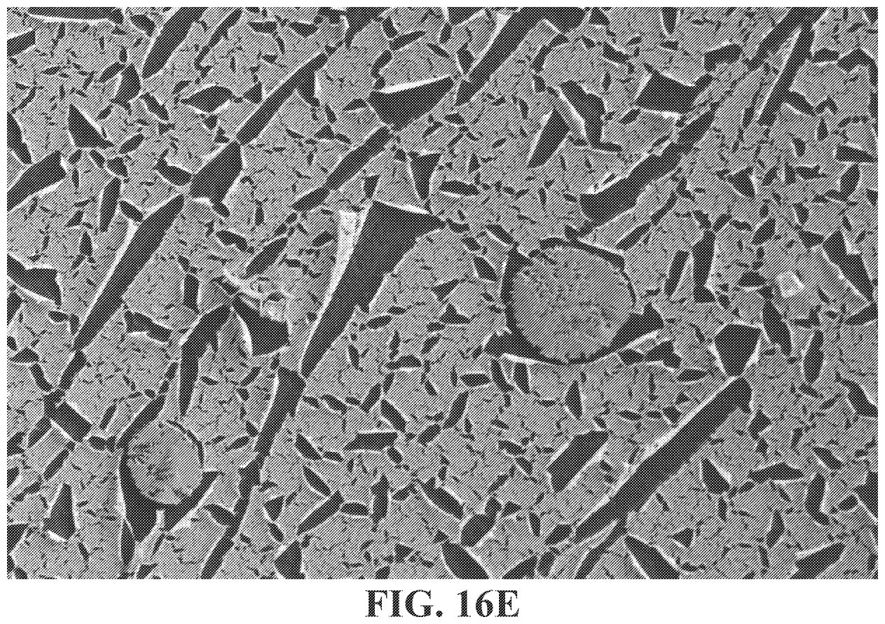

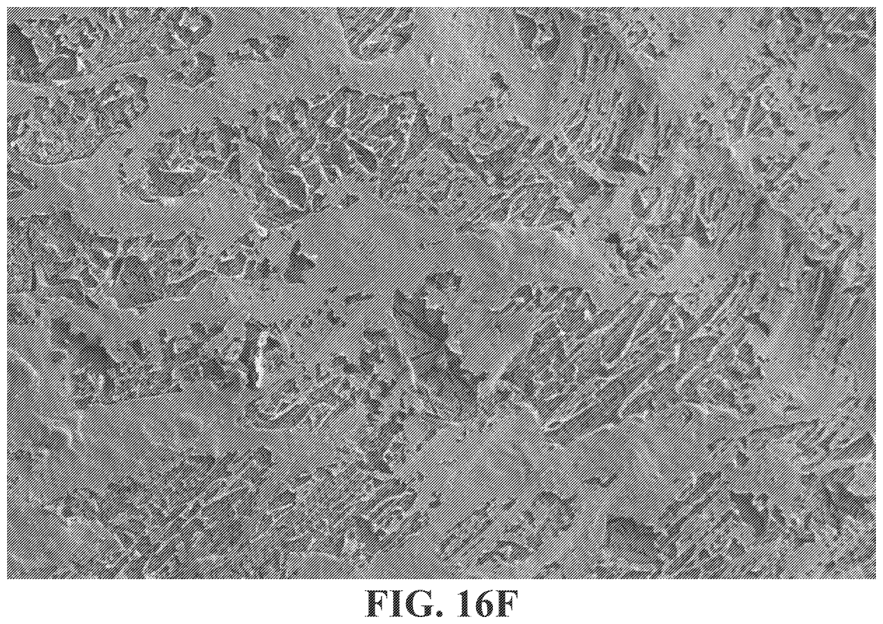

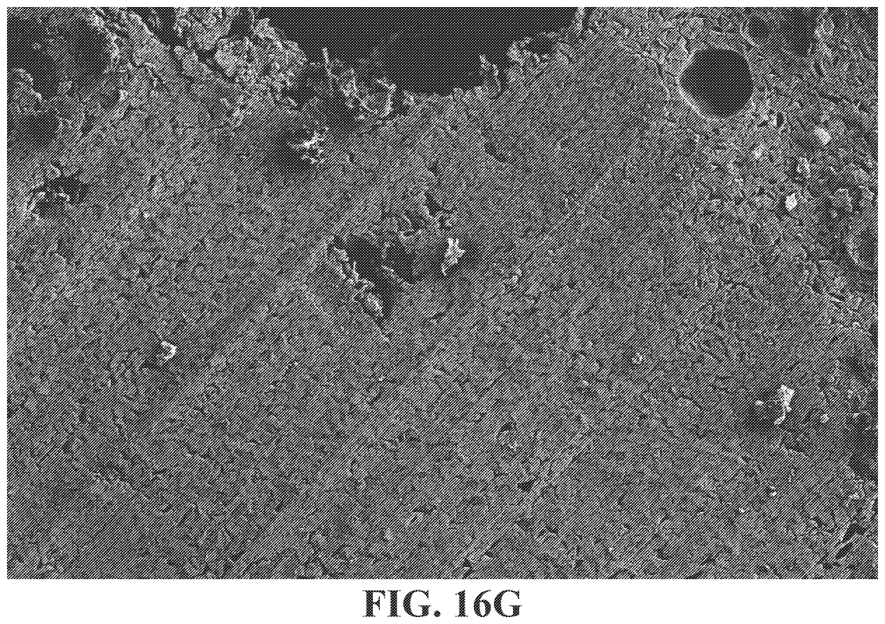

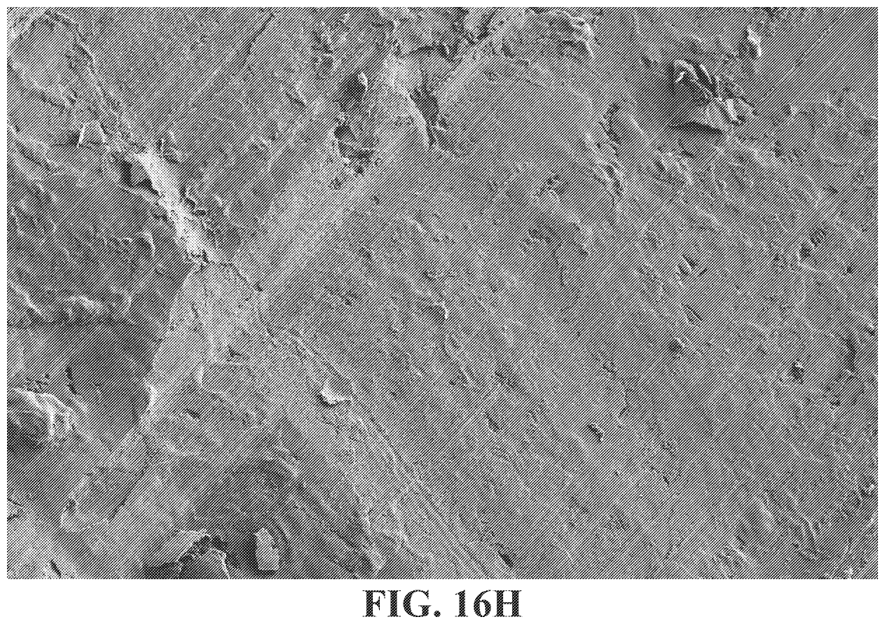

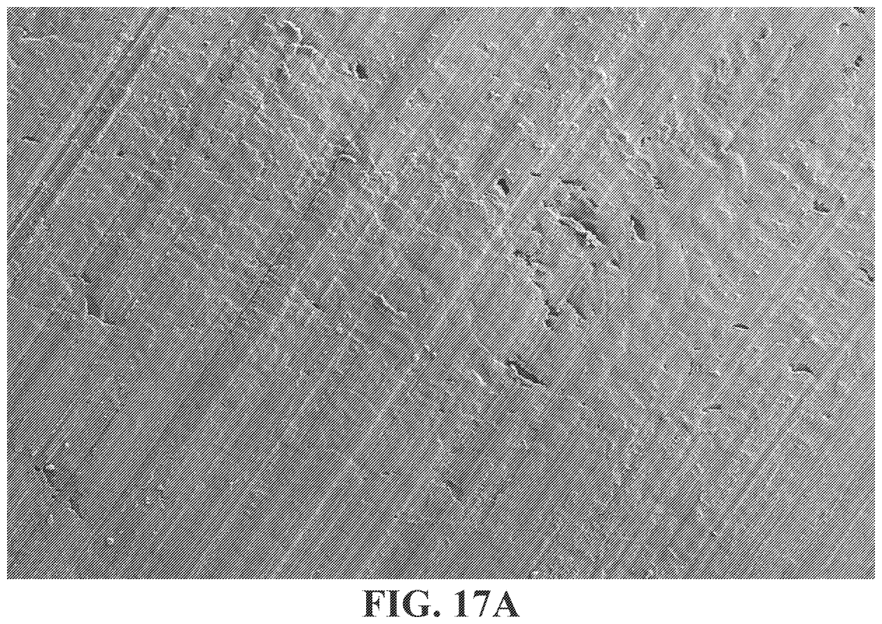

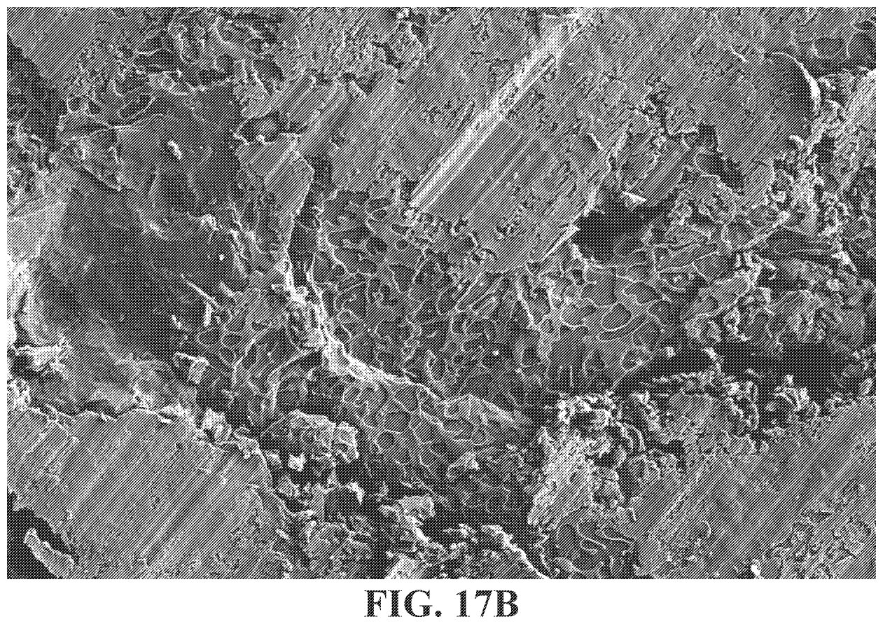

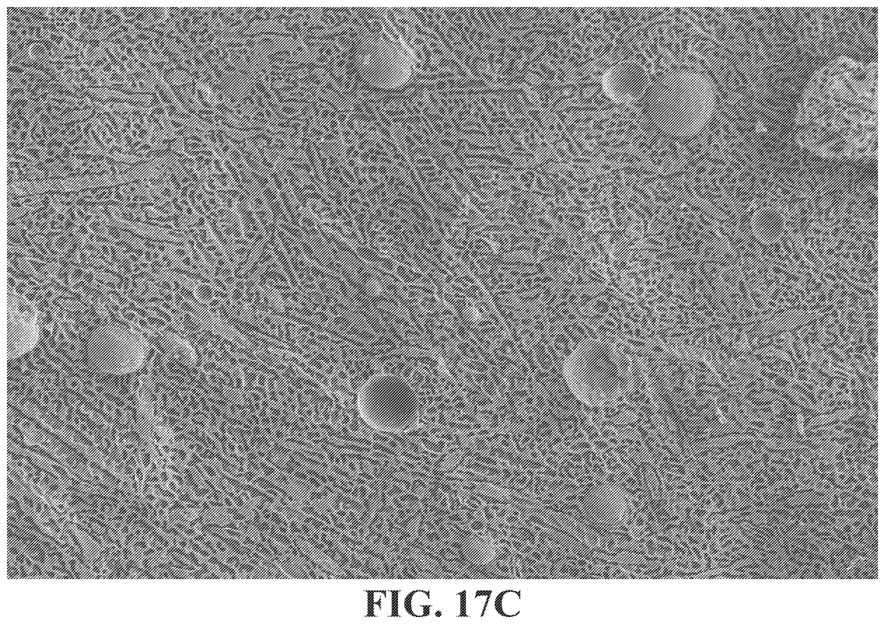

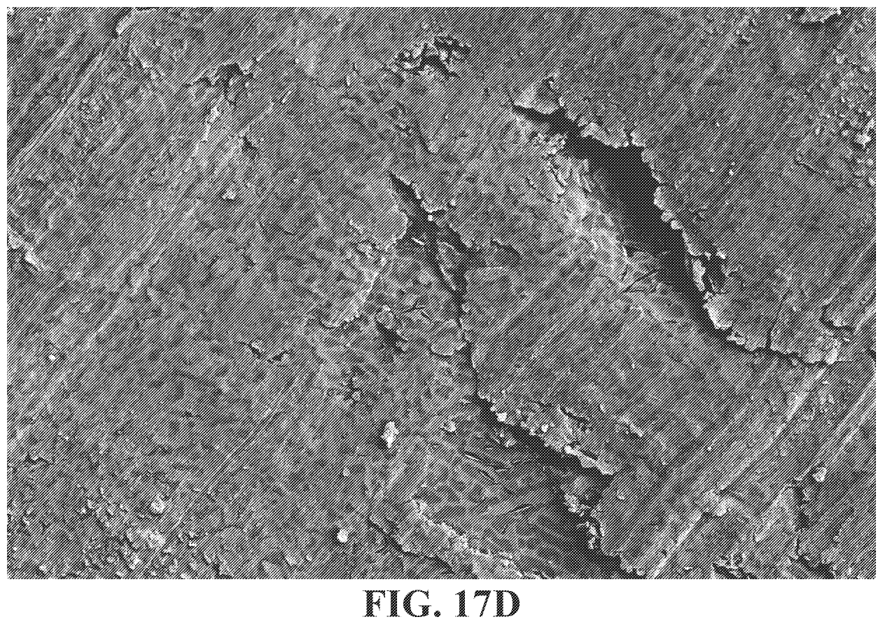

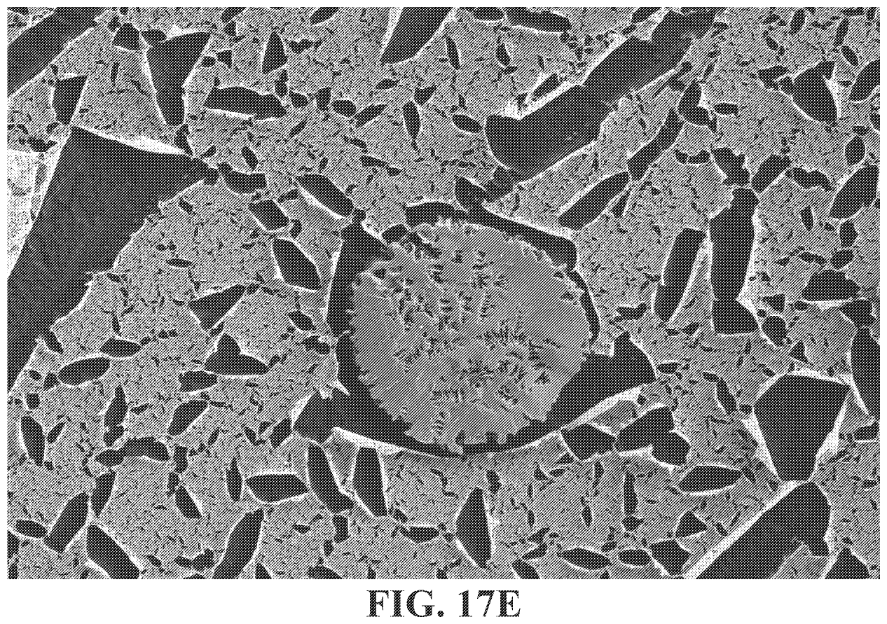

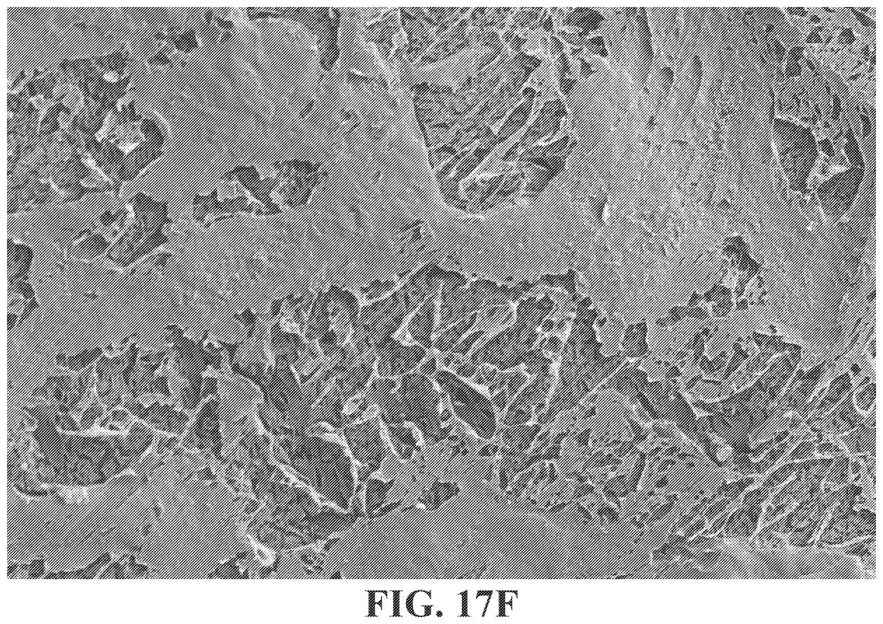

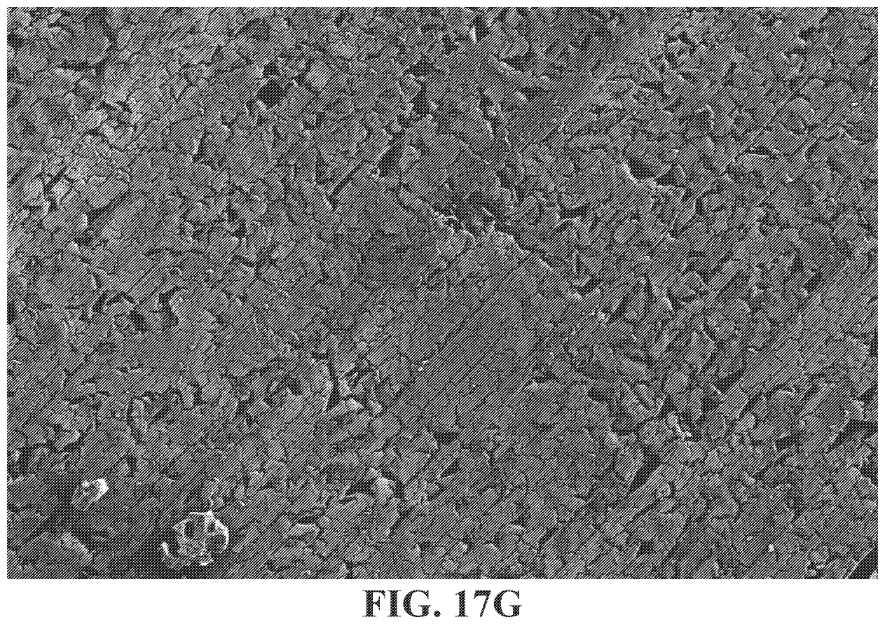

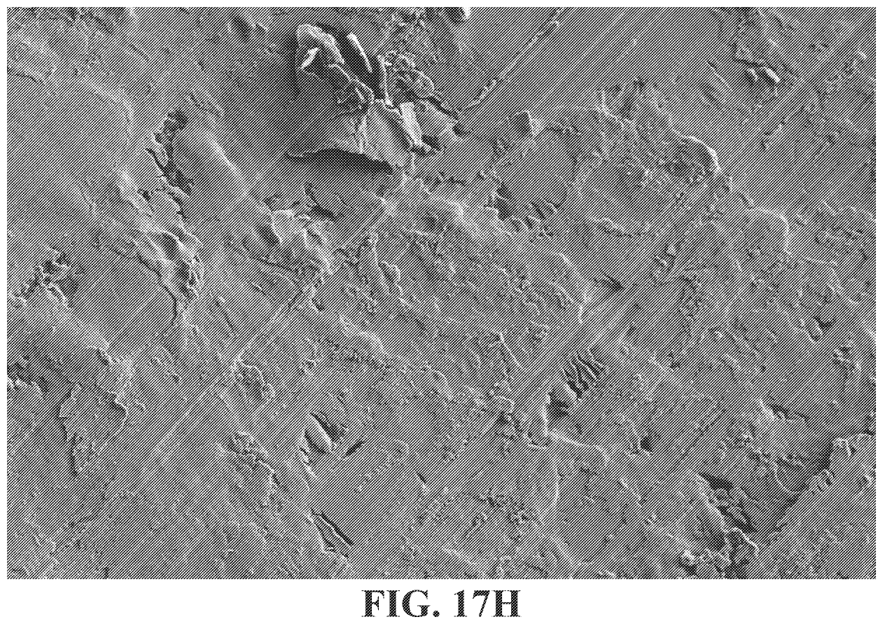

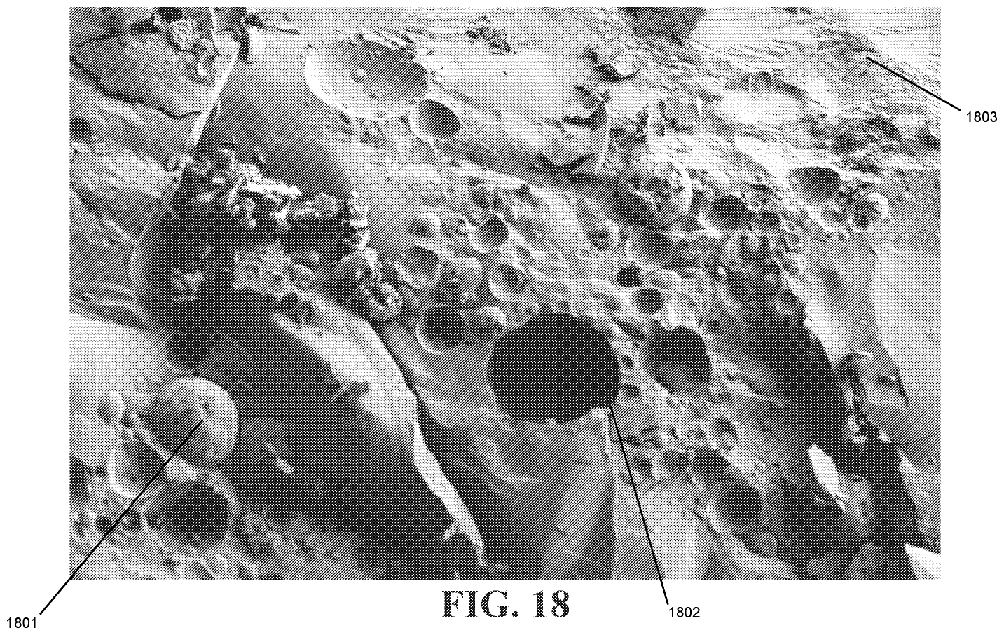

FIGS. 16A through 16H show SEM images of ice cream analog food products Fy mat, V3, V4, V5, V6, V7, V8, and V11, respectively, at 500× magnification, and FIGS. 17A through 17H show SEM images of ice cream analog food products Fy mat, V3, V4, V5, V6, V7, V8, and V11, respectively, at 1,000× magnification. FIG. 18 shows product V11 at a lower degree of magnification (200×) and is annotated for the purposes of indicating examples of certain structural features of the ice cream analog food products generally; in FIGS. 16-18, protein particles appear as approximately spherical features (e.g., protein particle 1801 in FIG. 18), air bubbles appear as dark voids (e.g., air bubble 1802 in FIG. 18), and the fat is dispersed as a generally continuous phase (e.g., fat phase 1803 in FIG. 18). As the images show, all of the ice cream analog food products exhibited desirable emulsification of the fungal particles, with some variation in terms of protein, fat, and air bubble distribution, but in general all of the products show a structure in which most of the air bubbles are small and substantially homogeneously distributed throughout the composition. Product V6 particularly (FIGS. 16E and 17E), which contained a small amount (0.1 wt %) of the well-known food stabilizer lecithin, exhibited a highly homogeneous distribution of fat, protein, and air cells throughout the sample. Product V11 (FIGS. 16H and 17H), produced from filamentous fungal particles derived from a surface fermentation process, showed a different structure relative to the fungal mat- and fungal flour-derived products, with higher moisture content at the surface of the sample and greater protein observed within the sample.

### Example 25

### Sensory Perceptions of Ice Creams and Ice Cream Analog Food Products

Samples of ice cream analog food products V1, Fy mat, V11, DD Fy, and SD Fy described in Example 24 were selected for comparative sensory perception testing against a commercially available dairy ice cream (Breyer's Natural Vanilla Ice Cream) and a commercially available non-dairy ice cream analog product (Fronen Madagascar Vanilla Frozen Dessert). A group of nine panelists were screened for taste acuity; to ensure accurate and consistent use of terminology, the panelists participated in a training prior to evaluation, in which key textural attributes of ice creams and analogous food products were discussed and defined and scaling was practiced.

Samples of each product were scooped into lidded 2-ounce cups and held at 0° F. for several hours before the evaluation. Each panelist received a sample of approximately two tablespoons of each product and were asked, after tasting each product, to evaluate the products on a scale of 0 (none) to 10 (very high) in each of five textural attributes: firmness out of cup (force needed to compress the sample when spooning the sample out of the cup), iciness (perception of ice crystals within the sample immediately after placing the sample in the mouth), firmness in mouth (force needed to compress the sample between the tongue and the palate), creamy mouthfeel (intensity of the “creamy” feeling perceived when the food product is in the mouth), and creamy mouthcoating (intensity of the “creamy” feeling perceived after the food product is swallowed or expectorated). Following this evaluation, each panelist then received a smaller sample (approximately one teaspoon) of each product to perform a “meltdown” test to evaluate the time (in seconds) required for the product to melt in the mouth when continuously pressed against the palate by the tongue. The samples were labeled with random three-digit codes and presented in a randomized order to each panelist, each of whom completed all evaluations independently; data were collected using RedJade Sensory Software.

The average score reported by the nine panelists for each attribute and each product are given in Table 19. Statistical significance tests (two-way ANOVA, with a Fisher's LSD used as a post hoc check) were carried out to assess statistical significance at a P<0.05 level; in Table 20, for a given attribute, scores reported with the same capital letter are not statistically significant relative to each other, while scores reported with different capital letters are statistically significant relative to each other.

TABLE 19

| | | Non- | | Fy | | DD | SD |
|---|---|---|---|---|---|---|---|
| | Dairy | dairy | V1 | mat | V11 | Fy | Fy |
| Firmness | 4.7 | 6.6 | 7.9 | 6.0 | 6.1 | 7.1 | 6.8 |
| (out of cup) | C | B | A | B | B | AB | AB |
| Iciness | 5.3 | 7.6 | 3.2 | 2.2 | 2.1 | 1.9 | 1.4 |
| | B | A | C | CD | CD | CD | D |
| Firmness | 5.1 | 5.4 | 7.6 | 5.8 | 5.2 | 6.8 | 6.6 |
| (in mouth) | C | BC | A | BC | C | AB | ABC |
| Creamy | 4.0 | 1.3 | 4.6 | 4.8 | 4.3 | 4.8 | 5.1 |
| mouthfeel | A | B | A | A | A | A | A |
| Creamy | 3.9 | 1.3 | 4.2 | 4.7 | 3.1 | 4.7 | 4.6 |
| mouthcoating | AB | C | AB | A | B | A | A |
| Meltdown | 17.5 | 27.0 | 30.2 | 27.0 | 25.4 | 33.3 | 29.1 |
| (seconds) | B | A | A | A | AB | A | A |

As Table 19 shows, while the commercially available dairy ice cream was the softest out of the cup, products Fy mat and V11 according to the present disclosure were closest to the dairy sample for this attribute; except for V1, which had the highest out-of-cup firmness score, all of the products according to the present disclosure were similar to the commercially available non-dairy product in this attribute. While the samples of products according to the present disclosure exhibited a range of iciness values, all of these values fell below the commercially available dairy ice cream and well below the commercially available non-dairy product; this represents an important advantage of the ice cream analog food products according to the present disclosure, as iciness is a generally undesirable attribute in such products. The products according to the present disclosure also exhibited a range of in-mouth firmness values, with products Fy mat, V11, and SD Fy being similar to both the dairy and non-dairy commercial products and products DD Fy and V1 being somewhat firmer. All products according to the present disclosure exhibited creamy mouthfeel and creamy mouthcoating characteristics similar to that of the commercially available dairy ice cream and well above that of the commercially available non-dairy product. Finally, the products according to the present disclosure generally took longer to melt in the mouth than the commercially available dairy ice cream but a comparable time to the commercially available non-dairy product. This Example thus demonstrates both that colloidal food compositions (and particularly ice cream analog food products) according to the present disclosure are highly versatile and can be tuned or optimized for a wide range of textural attribute intensities, and that the compositions can match or even improve upon the textural qualities of analogous commercially available food products.

The invention illustratively disclosed herein suitably may be practiced in the absence of any element which is not specifically disclosed herein. It is apparent to those skilled in the art, however, that many changes, variations, modifications, other uses, and applications of the invention are possible, and changes, variations, modifications, other uses, and applications which do not depart from the spirit and scope of the invention are deemed to be covered by the invention, which is limited only by the claims which follow.

The foregoing discussion of the invention has been presented for purposes of illustration and description. The foregoing is not intended to limit the invention to the form or forms disclosed herein. In the foregoing Detailed Description of the Invention, for example, various features of the invention are grouped together in one or more embodiments for the purpose of streamlining the disclosure. The features of the embodiments of the invention may be combined in alternate embodiments other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description of the Invention, with each claim standing on its own as a separate preferred embodiment of the invention.

Moreover, though the description of the invention has included description of one or more embodiments and certain variations and modifications, other variations, combinations, and modifications are within the scope of the invention, e.g., as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

1.-50. (canceled)

51. A colloidal composition, comprising:
a first phase;
a continuous second phase; and
filamentous fungal particles,
wherein the filamentous fungal particles comprise elongated particles having a length of between about 1 micron and about 50 microns, and wherein the filamentous fungal particles are substantially uniformly dispersed throughout the continuous second phase,
wherein the colloidal composition is a dairy analog food product, and
wherein the colloidal composition is an ice cream analog food product comprising at least one flavoring ingredient.

52. The colloidal composition of claim 51, wherein the first phase comprises a gas.

53. The colloidal composition of claim 52, wherein the gas comprises at least one species selected from the group consisting of nitrogen, oxygen, argon, and carbon dioxide.

54. The colloidal composition of claim 51, wherein the continuous second phase comprises at least one of an oil, a monosaccharide, a disaccharide, a polysaccharide, and ice crystals.

55. The colloidal composition of claim 51, wherein the filamentous fungal particles comprise elongated particles having a length of between about 5 microns and about 20 microns.

56. The colloidal composition of claim 51, wherein the filamentous fungal particles comprise elongated particles having a width of between about 0.01 microns and about 2 microns.

57. (canceled)

58. The colloidal composition of claim 57, wherein the dairy analog food product is a cream analog food product having a fat content of at least about 10.5 wt %.

59. The colloidal composition of claim 51, wherein the colloidal composition is a frozen food product.

60. (canceled)

61. The colloidal composition of claim 51, wherein the colloidal composition is a vanilla ice cream analog food product and the at least one flavoring ingredient comprises vanilla beans or vanilla paste.

62. The colloidal composition of claim 51, wherein the colloidal composition is a strawberry ice cream analog food product and the at least one flavoring ingredient comprises strawberry puree and lemon juice.

63. The colloidal composition of claim 51, wherein the colloidal composition is a chocolate ice cream analog food product and the at least one flavoring ingredient comprises cacao powder.

64. The colloidal composition of claim 57, wherein at least about 10% (by number, volume, or weight), at least about 20% (by number, volume, or weight), at least about 30% (by number, volume, or weight), at least about 40% (by number, volume, or weight), at least about 50% (by number, volume, or weight), at least about 60% (by number, volume, or weight), at least about 70% (by number, volume, or weight), at least about 80% (by number, volume, or weight), at least about 90% (by number, volume, or weight), at least about 91% (by number, volume, or weight), at least about 92% (by number, volume, or weight), at least about 93% (by number, volume, or weight), at least about 94% (by number, volume, or weight), at least about 95% (by number, volume, or weight), at least about 96% (by number, volume, or weight), at least about 97% (by number, volume, or weight), at least about 98% (by number, volume, or weight), or at least about 99% (by number, volume, or weight) of ice crystals in the colloidal composition have particle sizes of less than about 25 μm, less than about 24 μm, less than about 23 μm, less than about 22 μm, less than about 21 μm, less than about 20 μm, less than about 19 μm, less than about 18 μm, less than about 17 μm, less than about 16 μm, less than about 15 μm, less than about 14 μm, less than about 13 μm, less than about 12 μm, less than about 11 μm, less than about 10 μm, less than about 9 μm, less than about 8 μm, less than about 7 μm, less than about 6 μm, or less than about 5 μm.

65.-107. (canceled)

108. The colloidal composition of claim 51, wherein the filamentous fungal particles comprise at least one ice-structuring protein.

109.-120. (canceled)

121. A method for preparing an ice cream analog food product, comprising:
(a) heating a first mixture to a first temperature, the first mixture comprising a fungal dispersion, the fungal dispersion comprising particles of filamentous fungus dispersed in water;
(b) adding at least one monosaccharide, disaccharide, or polysaccharide to the first mixture to form a fungus- and saccharide-containing mixture;
(c) heating the fungus- and saccharide-containing mixture to a second temperature;
(d) heating the fungus- and saccharide-containing mixture to a third temperature and maintaining this temperature for at least about two minutes to form an emulsion;
(e) cooling the emulsion to a fourth temperature;
(f) churning the emulsion to incorporate air into the emulsion; and
(g) freezing the emulsion to a fifth temperature.

122. The method of claim 121, further comprising, during step (b), between steps (b) and (c), during step (c), between steps (c) and (d), or during step (d), adding a fatty substance to the fungus- and saccharide-containing mixture.

123. The method of claim 121, wherein at least one of the first mixture and the fatty substance comprises a flavoring ingredient.

124. The method of claim 121, wherein at least one of the following is true:
(i) the first temperature is about 40° C.;
(ii) the second temperature is between about 45° C. and about 70° C.;
(iii) the third temperature is about 82° C.;
(vi) the fourth temperature is about 5° C.; and
(v) the fifth temperature is about −18° C.

125. The method of claim 121, further comprising, at least one of the following additional components:
between steps (e) and (f) or during step (f), adding a flavoring ingredient to the emulsion, and
between steps (b) and (c) or during step (c), adding a foam stabilizer to the second mixture.

126. (canceled)

127. (canceled)

128. The method of claim 121, wherein at least one of the following conditions is met:
wherein a freezing temperature of the fungal dispersion is greater than −0.5° C.,
wherein the fungal dispersion has a CIELAB lightness value L* of at least about 64, and
wherein the fungal dispersion has a dietary fiber content of at least about 2 wt %.

129.-131. (canceled)
